(19) United States
(12) Patent Application Publication
(10) Pub. No.: US 2026/0239041 A1
(43) Pub. Date: Aug. 13, 2026

(54) METHOD AND APPARATUS FOR SUPPORTING A MOBILITY IN A WIRELESS COMMUNICATION SYSTEM

(71) Applicant: SAMSUNG ELECTRONICS CO., LTD., Suwon-si, Gyeonggi-do (KR)

(72) Inventor: Donggun KIM, Staines, Middlesex (GB)

(21) Appl. No.: 19/470,747

(22) PCT Filed: Mar. 21, 2024
(86) PCT No.: PCT/KR2024/095606

§ 371 Date: Sep. 29, 2025

(30) Foreign Application Priority Data
Mar. 30, 2023 (GB) 2304748.3
Feb. 29, 2024 (GB) 2402899.5

(51) Int. Cl. H04W 24/04; H04W 12/04; H04W 76/20

(52) U.S. Cl. CPC H04W 24/04; H04W 12/04; H04W 76/20

(57) ABSTRACT

The disclosure relates to a 5G or 6G communication system for supporting a higher data transmission rate. Disclosed is a method for performing a handover in a telecommunication system by a transmitting device, the method comprising the steps of: receiving a reconfiguration message via a Signalling Radio Bearer, SRB, wherein the reconfiguration message includes a first indicator or a second indicator; wherein, the first indicator triggers Packet Data Convergence Protocol, PDCP, re-establishment for the SRB and the second indicator triggers PDCP data recovery; wherein, PDCP re-establishment is triggered based on a first field for security key update being included in reconfiguration message; and performing PDCP re-establishment or PDCP data recovery, respectively, for the SRB, based on the first indicator or the second indicator.

### TECHNICAL FIELD

The disclosure generally relates to the field of wireless communication. More particularly, the disclosure relates to a terminal and a communication method thereof in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

This disclosure relates to wireless communication networks, and more particularly to a terminal and a communication method thereof in a wireless communication system.

In accordance with an aspect of the disclosure, there is provided a method for performing a handover in a telecommunication system by a transmitting device, the method comprising the steps of: receiving a reconfiguration message via a Signalling Radio Bearer, SRB, wherein the reconfiguration message includes a first indicator or a second indicator; wherein, the first indicator triggers Packet Data Convergence Protocol, PDCP, re-establishment for the SRB and the second indicator triggers PDCP data recovery; wherein, PDCP re-establishment is triggered based on a first field for security key update being included in reconfiguration message; and performing PDCP re-establishment or PDCP data recovery, respectively, for the SRB, based on the first indicator or the second indicator.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

For a better understanding of the invention, and to show how embodiments of the same may be carried into effect, reference will now be made, by way of example only, to the accompanying diagrammatic drawings in which:

FIG. 1 shows a Functional Framework for RAN Intelligence as known in the art;

FIG. 2 shows Model Training at OAM, Model Inference at NG-RAN according to an embodiment of the invention;

FIG. 3 shows Model Training and Model Inference at NG-RAN according to an embodiment of the invention;

FIG. 4 shows UE state machine and state transitions in NR as known in the art;

FIG. 5 shows System architecture and RRC connection control as known in the art;

FIG. 6 shows a radio protocol structure as known in the art;

FIG. 7 shows a next generation mobile communication system, known in the art;

FIG. 8 shows a radio protocol structure as known in the art;

FIG. 9 shows a procedure according to an embodiment of the invention;

FIG. 10 shows a procedure illustrating system information acquisition according to an embodiment of the invention;

FIG. 11 shows measurement reporting according to an embodiment of the invention;

FIG. 12 shows an Inter-gNB handover procedures according to an embodiment of the invention;

FIG. 13 shows a flowchart representing an embodiment of the invention;

FIG. 14 illustrates various hardware components of a UE, according to the embodiments as disclosed herein; and

FIG. 15 illustrates various hardware components of a base station according to the embodiments as disclosed herein.

Throughout the drawings, it should be noted that like reference numbers are used to depict the same or similar elements, features, and structures.

### BEST MODE FOR CARRYING OUT THE INVENTION

Aspects of the disclosure are to address at least the above-mentioned problems and/or disadvantages and to provide at least the advantages described below. Accordingly, an aspect of the disclosure is to provide a terminal and a communication method thereof in a wireless communication system.

The present invention relates to improved mobility support for Artificial Intelligence/Machine Learning, AI/ML, functionality. The first step to providing AI/ML functionality in a Radio Access Network, RAN, is to support it for User Equipments, UEs, in RRC CONNECTED state using various technical enhancements set out herein.

The next step is to support AI/ML functionality for UEs configured with carrier aggregation (CA) or dual connectivity (DC) in RRC CONNECTED state, which can allow the network to utilize separate radio resource for AI/ML functionality and thus implementation flexibility can increased. Other than UEs in RRC CONNECTED, if AI/ML functionality is supported for UEs in RRC INACTIVE or RRC IDLE state, the network is able to get more information and more time to train an AI/ML model, plus it can also prepare an AI/ML model in advance to control the UEs before their transition into RRC CONNECTED state.

According to the present invention there is provided an apparatus and method as set forth in the appended claims. Other features of the invention will be apparent from the dependent claims, and the description which follows.

According to a first aspect of the present invention, there is provided a method for performing a handover in a telecommunication system by a transmitting device, the method comprising the steps of: receiving a reconfiguration message via a Signalling Radio Bearer, SRB, wherein the reconfiguration message includes a first indicator or a second indicator; wherein, the first indicator triggers Packet Data Convergence Protocol, PDCP, re-establishment for the SRB and the second indicator triggers PDCP data recovery; wherein, PDCP re-establishment is triggered based on a first field for security key update being included in reconfiguration message; and performing PDCP re-establishment or PDCP data recovery, respectively, for the SRB, based on the first indicator or the second indicator.

In an embodiment, the transmitting device is a User Equipment, UE, configured with Artificial Intelligence/Machine Learning, AI/ML, functionality.

In an embodiment, the reconfiguration message is RRCReconfiguration including reconfigurationWithSync.

In an embodiment, the reconfiguration message is received via SRB1.

In an embodiment, the first value of the first indicator is reestablishPDCP and the second value of the first indicator is recoverPDCP.

In an embodiment, the first field is masterKeyUpdate.

According to a second aspect of the present invention, there is provided apparatus arranged to perform the method of the first aspect.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to their bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the disclosure. For example, unless otherwise defined, the technical terms or scientific terms used in the disclosure shall have the ordinary meaning understood by those with ordinary skills in the art to which the disclosure belongs.

It should be understood that “first”, “second” and similar words used in the disclosure do not express any order, quantity or importance, but are only used to distinguish different components.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the application can be applied to future-oriented communication technologies. In addition, the technical schemes of the embodiments of the application can be applied to future-oriented communication technologies.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

Embodiments of the invention support the mobility (i.e. handover) of the UE capable of and configured with AI/ML functionality, and sets out specific UE behaviours, e.g. how UE operates in RRC layer and Packet Data Convergence Protocol, PDCP, layer for intra-gNB (intra-base-station) handover (i.e. security key is not changed/updated) and inter-gNB handover (i.e. security key is changed/updated), separately.

Embodiments of the invention mainly relate to the following issues:
To support the mobility of UE configured with AI/ML functionality in AI-native network
Handover negotiation between the source gNB and the target gNB
New indicators in RRCReconfiguation message
PDCP re-establishment procedure
PDCP data recovery procedure
PDCP status report triggering
Restrictions on AI/ML configuration for DAPS handover.

In addition to this, embodiments of the invention provide an extension of the following solutions for supporting AI/ML functionality in dual connectivity (DC) and RRC INACTIVE state:
To support RRC INACTIVE
System information enhancement
Paging enhancement
How to measure (or collect) AI/ML data
How to configure AI/ML configuration,
When to report and release
When to stop to measure or collect AI/ML data
UE Inactive Context handling
UE Restriction to avoid collision with SDT (Small Data transmission) handling
To support Dual connectivity
Handling of Multiple AI/ML configurations
SCG (Secondary Cell Group) configuration for AI/ML and delta configuration
SRB3 (System Resource Block 3) or a Resource Block (RB) (configured for AI/ML functionality, e.g. SRBx or a Data Radio Bearer, DRB) handling
Split SRB handling

Embodiments of the invention also provide the following solutions for supporting AI/ML functionality in RRC CONNECTED state:
To support AI/ML functionality, AI/ML configuration/reporting, the signalling procedures, and UE's operations are set out.
To reduce UE processing burden, a new security protection (integrity protection or ciphering) mechanism is set out unlike the mandatory security protection for SRBs.
To avoid the impact on the network's control for UEs, a new prioritization mechanism is introduced by defining a rule for SRBs or introducing a new SRB or allocating a separate DRB.
To avoid frequent reporting, a new message structure is designed to report multiple data in chronological sequence for the same target in one message.
To support UE's mobility for AI/ML functionality, RRC procedures are set out.
To increase the reliability of AI/ML functionality, a retransmission mechanism is set out.

In this application, it is useful to set out certain features and definitions, which follow.

Data collection: Data collected from the network nodes, management entity or UE, as a basis for AI/ML model training, data analytics and inference.

AI/ML (Artificial Intelligence/Machine Learning) Model: A data driven algorithm by applying machine learning techniques that generates a set of outputs consisting of predicted information and/or decision parameters, based on a set of inputs. It also indicates AI/ML (Model) training or inference or training data or predicted information or decision parameters or a set of inputs.

In this invention, AI/ML data indicates AI/ML (model) training or inference or training data or predicted information or decision parameters or a set of inputs for AI/ML or AI/ML model while AI/ML configuration includes the type of AI/ML Model, Model Inference, Model training, Algorithms or how to construct a RRC message for response (or report) including AI/ML data (e.g. which information should be included) or how to send the RRC message from the transmitter (UE or gNB) to the receiver (gNB or UE) (e.g. periodicity, timer related information, etc). AI/ML data can indicates the measurement report (e.g for beam or SSB (Synchronization Signal Block) or CSI or CRS (Cell specific Reference Signal)) and CSI (Channel State Information) report and AI/ML configuration can include the measurement configuration (e.g for beam or SSB (Synchronization Signal Block) or CSI or CRS (Cell specific Reference Signal)) and CSI measurement configuration (e.g aperiodic CSI, periodic CSI, etc). AI/ML functionality means all these information (e.g. AI/ML data and AI/ML configuration), measurement configuration and reporting, the request/report for training data, the training described later and inference procedure also described later.

AI/ML Training: An online or offline process to train an AI/ML model by learning features and patterns that best present data and get the trained AI/ML model for inference.

AI/ML Inference: A process of using a trained AI/ML model to make a prediction or guide the decision based on collected data and AI/ML model.

“Signalling Radio Bearers” (SRBs) are defined as Radio Bearers (RBs) that are used only for the transmission of RRC (Radio Resource Control) and NAS (Non-Access Stratum) messages. More specifically, the following SRBs are defined:
SRB0 is for RRC messages using the CCCH (Common Control Channel) logical channel;
SRB1 is for the first RRC messages (which may include a piggybacked NAS message) as well as for NAS messages prior to the establishment of SRB2, all using DCCH logical channel. It can be for the second RRC messages which include AI/ML related information (e.g. AI/ML data, training data, update information, response, offset for AI/ML, etc) but the second RRC messages can have lower priority than the first RRC messages (e.g. a piggybacked NAS message, NAS messages prior to the establishment of SRB2, RRC messages for setting up (re-)connection and (re-)configuration, i.e. RRCSetupRequest, RRCSetup, RRCSetupComplete, RRCResumeRequest, RRCResume, RRCResumeComplete, RRCReconfiguration, RRCReconfigurationComplete, RRCReestablishment RRCReestablishmentRequest, etc) because the first RRC messages are much more important than the second RRC messages to support UE's connection management and mobility support. When the first messages and the second messages are generated together or simultaneously (or co-exist in buffer), then the first message can be prioritized over the second RRC messages and can be submitted to lower layers (e.g. PDCP layer) and sent first.
SRB2 is for NAS messages and for RRC messages which include logged measurement information or AI/ML related information (e.g. AI/ML data, training data, update information, response, offset for AI/ML, etc), all using DCCH logical channel. SRB2 has a lower priority than SRB1 and may be configured by the network after AS security activation;
SRB3 is for specific RRC messages when UE is in (NG)EN-DC or NR-DC, all using DCCH logical channel, or RRC messages which include AI/ML related information (e.g. AI/ML data, training data, update information, response, offset for AI/ML, etc);
SRB4 is for RRC messages which include application layer measurement report information, all using DCCH logical channel or RRC messages which include AI/ML related information (e.g. AI/ML data, training data, update information, response, offset for AI/ML, etc). SRB4 can only be configured by the network after AS security activation.
SRBx (e.g. SRB5) is for RRC messages which include AI/ML related information (e.g. AI/ML data, training data, update information, response, offset for AI/ML, etc), all using DCCH logical channel. SRBx can be configured by the network after AS security activation. However, SRBx can be configured by the network before AS security activation in the case SRBx is not required to perform ciphering and integrity protection for the RRC messages. When SRBx is configured to send/receive RRC messages for AI/ML related information, the network can configure Logical channel prioritization parameters (i.e. allocation of a priority and a prioritised bit rate (PBR)) for LCP procedure performed in MAC entity (or layer) for SRBx to control the prioritization of data transmission. In this invention, SRBx is a new SRB configured for AI/ML functionality, which can be named SRB5.

A DRB is for AI/ML related information (e.g. AI/ML data, training data, update information, response, offset for AI/ML, etc), all using DCCH logical channel. This DRB can be configured by the network after AS security activation. However, the DRB can be configured by the network before AS security activation in the case the DRB is not required to perform ciphering and integrity protection for the AI/ML data. When DRB is configured to send/receive AI/ML data, the network can configure Logical channel prioritization (LCP) parameters (i.e. allocation of a priority and a prioritised bit rate (PBR)) for LCP procedure performed in MAC entity (or layer) for the DRB to control the prioritization of data transmission.

In downlink, piggybacking of NAS messages is used only for one dependent (i.e. with joint success/failure) procedure: bearer establishment/modification/release. In uplink piggybacking of NAS message is used only for transferring the initial NAS message during connection setup and connection resume.

Note that the NAS messages transferred via SRB2 are also contained in RRC messages, which however do not include any RRC protocol control information.

Once AS (Access stratum) security is activated, all RRC messages on SRB1, SRB2, SRB3 and SRB4, including those containing NAS messages, are integrity protected and ciphered by PDCP. NAS independently applies integrity protection and ciphering to the NAS messages as default. However, even if AS security is activated, some RRC messages (e.g. RRC messages for AI/ML data) can be not integrity protected or not ciphered by PDCP according to the configuration (configuration by RRC message) or according to pre-defined rule (e.g. no integrity protection (integrity verification) or no ciphering (deciphering) only for specific RRC message) or according to indication from RRC to PDCP whether to perform ciphering or integrity protecting. This can allow a RRC message not integrity protected and not ciphered, a RRC message not integrity protected but ciphered, and a RRC message integrity protected but not ciphered, in order to reduce UE's processing burden and avoid over-security protection in RAN.

For operation with shared spectrum channel access, SRB0, SRB1 and SRB3 are assigned with the highest priority Channel Access Priority Class (CAPC), (i.e. CAPC=1) while CAPC for SRB2 is configurable.

The following high-level principles should be applied for AI-enabled RAN (Radio Access Network) intelligence:
The detailed AI/ML algorithms and models for use cases are implementation specific and they can be configured to UE or gNB or a network entity together with other related parameters and configuration information by the RRC (Radio Resource Control) message or newly defined network message (e.g. X2 message, inter-node messages for interface between network entities).
Where AI/ML functionality resides within the current RAN architecture, depends on deployment and on the specific use cases.
The Model Training and Model Inference functions should be able to request, if needed, specific information to be used to train or execute the AI/ML algorithm and to avoid reception of unnecessary information for UE or gNB or a network entity by using signalling (i.e. sending a request message). The nature of such information depends on the use case and on the AI/ML algorithm.
The Model Inference function should signal the outputs of the model only to nodes that have explicitly requested them (e.g., via subscription or via configuration), or nodes that take actions based on the output from Model Inference, e.g. by sending a message (e.g. RRC message or inter-node message or a newly-defined message).
An AI/ML model used in a Model Inference function has to be initially trained, validated and tested by the Model Training function before deployment to guarantee the performance and avoid a lot of signalings and save radio resource. It can be also trained after deployment in some cases.
The proposed mechanism can work in NG-RAN SA (Next Generation-RAN StandAlone operation mode). However, it can be extended to EN-DC (E-UTRA NR Dual Connectivity with E-UTRA connected to EPC (Evolved Packet Core network)) and MR-DC (Multi-RAT Dual Connectivity).
User data privacy and anonymisation can be respected during AI/ML operation.

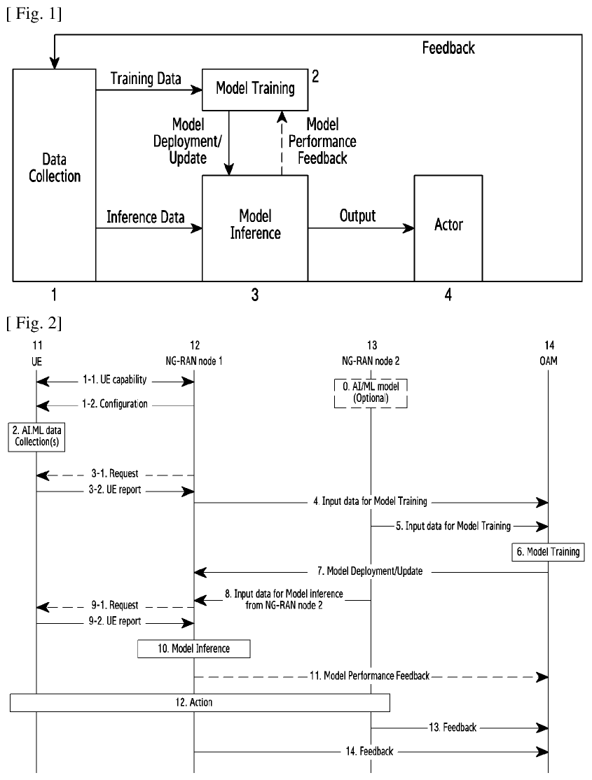

FIG. 1 illustrates a functional framework for RAN intelligence. A detailed description of the functional framework follows.

The following introduces the common terminologies related to the functional framework for RAN intelligence illustrated in FIG. 1. For the functions and data/information flows shown in FIG. 1, the solutions to implement this RAN intelligence are discussed later e.g. how to support AI/ML Model training and Model Inference.

Data Collection 1 is a function that provides input data to Model training and Model inference functions. AI/ML algorithm specific data preparation (e.g., data pre-processing and cleaning, formatting, and transformation) is not carried out in the Data Collection function.

Examples of input data may include measurements (or response or information or report) from UEs or different network entities, feedback from Actor, output from an AI/ML model.

Training Data: Data needed as input for the AI/ML Model Training function.

Inference Data: Data needed as input for the AI/ML Model Inference function.

Model Training 2 is a function that performs the AI/ML model training, validation, and testing which may generate model performance metrics as part of the model testing procedure. The Model Training function is also responsible for data preparation (e.g., data pre-processing and cleaning, formatting, and transformation) based on Training Data delivered by a Data Collection function, if required.

Model Deployment/Update: Used to initially deploy a trained, validated, and tested AI/ML model to the Model Inference function or to deliver an updated model to the Model Inference function.

Model Inference 3 is a function that provides AI/ML model inference output (e.g., predictions or decisions). Model Inference function may provide Model Performance Feedback to Model Training function 2 when applicable. The Model Inference function is also responsible for data preparation (e.g., data pre-processing and cleaning, formatting, and transformation) based on Inference Data delivered by a Data Collection function, if required.

Output: The inference output of the AI/ML model produced by a Model Inference function. Details of inference output are use case specific.

Model Performance Feedback: It may be used for monitoring the performance of the AI/ML model, when available.

Actor 4 is a function that receives the output from the Model Inference function 3 and triggers or performs corresponding actions. The Actor 4 may trigger actions directed to other entities or to itself.

Feedback: Information that may be needed to derive training data, inference data or to monitor the performance of the AI/ML Model and its impact to the network through updating of KPI (Key Performance Indicator) s and performance counters.

The RRC protocol includes the following main functions:
Broadcast of system information:
Including NAS common information;
Information applicable for UEs in RRC_IDLE and RRC_INACTIVE (e.g. cell (re-)selection parameters, neighbouring cell information) and information (also) applicable for UEs in RRC_CONNECTED (e.g. common channel configuration information);
Including ETWS notification, CMAS notification;
Including positioning assistance data.
Including an indication whether the cell supports AI/ML functionality or not. The system information can broadcast the indication. When UE acquires the system information, UE can perform the cell (re-)selection based on this and send UE Capability information including UE's capability for AI/ML functionality support to the cell (or gNB or network) if the system information broadcast the indication supporting AI/ML functionality.
RRC connection control:
Paging; The paging message can be used to indicate whether UE stops (deactivate) or starts (activate) the reporting for AI/ML functionality or whether UE stops (deactivate) or starts (activate) to collect AI/ML data or whether to trigger the report for AI/ML data when UE in RRC IDLE or RRC INACTIVE state, based on newly-defined indications included in paging message. With this indication, the identifier (full I-RNTI or short I-RNTI or ng-5G-S-TMSI) or newly-defined identifier in paging message also indicates a UE in RRC INACTIVE or the group of UEs to do the above proposed behaviours.
Establishment/modification/suspension/resumption/release of RRC connection, including e.g. assignment/modification of UE identity (C-RNTI, fullI-RNTI, etc.), establishment/modification/suspension/resumption/release of SRBs (except for SRB0);
Access barring; The access barring mechanism can allow UE with the purpose of AI/ML functionality to access the cell based on the newly-defined indication in system information. The access barring mechanism also cannot allow UE with the purpose of AI/ML functionality to access the cell based on the newly-defined indication in system information.
Initial AS security activation, i.e. initial configuration of AS integrity protection (SRBs, DRBs) and AS ciphering (SRBs, DRBs);
RRC connection mobility including e.g. intra-frequency and inter-frequency handover, path switch from a PCell to a target L2 U2N Relay UE or from a L2 U2N Relay UE to a target PCell, associated AS security handling, i.e. key/algorithm change, specification of RRC context information transferred between network nodes;
Establishment/modification/suspension/resumption/release of RBs carrying user data (DRBs/MRBs);
Radio configuration control including e.g. assignment/modification of ARQ configuration, HARQ configuration, DRX configuration;
In case of DC, cell management including e.g. change of PSCell, addition/modification/release of SCG cell(s);
In case of CA, cell management including e.g. addition/modification/release of SCell(s);
QoS control including assignment/modification of semi-persistent scheduling (SPS) configuration and configured grant configuration for DL and UL respectively, assignment/modification of parameters for UL rate control in the UE, i.e. allocation of a priority and a prioritised bit rate (PBR) for each RB of UE and logical channel of IAB-MT.
AI/ML functionality control including assignment/modification of semi-persistent scheduling (SPS) configuration and configured grant configuration for DL and UL respectively, assignment/modification of parameters for UL rate control in the UE, i.e. allocation of a priority and a prioritised bit rate (PBR) for each RB of UE and logical channel of IAB-MT.
Recovery from radio link failure.
Inter-RAT mobility including e.g. AS security activation, transfer of RRC context information;
Measurement configuration and reporting:
Establishment/modification/release of measurement configuration (e.g. intra-frequency, inter-frequency and inter-RAT measurements, measurements for AI/ML functionality);
Setup and release of measurement gaps;
Measurement reporting.
AI/ML configuration and reporting for AI/ML functionality and measurement:
Establishment/modification/release of AI/ML configuration including measurement configuration (e.g. intra-frequency, inter-frequency and inter-RAT measurements, time information (measurement duration or timing for measurement) or sequence number for reordering or cell identity (or Physical cell Identity)), and including the measurement configuration (e.g for beam or SSB or CSI or CRS or CSI);
Setup and release of AI/ML configuration including measurement configuration;
AI/ML reporting including measurement reporting (e.g for frequency or beam or SSB or CSI or CRS or cell identity (or Physical cell Identity))
Configuration of BAP entity and BH RLC channels for the support of IAB-node.
Other functions including e.g. generic protocol error handling, transfer of dedicated NAS information, transfer of UE radio access capability information.
Support of self-configuration and self-optimisation.
Support of measurement logging and reporting for network performance optimisation, as specified in TS 37.320 [61];
Support of transfer of application layer measurement configuration and reporting.
Support of AI/ML configuration and reporting.

RRC connection establishment involves the establishment of SRB1. The network completes RRC connection establishment prior to completing the establishment of the NG connection, i.e. prior to receiving the UE context information from the 5GC. Consequently, AS security is not activated during the initial phase of the RRC connection. During this initial phase of the RRC connection, the network may configure the UE to perform measurement reporting or collect AI/ML data, but the UE only sends the corresponding measurement reports or AI/ML data after successful AS security activation. However, the UE only accepts a re-configuration with sync message when AS security has been activated.

The AI/ML data indicates AI/ML (model) training or inference or training data or predicted information or decision parameters or a set of inputs for AI/ML or AI/ML model. For example, the AI/ML data can indicate the measurement report (e.g for beam or SSB (Synchronization Signal Block) or CSI or CRS (Cell specific Reference Signal)) and CSI (Channel State Information) report or positioning information for a UE.

Upon receiving the UE context from the 5GC, the RAN activates AS security (both ciphering and integrity protection) using the initial AS security activation procedure. The RRC messages to activate AS security (command and successful response) are integrity protected, while ciphering is started only after completion of the procedure. That is, the response to the message used to activate AS security is not ciphered, while the subsequent RRC messages (e.g. used to establish SRB2, DRBs and multicast MRBs or a new RB (e.g. SRBx or SRB4 or DRB) for supporting AI/ML functionality or used to transmit/receive AI/ML data (or AI/ML configuration)), e.g. RRCSetup or RRCResume or RRCReconfiguration messages are both integrity protected and ciphered. In another embodiment, a RRC message transmitted via the RB used to transmit/receive AI/ML data (or AI/ML configuration) may not be integrity protected or ciphered or neither based on security configuration. After having initiated the initial AS security activation procedure or establishment of SRB1, the network may initiate the establishment of SRB2 and DRBs and/or multicast MRBs or a new RB (e.g. SRBx or SRB4 or DRB) for supporting AI/ML functionality, i.e. the network may do this prior to receiving the confirmation of the initial AS security activation from the UE. In any case, the network will apply both ciphering and integrity protection for the RRC reconfiguration messages used to establish SRB2, DRBs and/or multicast MRBs, or a new RB (e.g. SRBx or SRB4 or DRB) for supporting AI/ML functionality.

The network initiates the security mode command procedure to a UE in RRC_CONNECTED. Moreover, the network applies the procedure when only SRB1 is established, i.e. prior to establishment of SRB2, multicast MRBs and/or DRBs or a new RB (e.g. SRBx or SRB4 or DRB) for supporting AI/ML functionality. The Network can initiate the RRC reconfiguration procedure to a UE in RRC_CONNECTED to establish RBs (other than SRB1, that is established during RRC connection establishment), e.g. SRB2, DRBs and/or multicast MRBs, or a new RB (e.g. SRBx or SRB4 or DRB) for supporting AI/ML functionality, is performed only when AS security has been activated.

The network should release the RRC connection if the initial AS security activation and/or the radio bearer establishment fails. A configuration with SRB2 without DRB or multicast MRB or a new RB (e.g. SRBx or SRB4 or DRB) for supporting AI/ML functionality, or with DRB or multicast MRB without SRB2 is not supported (i.e., SRB2 and at least one DRB or multicast MRB or a new RB (e.g. SRBx or SRB4 or DRB) for supporting AI/ML functionality, must be configured in the same RRC Reconfiguration message, and it is not allowed to release all the DRBs and multicast MRBs and a new RB (e.g. SRBx or SRB4 or DRB) for supporting AI/ML functionality, without releasing the RRC Connection). For IAB-MT, a configuration with SRB2 without any DRB/MRB/or a new RB (e.g. SRBx or SRB4 or DRB) for supporting AI/ML functionality is supported.

For establishment of a new RB (e.g. SRBx or SRB4 or DRB) for supporting AI/ML functionality, the RRC message transmitted via SRB1 (e.g. RRCReconfiguration message) includes AI/ML configuration and the configuration for the new SRB.

The AI/ML configuration includes the type of AI/ML Model (e.g. Identifier for Model or Model functionality), Model Inference, Model training, Algorithms or how to construct a RRC message for response (or report) including AI/ML data (e.g. which information should be included) or how to send the RRC message from the transmitter (UE or gNB) to the receiver (gNB or UE) (e.g. periodicity, timer related information, etc). The AI/ML configuration can include the measurement configuration (e.g for beam or SSB (Synchronization Signal Block) or CSI or CRS (Cell specific Reference Signal)) and CSI measurement configuration (e.g aperiodic CSI, periodic CSI, etc) or positioning configuration for a UE.

When the AI/ML data or AI/ML configuration indicates AI/ML model, it means AI/ML model transfer (or AI/ML model delivery) by RRC message via SRB1 or a new RB (e.g. SRBx or SRB4 or DRB) for supporting AI/ML functionality.

AI/ML model transfer (or AI/ML model delivery) may mean the delivery of an AI/ML model over the air interface, either parameters of a model structure known at the receiving end or a new model with parameters or identifies for model or function. The function may indicate the measurement (e.g for beam or SSB (Synchronization Signal Block) or CSI or CRS (Cell specific Reference Signal)) and CSI measurement (e.g aperiodic CSI, periodic CSI, etc) or positioning for a UE. Delivery may contain a full model or a partial model. It may be a generic term referring to delivery of an AI/ML model from one entity to another entity in any manner. An entity could mean a network node/function (e.g., gNB, LMF (Life Management Function), etc.), UE, proprietary server, etc.

When a new RB (e.g. SRBx or SRB4 or DRB) for supporting AI/ML functionality is established, the UE (or the gNB) can send AI/ML data via the RB to the gNB (or the UE) and vice versa. If the RB is a SRB (e.g. SRBx or SRB4 or SRB5), a RRC message including AI/ML data can be transmitted and received in UE or gNB and the RRC message can be newly defined for AI/ML functionality.

When AI/ML data (or AI/ML configuration) is transmitted via SRB1 or the new RB, the RRC message (or AI/ML data) can be segmentation if the RRC message segmentation is enabled based on the field rrc-SegAllowed received in the received RRC message, and the encoded RRC message (or AI/ML data) is larger than the maximum supported size of a PDCP SDU (e.g. 9 Kbytes) for Uplink transmission or Downlink transmission. When the RRC message is segmented, each segment includes its own sequence number and the indicator (to indicate whether it is the last segment or not).

The same procedure for AI/ML configuration or a RB (used for AI/ML functionality, e.g. SRBx or a DRB) proposed above can be applied to the UE configured/will be configured for dual connectivity. For example, the establishment of SRB1 is done by during RRC connection establishment. For establishment of a new RB (e.g. SRBx or SRB4 or DRB) for supporting AI/ML functionality, the RRC message transmitted via SRB1 (e.g. RRCReconfiguration message) includes AI/ML configuration. When the new RB (e.g. SRBx or SRB4 or DRB) for supporting AI/ML functionality is established, the UE (or the gNB) can send AI/ML data via the RB to the gNB (or the UE) and vice versa via SCG (or MCG). If the RB is a SRB (e.g. SRBx or SRB4 or SRB5), a RRC message including AI/ML data can be transmitted and received in UE or gNB and the RRC message can be newly defined for AI/ML functionality via SCG (or MCG). The RB (used for AI/ML functionality, e.g. SRBx or a DRB) can be configured for either SCG or MCG based on configuration (e.g. based on indicator or Cell group identifier).

The release of the RRC connection normally is initiated by the network. The procedure may be used to re-direct the UE to an NR frequency or an E-UTRA carrier frequency.

The suspension of the RRC connection is initiated by the network. When the RRC connection is suspended, the UE stores the UE Inactive AS context and any configuration received from the network, and transits to RRC_INACTIVE state. The RRC message to suspend the RRC connection is integrity protected and ciphered.

The resumption of a suspended RRC connection is initiated by upper layers when the UE needs to transit from RRC_INACTIVE state to RRC_CONNECTED state or by RRC layer to perform a RNA update or by RAN paging from NG-RAN or for SDT. When the RRC connection is resumed, network configures the UE according to the RRC connection resume procedure based on the stored UE Inactive AS context and any RRC configuration received from the network. The RRC connection resume procedure re-activates AS security and re-establishes SRB(s) and DRB(s) and/or multicast MRB(s) or a new RB (e.g. SRBx or SRB4 or DRB) for supporting AI/ML functionality, if configured.

When a new RB for supporting AI/ML functionality is a DRB, the DRB can be AM DRB configured with AM (Acknowledged Mode) RLC entities and using RLC AM mode to support lossless delivery and high reliability, wherein AM mode supports ARQ (Automatic Repeat Request) mechanism.

Upon initiating the resume procedure for SDT, AS security (both ciphering and integrity protection) is re-activated for SRB2 (if configured for SDT) and for SRB1. In addition, AS security is also re-activated (if security is configured) for all the DRBs configured for SDT. Further, the PDCP entities of SRB1 and PDCP entities of the radio bearers configured for SDT are re-established and resumed whilst the UE remains in RRC_INACTIVE state. Transmission and reception of data and/or signalling messages over radio bearers configured for SDT can happen whilst the UE is in RRC_INACTIVE state and SDT procedure is ongoing.

In response to a request to resume the RRC connection or in response to a resume procedure initiated for SDT, the network may resume the suspended RRC connection and send UE to RRC_CONNECTED, or reject the request to resume and send UE to RRC_INACTIVE (with a wait timer), or directly re-suspend the RRC connection and send UE to RRC_INACTIVE, or directly release the RRC connection and send UE to RRC_IDLE, or instruct the UE to initiate NAS level recovery (in this case the network sends an RRC setup message).

The AI/ML configuration may be configured and the AI/ML data may be transmitted and received as a part SON (Self-Organizing Network) procedure, MDT (Minimization of Drive Tests) procedure, UE assistance information, early idle/inactive measurements, RRM (Radio Resource Management) measurement reports, CSI (Channel Status Information) reporting framework, LPP (LTE Positioning Protocol) Provide location information.

The following high-level principles should be applied. In embodiments of this invention, security protection implies ciphering or integrity protection. The ciphering means not only the ciphering operation but also the deciphering operation because the deciphering should be applied to the data at the receiver if a data is ciphered at the transmitter. Likewise, the integrity protection means the integrity verification operation as well as the integrity protection operation because the integrity verification should be applied to the data at the receiver if a data is integrity protected at the transmitter.

AS security comprises of the integrity protection and ciphering of RRC signalling (SRBs) and user data (DRBs).

RRC handles the configuration of the AS security parameters which are part of the AS configuration: the integrity protection algorithm, the ciphering algorithm, if integrity protection and/or ciphering is enabled for a DRB and two parameters, namely the keySetChangeIndicator and the nextHopChainingCount, which are used by the UE to determine the AS security keys upon reconfiguration with sync (with key change), connection re-establishment and/or connection resume.

The integrity protection algorithm is common for SRB1, SRB2, SRB3 (if configured), SRB4 (if configured), SRBx (if configured) and DRBs configured with integrity protection, with the same keyToUse value. The ciphering algorithm is common for SRB1, SRB2, SRB3 (if configured), SRB4 (if configured), SRBx (if configured) and DRBs configured with the same keyToUse value. Neither integrity protection nor ciphering applies for SRB0.

Note that all DRBs related to the same PDU session have the same enable/disable setting for ciphering and the same enable/disable setting for integrity protection.

RRC integrity protection and ciphering are always activated together, i.e. in one message/procedure. RRC integrity protection and ciphering for SRBs are never deactivated. However, it is possible to switch to a ‘NULL’ ciphering algorithm (nea0).

For SRBx (if configured), RRC integrity protection and ciphering can be activated and deactivated based on configuration or indication by RRC messages (or MAC CE (Control Element) or PDCP control PDU (Protocol Data Unit)), in order to reduce the UE processing burden. For SRBx (if configured), it is also possible to switch to a ‘NULL’ ciphering algorithm (nea0) and the ‘NULL’ integrity protection algorithm (nia0) can be used.

The ‘NULL’ integrity protection algorithm (nia0) is used only for SRBs and for the UE in limited service mode and when used for SRBs, integrity protection is disabled for DRBs. In case the ‘NULL’ integrity protection algorithm is used, ‘NULL’ ciphering algorithm is also used.

Note that lower layers discard RRC messages for which the integrity protection check has failed and indicate the integrity protection verification check failure to RRC.

The AS applies four different security keys: one for the integrity protection of RRC signalling (K_{RRCint}), one for the ciphering of RRC signalling (K_{RRCenc}), one for integrity protection of user data (K_{UPint}) and one for the ciphering of user data (K_{UPenc}). All four AS keys are derived from the K_{gNB} key. The K_{gNB} key is based on the KAME key, which is handled by upper layers.

The integrity protection and ciphering algorithms can only be changed with reconfiguration with sync. The AS keys (K_{gNB}, K_{RRCint}, K_{RRCenc}, K_{UPint} and K_{UPenc}) change upon reconfiguration with sync (if masterKeyUpdate is included), and upon connection re-establishment and connection resume.

For each radio bearer an independent counter (COUNT used in PDCP layer) is maintained for each direction. For each radio bearer, the COUNT is used as input for ciphering and integrity protection.

It is not allowed to use the same COUNT value more than once for a given security key. The network is responsible for avoiding reuse of the COUNT with the same RB identity and with the same key, e.g. due to the transfer of large volumes of data, release and establishment of new RBs, and multiple termination point changes for RLC-UM bearers and multiple termination point changes for RLC-AM bearer with SN terminated PDCP re-establishment (COUNT reset) due to SN only full configuration whilst the key stream inputs (i.e. bearer ID, security key) at MN have not been updated. In order to avoid such re-use, the network may e.g. use different RB identities for RB establishments, change the AS security key, or an RRC_CONNECTED to RRC_IDLE/RRC_INACTIVE and then to RRC_CONNECTED transition.

In order to limit the signalling overhead, individual messages/packets include a short sequence number (PDCP SN (Sequence Number)). In addition, an overflow counter mechanism is used: the hyper frame number (HFN used in PDCP layer). The HFN needs to be synchronized between the UE and the network.

For each SRB, the value provided by RRC to lower layers to derive the 5-bit BEARER parameter used as input for ciphering and for integrity protection is the value of the corresponding srb-Identity with the MSBs padded with zeroes.

For a UE provided with an sk-counter, keyToUse indicates whether the UE uses the master key (K_{gNB}) or the secondary key (S-K_{eNB} or S-K_{gNB}) for a particular DRB. The secondary key is derived from the master key and sk-Counter. Whenever there is a need to refresh the secondary key, e.g. upon change of MN with K_{gNB} change or to avoid COUNT reuse, the security key update is used. When the UE is in NR-DC, the network may provide a UE configured with an SCG with an sk-Counter even when no DRB is setup using the secondary key (S-K_{gNB}) in order to allow the configuration of SRB3. The network can also provide the UE with an sk-Counter, even if no SCG is configured, when using SN terminated MCG bearers.

There are various use cases related to the use of AI in RAN.

These include the following broad areas.

### Network Energy Saving

To meet the 5G network requirements of key performance and the demands of unprecedented growth of the mobile subscribers, millions of base stations (BSs) are being deployed. Such rapid growth brings the issues of high energy consumption, CO2 emissions and operation expenditures (OPEX). Therefore, energy saving is an important use case which may involve different layers of the network, with mechanisms operating at different time scales.

Cell activation/deactivation is an energy saving scheme in the spatial domain that exploits traffic offloading in a layered structure to reduce the energy consumption of the whole radio access network (RAN). When the expected traffic volume is lower than a fixed threshold, the cells may be switched off, and the served UEs may be offloaded to a new target cell.

Efficient energy consumption can also be achieved by other means such as reduction of load, coverage modification, or other RAN configuration adjustments. The optimal energy saving decision depends on many factors including the load situation at different RAN nodes, RAN nodes capabilities, KPI/QoS (Quality of Service) requirements, number of active UEs and UE mobility, cell utilization, etc.

However, the identification of actions aimed at energy efficiency improvements is not a trivial task. Wrong switch-off of the cells may seriously deteriorate the network performance since the remaining active cells need to serve the additional traffic. Wrong traffic offload actions may lead to a deterioration of energy efficiency instead of an improvement. The current energy-saving schemes are vulnerable to potential issues listed as follows:
Inaccurate cell load prediction. Currently, energy-saving decisions rely on current traffic load without considering future traffic load.
Conflicting targets between system performance and energy efficiency. Maximizing the system's key performance indicator (KPI) is usually done at the expense of energy efficiency. Similarly, the most energy efficient solution may impact system performance. Thus, there is a need to balance and manage the trade-off between the two.
Conventional energy-saving related parameters adjustment. Energy-saving related parameters configuration is set by traditional operation, e.g., based on different thresholds of cell load for cell switch on/off which is somewhat a rigid mechanism since it is difficult to set a reasonable threshold.
Actions that may produce a local (e.g., limited to a single RAN node) improvement of Energy Efficiency, while producing an overall (e.g., involving multiple RAN nodes) deterioration of Energy Efficiency.

To deal with issues listed above, ML techniques may be utilized to optimize the energy saving decisions by leveraging on the data collected in the RAN network. ML algorithms may predict the energy efficiency and load state of the next period, which can be used to make better decisions on cell activation/deactivation for energy saving. Based on the predicted load, the system may dynamically configure the energy-saving strategy (e.g., the switch-off timing and granularity, offloading actions) to keep a balance between system performance and energy efficiency and to reduce the energy consumption.

### Load Balancing

The rapid traffic growth and multiple frequency bands utilized in a commercial network make it challenging to steer the traffic in a balanced distribution. To address the problem, load balancing had been proposed. The objective of load balancing is to distribute load evenly among cells and among areas of cells, or to transfer part of the traffic from congested cells or from congested areas of cells, or to offload users from one cell, cell area, carrier or RAT to improve network performance. This can be done by means of optimization of handover parameters and handover actions. The automation of such optimisation can provide high quality user experience, while simultaneously improving the system capacity and also to minimize human intervention in the network management and optimization tasks.

However, the optimization of the load balancing is not an easy task as follows:
Currently the load balancing decisions relying on the current/past-state cell load status are insufficient. The traffic load and resource status of the network changes rapidly, especially in the scenarios with high-mobility and large number of connections, which may lead to ping-pong handover between different cells, cell overload and degradation of user service quality.
It is difficult to guarantee the overall network and service performance when performing load balancing. For the load balancing, the Ues in the congested cell may be offloaded to the target cell, by means of handover procedure or adapting handover configuration. For example, if the Ues with time-varying traffic load are offloaded to the target cell, the target cell may be overloaded with new-arrival heavy traffic. It is difficult to determine whether the service performance after the offloading action meets the desired targets.

To deal with the above issues, solutions based on AI/ML model may be introduced to improve the load balancing performance. Based on collection of various measurements and feedbacks from UEs and network nodes, historical data, etc. AI/ML model-based solutions and predicted load could improve load balancing performance, in order to provide higher quality user experience and to improve the system capacity.

### Mobility Optimization

Mobility management is a scheme to guarantee the service-continuity during the mobility by minimizing the call drops, RLFs, unnecessary handovers, and ping-pong. For the future high-frequency network, as the coverage of a single node decreases, the frequency for UE to handover between nodes becomes high, especially for high-mobility UE. In addition, for the applications characterized with the stringent QoS requirements such as reliability, latency etc., the QoE is sensitive to the handover performance, so that mobility management should avoid unsuccessful handover and reduce the latency during handover procedure. However, for the conventional method, it is challengeable for trial-and-error-based scheme to achieve nearly zero-failure handover. The unsuccessful handover cases are the main reason for packet dropping or extra delay during the mobility period, which is unexpected for the packet-drop-intolerant and low-latency applications. In addition, the effectiveness of adjustment based on feedback may be weak due to randomness and inconstancy of transmission environment. Besides the baseline case of mobility, areas of optimization for mobility include dual connectivity, CHO, and DAPS, which each has additional aspects to handle in the optimization of mobility.

Mobility aspects of Self Organising Network, SON, that can be enhanced by the use of AI/ML include:
Reduction of the probability of unintended events
UE Location/Mobility/Performance prediction
Traffic Steering

Reduction of the probability of unintended events associated with mobility.

Examples of such unintended events are:
Intra-system Too Late Handover: A radio link failure (RLF) occurs after the UE has stayed for a long period of time in the cell; the UE attempts to re-establish the radio link connection in a different cell.
Intra-system Too Early Handover: An RLF occurs shortly after a successful handover from a source cell to a target cell or a handover failure occurs during the handover procedure; the UE attempts to re-establish the radio link connection in the source cell.
Intra-system Handover to Wrong Cell: An RLF occurs shortly after a successful handover from a source cell to a target cell or a handover failure occurs during the handover procedure; the UE attempts to re-establish the radio link connection in a cell other than the source cell and the target cell.
Successful Handover: During a successful handover, there is underlying issue.

RAN Intelligence could observe multiple HO events with associated parameters, use this information to train its ML model and try to identify sets of parameters that lead to successful HOs and sets of parameters that lead to unintended events.

### UE Location/Mobility/Performance Prediction

Predicting UE's location is a key part for mobility optimisation, as many RRM actions related to mobility (e.g., selecting handover target cells) can benefit from the predicted UE location/trajectory. UE mobility prediction is also one key factor in the optimization of early data forwarding particularly for CHO. UE Performance prediction when the UE is served by certain cells is a key factor in determining which is the best mobility target for maximisation of efficiency and performance.

### Traffic Steering

Efficient resource handling can be achieved adjusting handover trigger points and selecting optimal combination of Pcell/PSCell/Scells to serve a user.

Existing traffic steering can also be improved by providing a RAN node with information related to mobility or dual connectivity.

For example, before initiating a handover, the source gNB could use feedbacks on UE performance collected for successful handovers occurred in the past and received from neighbouring gNBs.

Similarly, for the case of dual connectivity, before triggering the addition of a secondary gNB or triggering SN change, an eNB could use information (feedbacks) received in the past from the gNB for successfully completed SN Addition or SN Change procedures.

In the two reported examples, the source RAN node of a mobility event, or the RAN node acting as Master Node (a eNB for EN-DC, a gNB for NR-DC) can use feedbacks received from the other RAN node, as input to an AI/ML function supporting traffic related decisions (e.g., selection of target cell in case of mobility, selection of a PSCell/Scell(s) in the other case), so that future decisions can be optimized.

Various locations for AI/ML Model Training and AI/ML Model Inference can be considered.

The following solutions can be considered for supporting AI/ML-based network energy saving:
AI/ML Model Training is located in the OAM and AI/ML Model Inference is located in the gNB.
AI/ML Model Training and AI/ML Model Inference are both located in the gNB.

Note: gNB is also allowed to continue model training based on AI/ML model trained in the OAM

In case of UE configured with AI/ML model (or AI/ML model functions (e.g. training or inference)) by RRC messages or newly-defined messages, e.g. Federated learning model or split learning model:
AI/ML Model Training is located in UE and AI/ML Model Inference is located in the gNB or OAM.
AI/ML Model Training is located in the gNB or OAM and AI/ML Model Inference is located in the UE.
AI/ML Model Training and AI/ML Model Inference are both located in the UE.

Note: Federated learning (also known as collaborative learning) is a machine learning technique that trains an algorithm across multiple decentralized edge devices or servers holding local data samples, without exchanging them. This approach stands in contrast to traditional centralized machine learning techniques where all the local datasets are uploaded to one server, as well as to more classical decentralized approaches which often assume that local data samples are identically distributed. Federated learning enables multiple actors (or UEs) to build a common, robust machine learning model without sharing data, thus allowing to address critical issues such as data privacy, data security, data access rights and access to heterogeneous data. Its applications are spread over a number of industries including defence, telecommunications, IoT, and pharmaceutics. Split learning is a new technique developed that allows for participating entities to train machine learning models without sharing any raw data. In principle, both federated learning and split learning has similar nature having benefits of data privacy effect.

In case of CU-DU split architecture, the following solutions are possible:
AI/ML Model Training is located in the OAM and AI/ML Model Inference is located in the gNB-CU.
AI/ML Model Training and Model Inference are both located in the gNB-CU.

In case of UE configured with AI/ML model (or AI/ML model functions (e.g. training or inference)) by RRC messages or newly-defined messages, e.g. Federated learning model or split learning model:
AI/ML Model Training is located in UE and AI/ML Model Inference is located in the gNB-CU or OAM.
AI/ML Model Training is located in the gNB-CU or OAM and AI/ML Model Inference is located in the UE.
AI/ML Model Training and AI/ML Model Inference are both located in the UE.

In an embodiment, NG-RAN makes energy decisions using AI/ML model trained from OAM. This is illustrated in FIG. 2.

For UE configuration, the network can send a RRC message (e.g RRCReconfiguration or RRCSetup or RRCResume or newly defined RRC message) to UE in order to configure the type of AI/ML configuration, e.g. algorithms or models, the related timers, parameters for measurement (e.g beam, CSI, SSB, frequency), conditions, or the type of reporting (or collection), and so on. The Step numbers shown in the following correspond to this used in FIG. 2.

Step 0: NG-RAN node 2 (13) is assumed to have an AI/ML model optionally, which can provide NG-RAN node 1 (12) with input information.

Step 1-1: The network (or the cell) broadcasts the system information including the indication of AI/ML functionality support. In this cell, UEs in RRC IDLE state and RRC INACTIVE state can report the results corresponding to the configured request (e.g. AI/ML configuration) which was configured in RRC CONNECTED state by RRCRelease message including mode change indication from RRC CONNECTED to RRC IDLE/RRC INACTIVE state or by RRCReconfiguration message. When UE performs AI/ML data reporting, UE in RRC IDLE or RRC INACTIVE state can send the results (or indication of availability of the results) by RRC message (e.g. RRCSetupRequest or RRCSetupComplete or RRCResumeRequest or RRCResumeComplete) staying in RRC IDLE or RRC INACTIVE state. If the network want UE to request the results, the network send a RRC message including the indication for report (e.g. RRCSetup or RRCResume) and UE can report it by a RRC message (e.g. RRCSetupComplete or RRCResumeComplete). In another embodiment, when UE performs AI/ML data reporting, UE in RRC IDLE or RRC INACTIVE state can send the results (or indication of availability of the results) after setting up RRC connection with the network (going to RRC CONNECTED state) by RRC message (e.g. RRCSetupComplete or RRCResumeComplete) in RRC CONNECTED state. In another embodiment, if the network want UE to request the results, the network send a RRC message including the indication for AI/ML data report (e.g. UEInformationRequest messages) and UE can report it by a RRC message (e.g. UEInformationResponse messages). When the network requests UE to report UE capability information by sending UE CapabilityEnquiry message, the UE can send UEcapabilityInformation message including the capability of AI/ML functionality support. When UE stays in RRC CONNECTED state, UE can perform AI/ML data collection and reporting based on the configuration or request as specified in Step 1-2, 2, 3-1, and 3-2.

Step 1-2: NG-RAN node 1 configures AI/ML configuration to UE (e.g. the measurement information on the UE side) and sends configuration message (e.g RRCReconfiguation, RRCSetup, or RRCResume or RRCRelease message or newly defined message) to UE to perform AI/ML functionality (e.g. measurement procedure and reporting). The NG-RAN node 1 can also configures the UE to provide AI/ML data (e.g. measurements and/or location information, RRM measurements, MDT measurements, velocity, position, time information for measurement, measurement duration, sequence number for reordering training data, or CSI (e.g. aperiodic CSI or periodic CSI) or measurement results for frequency (or cell identity or beam or SSB)).

The AI/ML configuration information can include one of the following:

(1) The network can configure a SRB (e.g. SRB1, SRB2, SRB3, SRB4, or SRBx) to make UE report the AI/ML data through the SRB to the network by sending RRC message. In another embodiment, the network can configure a DRB (e.g. with special logical channel identity or bearder identity) to make UE report the AI/ML data through the DRB to the network by sending RRC message including configuration. The network can configure radio resource (e.g. time and frequency resources for PUCCH (Physical Uplink Control Channel) or PUSCH (Physical Uplink Shared Channel)) to make UE report the AI/ML data through the configured resources (e.g. UL grant or SPS (Semi Persistent Scheduling) grant (i.e radio resource) or Configured grant).

(2) The configuration information for the SRB or the DRB can include the AS security configuration, i.e. whether to perform ciphering (or integrity protection) or not.

(2-1) A lot of the AI/ML data may need to be reported to the network, i.e. frequent reporting may be needed. To reduce UE's processing burden resulted from ciphering or integrity protection, the ciphering function or integrity protection function may not be configured for the SRB or the DRB, i.e. either ciphering only or integrity protection only or no ciphering and no integrity protection can be configured. In another embodiment, the configured AS security (ciphering or integrity protection) of the SRB (or DRB) for AI/ML data reporting can be activated or deactivated by RRC message or MAC CE or PDCP control PDU or PDCCH DCI to control UE processing burden.

(2-2) A lot of the AI/ML data may need to be reported to the network. To avoid frequent reporting, UE can include many AI/ML data information in a proposed message structure of one RRC message (e.g. measurement reporting message or RRC message for reporting), i.e. UE can report a lot of AI/ML data with one message (e.g. RRC message or MAC CE). The proposed message can include a sequence number or a timing information for each AI/ML data to let the receiver sort them in chronological order. How many AI/ML data should be included in the reporting message can be configured by RRC message (e.g. in AI/ML configuration). The detailed message structure is described later.

(2-3) A lot of the AI/ML data may need to be reported to the network, i.e. frequent reporting may be needed. To reduce UE's processing burden resulted from ciphering or integrity protection, RRC layer can indicate to PDCP layer whether each RRC message (or AI/ML data) need to be integrity protected or not as well as whether each RRC message (or AI/ML data) need to be ciphered or not by using indication. It can be applied to configured SRB or DRB for AI/ML data. In another embodiment, the configured AS security (ciphering or integrity protection) of the SRB (or DRB) for AI/ML data reporting can be activated or deactivated by RRC message or MAC CE or PDCP control PDU or PDCCH DCI to control UE processing burden.

(3) The configuration information includes the prioritization information for AI/ML data. Given that it is very important to send/receive the general RRC messages with low latency and high reliability due to UE's connection management and mobility support, the AI/ML data may not be urgent, i.e. not time-sensitive. Hence, the prioritization mechanism can be configured and used for prioritize other RRC messages over the reporting message for AI/ML data.

(3-1) SRB1 or SRB2 or SRB3 or SRB4 can be configured and used for the transmission/reception of RRC messages which include AI/ML data. The RRC messages can have lower priority than the first RRC messages (e.g. a piggybacked NAS message, NAS messages prior to the establishment of SRB2, RRC messages for setting up (re-)connection and (re-)configuration, i.e. RRCSetupRequest, RRCSetup, RRCSetupComplete, RRCResumeRequest, RRCResume, RRCResumeComplete, RRCReconfiguration, RRCReconfigurationComplete, RRCReestablishment RRCReestablishmentRequest, etc) because the first RRC messages are much more important than the RRC messages for AI/ML data to support UE's connection management and mobility support. When the first RRC messages and the RRC messages for AI/ML data are generated together or simultaneously (or co-exist in buffer), then the first RRC message can be prioritized over the RRC messages for AI/ML data and can be submitted to lower layers (e.g. PDCP layer) and sent first.

(3-2) SRBx or a DRB can be configured and used only for the transmission/reception of messages which include AI/ML data.

(3-3) For AI/ML data through the configured RB as above, the network can do assignment/modification of semi-persistent scheduling (SPS) configuration and configured grant configuration for DL and UL respectively, assignment/modification of parameters for UL rate control in the UE, i.e. allocation of a priority and a PBR (LCP parameters for LCP procedure in MAC layer) for each RB of UE and logical channel identifier, and assignment of separate SCell configuration or separate BWP (BandWidth Part) configuration, in order to control prioritization between messages including AI/ML data and other messages (or data).

(4) The configuration information includes the configuration for AI/ML data and AI/ML configuration (e.g. CSI-MeasConfig or MeasConfig) as described earlier.

(5) The network can configure the conditions when UE (in RRC CONNECTED or RRC IDLE or RRC INACTIVE state) starts to collect AI/ML data (or perform measurement) by RRC message (e.g. RRCReconfiguration or RRCRelease), e.g. the threshold, explicit indication, timer, etc. The network can send RRCReconfiguration including the following configuration to UE in RRC CONNECTED state. The network can also send RRCRelease including the following configuration when it transits UE to RRC IDLE or RRC INACTIVE state.

(5-1) The threshold values can be configured to let UE know the condition when UE starts to collect AI/ML data (or perform measurement). UE starts to collect AI/ML data when the condition is met. For example, if one specific measure is larger (or smaller) than one threshold or/and if another specific measure (e.g.) is larger (or smaller) than another threshold, UE can consider the condition as met. The specific measures can be RSRP (Reference Signal Received Power) or RSRQ (Reference Signal Received Quality) or SINR (Signal-to-interference-plus-noise ratio) or time, etc. The condition can be generated with one or more than one threshold value based on configuration. The network can configures a periodicity in which the UE should collect AI/ML data (or perform measurement).

(5-2) The network can configure the conditions or type or size to let UE know which AI/ML data (or how much AI/ML data) should be collected by RRC message.

(5-3) The network can send an explicit indication to UE by RRC message (e.g. RRCReconfiguration or RRCRelease message) or MAC CE (Control Element) or PDCCH (Physical Downlink Control CHannel) DCI (Downlink Control Information) when to start (or activate) or stop (or deactivate) to collect AI/ML data (or perform measurement) or which measurement object should be measured (e.g. CSI or beam or SSB or frequency or cell identity) or change of the target AI/ML data. When UE receives the indication by the RRC message, UE can start or stop to collect AI/ML data met the conditions configured by the network and store them.

(5-4) The network can configure a timer (e.g. T3xx) to UE by RRC message (e.g. RRCReconfiguration or RRCRelease message). When the timer is configured, UE can start the timer and can collect AI/ML data (or perform measurement) while the timer is running. After the expiry of the timer, UE can stop it. If UE is in RRC IDLE or RRC INACTIVE state, UE can stop the timer upon the reception of RRCSetup or RRCResume message to transit to RRC CONNECTED state. An area information can be configured to make UE collect AI/ML data (i.e. perform measurement) within the configured area. The configure area can be defined with cell identity (i.e. physical cell identity or TAI (Tracking area Information)). When UE goes out of the area, UE can stop to collect AI/ML data or can stop the timer.

(6) The network can configure the conditions when the UE (in RRC CONNECTED or RRC IDLE or RRC INACTIVET state) reports AI/ML data (e.g. report measurement results) and the radio resources where UE send AI/ML data (or report the measurement results), e.g time/frequency resource, by RRC message (e.g. RRCReconfiguration or RRCRelease), e.g. the threshold, explicit indication, timer, etc. The network can send RRCReconfiguration including the following configuration to UE in RRC CONNECTED state. The network can also send RRCRelease including the following configuration when it transits UE to RRC IDLE or RRC INACTIVE state.

(6-1) The network can configures a periodicity in which the UE should report AI/ML data (or report measurement results). The UE can send (or report) AI/ML data to the network through RRC message or MAC CE or configured grant (i.e. radio resources) for PUCCH or PUSCH, periodically.

(6-2) Upon the reception of an explicit indication from the network, the UE can report AI/ML data (or report measurement results) through RRC message or MAC CE or configured grant (i.e. time/frequency radio resources) for PUCCH or PUSCH. The network can send the explicit indication to UE by RRC message (e.g. RRCReconfiguration or RRCRelease message) or MAC CE (Control Element) or PDCCH (Physical Downlink Control CHannel) DCI (Downlink Control Information) when or whether or where (e.g. radio resource for reporting) to report AI/ML data (or perform measurement) or which measurement object should be measured (e.g. CSI or beam or SSB or frequency or cell identity) or change of the target AI/ML data.

(6-3) The network can configure a timer (e.g. T3xx) to UE by RRC message (e.g. RRCReconfiguration or RRCRelease message). When the timer is configured, UE can start the timer. Whenever the timer expires, UE can report AI/ML data (or report measurement results) through RRC message or MAC CE or configured grant (i.e. time/frequency radio resources) for PUCCH or PUSCH. After reporting (or sending AI/ML data), UE can restart the timer.

(6-4) The threshold values can be configured to let UE know the condition when UE report AI/ML data (or perform measurement). UE reports AI/ML data when the condition is met. For example, if one specific measure is larger (or smaller) than one threshold or/and if another specific measure (e.g.) is larger (or smaller) than another threshold, UE can consider the condition as met. The specific measures can be RSRP (Reference Signal Received Power) or RSRQ (Reference Signal Received Quality) or SINR (Signal-to-interference-plus-noise ratio) or time, etc. The condition can be generated with one or more than one threshold value based on configuration.

Step 2: As set out above, the UE collects AI/ML data or the indicated measurement(s) based on the configured conditions or periodically (e.g. for configured radio resource) or upon the reception of explicit indication or the expiry of timer, e.g., UE measurements related to RSRP, RSRQ, SINR of serving cell and neighbouring cells.

Step 3-1 and 3-2: As set out above, the UE sends AI/ML data or the measurement report message(s) to NG-RAN node 1 based on the configured conditions or periodically (e.g. for configured radio resource) or upon the reception of explicit indication or the expiry of timer. NG-RAN can collect AI/ML data from UEs or other NG-RANS

Step 4: NG-RAN node 1 further sends AI/ML data or UE measurement reports together with other input data for Model Training to OAM. The AI/ML data can be included in a inter-node message between NG-RAN node and OAM. The inter-node message can also include indication(s) whether the AI/ML data is for Model training or Model inference or Model performance feedback or Model Deployment or Update. The inter-node message can be newly-defined for this purpose. In another embodiment, the legacy inter-node message can be used for this purpose by introducing a new container for AI/ML data and new indications/parameters in the message.

Step 5: NG-RAN node 2 (assumed to have an AI/ML model optionally) also sends AI/ML data or input data for Model Training to OAM. The NG-RAN node 2 sends AI/ML data or the input data for training to OAM, where the input data for training includes the required input information from the NG-RAN node 2. If the NG-RAN node 2 executes the AI/ML model, AI/ML data or the input data for training can include the corresponding inference result from the NG-RAN node 2. The AI/ML data can be included in a inter-node message between NG-RAN node and OAM. The inter-node message can also include indication(s) whether the AI/ML data is for Model training or Model inference or Model performance feedback or Model Deployment or Update. The inter-node message can be newly-defined for this purpose. In another embodiment, the legacy inter-node message can be used for this purpose by introducing a new container for AI/ML data and new indications/parameters in the message.

Step 6: Model Training at OAM. AI/ML data or required measurements and input data from other NG-RAN nodes are leveraged to train AI/ML models for network energy saving/load balancing/mobility optimization.

Step 7: OAM deploys/updates AI/ML model into the NG-RAN node(s). The NG-RAN node can also continue model training based on the received AI/ML model from OAM. OAM sends AI/ML Model Deployment Message to deploy the trained/updated AI/ML model into the NG-RAN node(s). The NG-RAN node can also continue model training based on the received AI/ML model from OAM. The AI/ML model or update parameters can be included in a inter-node message between NG-RAN node and OAM. The inter-node message can also include indication(s) whether this is for Model Deployment or Model Update. The inter-node message can be newly-defined for this purpose. In another embodiment, the legacy inter-node message can be used for this purpose by introducing a new container for AI/ML model and new indications/parameters in the message.

Step 8: NG-RAN node 2 sends AI/ML data or the required input data to NG-RAN node 1 for model inference. The NG-RAN node 1 receives from the neighbouring NG-RAN node 2 AI/ML data or the input information for model inference. The AI/ML data can be included in a inter-node message between NG-RAN nodes. The inter-node message can also include indication(s) whether the AI/ML data is for Model training or Model inference or Model performance feedback or Model Deployment or Update. The inter-node message can be newly-defined for this purpose. In another embodiment, the legacy inter-node message can be used for this purpose by introducing a new container for AI/ML data and new indications/parameters in the message.

Step 9-1 and 9-2: NG-RAN node 1 can update the AI/ML configuration for AI/ML data or reporting. The same procedure can be done as Step 3-1 and 3-2.

Step 10: Based on AI/ML data or local inputs of NG-RAN node 1 and received AI/ML data or inputs from NG-RAN node 2, NG-RAN node 1 generates model inference output(s) (e.g., energy saving strategy, load balancing, handover strategy, mobility optimization etc). NG-RAN node 1 performs model inference and generate predictions or decisions, i.e. Model Inference. AI/ML data or required measurements are leveraged into Model Inference to output the prediction, e.g., UE trajectory prediction, target cell prediction, target NG-RAN node prediction, etc.

Step 11: NG-RAN node 1 sends Model Performance Feedback to OAM if applicable. The AI/ML data can be included in a inter-node message between NG-RAN node and OAM. The inter-node message can also include indication(s) whether the AI/ML data is for Model training or Model inference or Model performance feedback or Model Deployment or Update. The inter-node message can be newly-defined for this purpose. In another embodiment, the legacy inter-node message can be used for this purpose by introducing a new container for AI/ML data and new indications/parameters in the message.

Step 12: NG-RAN node 1 executes actions, e.g. Network energy saving actions or Load Balancing actions or Mobility Optimization/handover procedure according to the model inference output. NG-RAN node 1 may select the most appropriate target cell for each UE before it performs handover, if the output is handover strategy. NG-RAN node 1 may take Load Balancing actions and the UE is moved from NG-RAN node 1 to NG-RAN node 2. According to the prediction, recommended actions or configuration, the NG-RAN node 1, the target NG-RAN node (represented by NG-RAN node 2 of this step in the flowchart), and UE perform the Mobility Optimization/handover procedure to hand over UE from NG-RAN node 1 to the target NG-RAN node. The AI/ML data (e.g. actions) can be included in a inter-node message between NG-RAN nodes (e.g. between NG-RAN node 1 and NG-RAN node 2). The inter-node message can also include indication(s) whether the AI/ML data is for transferring actions or decision. The inter-node message can be newly-defined for this purpose. In another embodiment, the legacy inter-node message can be used for this purpose by introducing a new container for AI/ML data and new indications/parameters in the message.

Step 13: NG-RAN node 2 can provides feedback to OAM. The AI/ML data (e.g. feedback) can be included in a inter-node message between NG-RAN nodes (e.g. between NG-RAN node 1 and NG-RAN node 2). The inter-node message can also include indication(s) whether the AI/ML data is for Model training or Model inference or Model performance feedback or Model Deployment or Update. The inter-node message can be newly-defined for this purpose. In another embodiment, the legacy inter-node message can be used for this purpose by introducing a new container for AI/ML data and new indications/parameters in the message.

Step 14: NG-RAN node 1 can provides feedback to OAM. The AI/ML data (e.g. feedback) can be included in a inter-node message between NG-RAN nodes (e.g. between NG-RAN node 1 and NG-RAN node 2). The inter-node message can also include indication(s) whether the AI/ML data is for Model training or Model inference or Model performance feedback or Model Deployment or Update. The inter-node message can be newly-defined for this purpose. In another embodiment, the legacy inter-node message can be used for this purpose by introducing a new container for AI/ML data and new indications/parameters in the message.

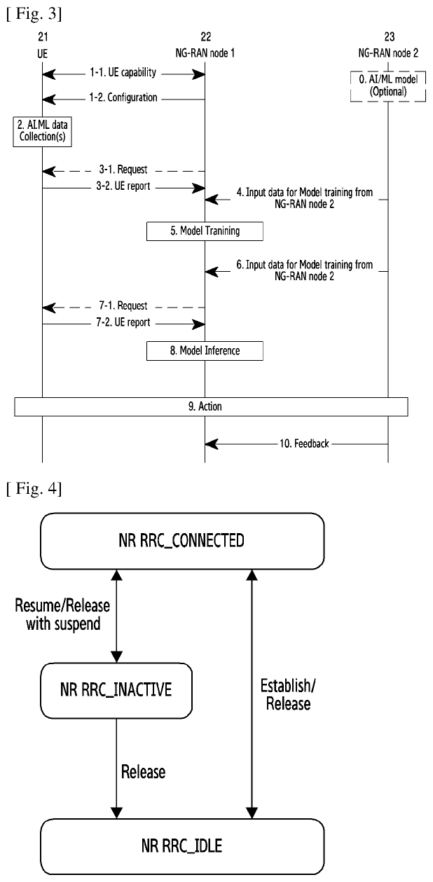

A further embodiment relates to AI/ML Model Training and AI/ML Model Inference at NG-RAN. In this embodiment, NG-RAN is responsible for model training and generates energy saving decisions. This is illustrated in FIG. 3. The references to steps in the following relate to FIG. 3.

For UE configuration, the network can send a RRC message (e.g

RRCReconfiguration or RRCSetup or RRCResume or newly defined RRC message) to UE 21 in order to configure the type of AI/ML configuration, e.g. algorithms or models, the related timers, parameters for measurement (e.g beam, CSI, SSB, frequency), conditions, or the type of reporting (or collection), and so on.

Step 0: NG-RAN node 2 (23) is assumed to have an AI/ML model optionally, which can provide NG-RAN node 1 (22) with input information.

Step 1-1: The network (or the cell) broadcasts the system information including the indication of AI/ML functionality support. In this cell, UEs in RRC IDLE state and RRC INACTIVE state can report the results corresponding to the configured request (e.g. AI/ML configuration) which was configured in RRC CONNECTED state by RRCRelease message including mode change indication from RRC CONNECTED to RRC IDLE/RRC INACTIVE state or by RRCReconfiguration message. When UE performs AI/ML data reporting, UE in RRC IDLE or RRC INACTIVE state can send the results (or indication of availability of the results) by RRC message (e.g. RRCSetupRequest or RRCSetupComplete or RRCResumeRequest or RRCResumeComplete) staying in RRC IDLE or RRC INACTIVE state. If the network want UE to request the results, the network send a RRC message including the indication for report (e.g. RRCSetup or RRCResume) and UE can report it by a RRC message (e.g. RRCSetupComplete or RRCResumeComplete). In another embodiment, when UE performs AI/ML data reporting, UE in RRC IDLE or RRC INACTIVE state can send the results (or indication of availability of the results) after setting up RRC connection with the network (going to RRC CONNECTED state) by RRC message (e.g. RRCSetupComplete or RRCResumeComplete) in RRC CONNECTED state. If the network want UE to request the results, the network send a RRC message including the indication for AI/ML data report (e.g. UEInformationRequest messages) and UE can report it by a RRC message (e.g. UEInformationResponse messages). When the network requests UE to report UE capability information by sending UE CapabilityEnquiry message, the UE can send UEcapabilityInformation message including the capability of AI/ML functionality support. When UE stays in RRC CONNECTED state, UE can perform AI/ML data collection and reporting based on the configuration or request as specified in Step 1-2, 2, 3-1, and 3-2.

Step 1-2: NG-RAN node 1 configures AI/ML configuration to UE (e.g. the measurement information on the UE side) and sends configuration message (e.g RRCReconfiguation, RRCSetup, or RRCResume or RRCRelease message or newly defined message) to UE to perform AI/ML functionality (e.g. measurement procedure and reporting). The NG-RAN node 1 can also configures the UE to provide AI/ML data (e.g. measurements and/or location information, RRM measurements, MDT measurements, velocity, position, time information for measurement, measurement duration, sequence number for reordering training data, or CSI (e.g. aperiodic CSI or periodic CSI) or measurement results for frequency (or cell identity or beam or SSB)).

The AI/ML configuration information can include one of the followings:

(1) The network can configure a SRB (e.g. SRB1, SRB2, SRB3, SRB4, or SRBx) to make UE report the AI/ML data through the SRB to the network by sending RRC message. In another embodiment, the network can configure a DRB (e.g. with special logical channel identity or bearder identity) to make UE report the AI/ML data through the DRB to the network by sending RRC message including configuration. The network can configure radio resource (e.g. time and frequency resources for PUCCH (Physical Uplink Control Channel) or PUSCH (Physical Uplink Shared Channel)) to make UE report the AI/ML data through the configured resources (e.g. UL grant or SPS (Semi Persistent Scheduling) grant (i.e radio resource) or Configured grant).

(2) The configuration information for the SRB or the DRB can include the AS security configuration, i.e. whether to perform ciphering (or integrity protection) or not.

(2-1) A lot of the AI/ML data may need to be reported to the network, i.e. frequent reporting may be needed. To reduce UE's processing burden resulted from ciphering or integrity protection, the ciphering function or integrity protection function may not be configured for the SRB or the DRB, i.e. either ciphering only or integrity protection only or no ciphering and no integrity protection can be configured. In another embodiment, the configured AS security (ciphering or integrity protection) of the SRB (or DRB) for AI/ML data reporting can be activated or deactivated by RRC message or MAC CE or PDCP control PDU or PDCCH DCI to control UE processing burden.

(2-2) A lot of the AI/ML data may need to be reported to the network. To avoid frequent reporting, UE can include many AI/ML data information in a proposed message structure of one RRC message (e.g. measurement reporting message or RRC message for reporting), i.e. UE can report a lot of AI/ML data with one message (e.g. RRC message or MAC CE). The proposed message can include a sequence number or a timing information for each AI/ML data to let the receiver sort them in chronological order. How many AI/ML data should be included in the reporting message can be configured by RRC message (e.g. in AI/ML configuration). The detailed message structure is set out later.

(2-3) A lot of the AI/ML data may need to be reported to the network, i.e. frequent reporting may be needed. To reduce UE's processing burden resulted from ciphering or integrity protection, RRC layer can indicate to PDCP layer whether each RRC message (or AI/ML data) need to be integrity protected or not as well as whether each RRC message (or AI/ML data) need to be ciphered or not by using indication. It can be applied to configured SRB or DRB for AI/ML data. In another embodiment, the configured AS security (ciphering or integrity protection) of the SRB (or DRB) for AI/ML data reporting can be activated or deactivated by RRC message or MAC CE or PDCP control PDU or PDCCH DCI to control UE processing burden.

(3) The configuration information includes the prioritization information for AI/ML data. Given that it is very important to send/receive the general RRC messages with low latency and high reliability due to UE's connection management and mobility support, the AI/ML data may not be urgent, i.e. not time-sensitive. Hence, the prioritization mechanism can be configured and used for prioritize other RRC messages over the reporting message for AI/ML data.

(3-1) SRB1 or SRB2 or SRB3 or SRB4 can be configured and used for the transmission/reception of RRC messages which include AI/ML data. The RRC messages can have lower priority than the first RRC messages (e.g. a piggybacked NAS message, NAS messages prior to the establishment of SRB2, RRC messages for setting up (re-)connection and (re-)configuration, i.e. RRCSetupRequest, RRCSetup, RRCSetupComplete, RRCResumeRequest, RRCResume, RRCResumeComplete, RRCReconfiguration, RRCReconfigurationComplete, RRCReestablishment RRCReestablishmentRequest, etc) because the first RRC messages are much more important than the RRC messages for AI/ML data to support UE's connection management and mobility support. When the first RRC messages and the RRC messages for AI/ML data are generated together or simultaneously (or co-exist in buffer), then the first RRC message can be prioritized over the RRC messages for AI/ML data and can be submitted to lower layers (e.g. PDCP layer) and sent first.

(3-2) SRBx or a DRB can be configured and used only for the transmission/reception of messages which include AI/ML data.

(3-3) For AI/ML data through the configured RB as above, the network can do assignment/modification of semi-persistent scheduling (SPS) configuration and configured grant configuration for DL and UL respectively, assignment/modification of parameters for UL rate control in the UE, i.e. allocation of a priority and a PBR (LCP parameters for LCP procedure in MAC layer) for each RB of UE and logical channel identifier, and assignment of separate SCell configuration or separate BWP (BandWidth Part) configuration, in order to control prioritization between messages including AI/ML data and other messages (or data).

(4) The configuration information includes the configuration for AI/ML data and AI/ML configuration (e.g. CSI-MeasConfig or MeasConfig specified in Section 5) as described earlier.

(5) The network can configure the conditions when UE (in RRC CONNECTED or RRC IDLE or RRC INACTIVET state) starts to collect AI/ML data (or perform measurement) by RRC message (e.g. RRCReconfiguration or RRCRelease), e.g. the threshold, explicit indication, timer, etc. The network can send RRCReconfiguration including the following configuration to UE in RRC CONNECTED state. The network can also send RRCRelease including the following configuration when it transits UE to RRC IDLE or RRC INACTIVE state.

(5-1) The threshold values can be configured to let UE know the condition when UE starts to collect AI/ML data (or perform measurement). UE starts to collect AI/ML data when the condition is met. For example, if one specific measure is larger (or smaller) than one threshold or/and if another specific measure (e.g.) is larger (or smaller) than another threshold, UE can consider the condition as met. The specific measures can be RSRP (Reference Signal Received Power) or RSRQ (Reference Signal Received Quality) or SINR (Signal-to-interference-plus-noise ratio) or time, etc. The condition can be generated with one or more than one threshold value based on configuration. The network can configures a periodicity in which the UE should collect AI/ML data (or perform measurement).

(5-2) The network can configure the conditions or type or size to let UE know which AI/ML data (or how much AI/ML data) should be collected by RRC message.

(5-3) The network can send an explicit indication to UE by RRC message (e.g. RRCReconfiguration or RRCRelease message) or MAC CE (Control Element) or PDCCH (Physical Downlink Control CHannel) DCI (Downlink Control Information) when to start (or activate) or stop (or deactivate) to collect AI/ML data (or perform measurement) or which measurement object should be measured (e.g. CSI or beam or SSB or frequency or cell identity) or change of the target AI/ML data. When UE receives the indication by the RRC message, UE can start or stop to collect AI/ML data met the conditions configured by the network and store them.

(5-4) The network can configure a timer (e.g. T3xx) to UE by RRC message (e.g. RRCReconfiguration or RRCRelease message). When the timer is configured, UE can start the timer and can collect AI/ML data (or perform measurement) while the timer is running. After the expiry of the timer, UE can stop it. If UE is in RRC IDLE or RRC INACTIVE state, UE can stop the timer upon the reception of RRCSetup or RRCResume message to transit to RRC CONNECTED state. An area information can be configured to make UE collect AI/ML data (i.e. perform measurement) within the configured area. The configure area can be defined with cell identity (i.e. physical cell identity or TAI (Tracking area Information)). When UE goes out of the area, UE can stop to collect AI/ML data or can stop the timer.

(6) The network can configure the conditions when the UE (in RRC CONNECTED or RRC IDLE or RRC INACTIVET state) reports AI/ML data (e.g. report measurement results) and the radio resources where UE send AI/ML data (or report the measurement results), e.g time/frequency resource, by RRC message (e.g. RRCReconfiguration or RRCRelease), e.g. the threshold, explicit indication, timer, etc. The network can send RRCReconfiguration including the following configuration to UE in RRC CONNECTED state. The network can also send RRCRelease including the following configuration when it transits UE to RRC IDLE or RRC INACTIVE state.

(6-1) The network can configures a periodicity in which the UE should report AI/ML data (or report measurement results). The UE can send (or report) AI/ML data to the network through RRC message or MAC CE or configured grant (i.e. radio resources) for PUCCH or PUSCH, periodically.

(6-2) Upon the reception of an explicit indication from the network, the UE can report AI/ML data (or report measurement results) through RRC message or MAC CE or configured grant (i.e. time/frequency radio resources) for PUCCH or PUSCH. The network can send the explicit indication to UE by RRC message (e.g. RRCReconfiguration or RRCRelease message) or MAC CE (Control Element) or PDCCH (Physical Downlink Control CHannel) DCI (Downlink Control Information) when or whether or where (e.g. radio resource for reporting) to report AI/ML data (or perform measurement) or which measurement object should be measured (e.g. CSI or beam or SSB or frequency or cell identity) or change of the target AI/ML data.

(6-3) The network can configure a timer (e.g. T3xx) to UE by RRC message (e.g. RRCReconfiguration or RRCRelease message). When the timer is configured, UE can start the timer. Whenever the timer expires, UE can report AI/ML data (or report measurement results) through RRC message or MAC CE or configured grant (i.e. time/frequency radio resources) for PUCCH or PUSCH. After reporting (or sending AI/ML data), UE can restart the timer.

(6-4) The threshold values can be configured to let UE know the condition when UE report AI/ML data (or perform measurement). UE reports AI/ML data when the condition is met. For example, if one specific measure is larger (or smaller) than one threshold or/and if another specific measure (e.g.) is larger (or smaller) than another threshold, UE can consider the condition as met. The specific measures can be RSRP (Reference Signal Received Power) or RSRQ (Reference Signal Received Quality) or SINR (Signal-to-interference-plus-noise ratio) or time, etc. The condition can be generated with one or more than one threshold value based on configuration.

Step 2: As proposed above, the UE collects AI/ML data or the indicated measurement(s) based on the configured conditions or periodically (e.g. for configured radio resource) or upon the reception of explicit indication or the expiry of timer, e.g., UE measurements related to RSRP, RSRQ, SINR of serving cell and neighbouring cells.

Step 3-1 and 3-2: As proposed above, the UE sends AI/ML data or the measurement report message(s) to NG-RAN node 1 based on the configured conditions or periodically (e.g. for configured radio resource) or upon the reception of explicit indication or the expiry of timer. NG-RAN can collect AI/ML data from UEs or other NG-RANs.

Step 4: NG-RAN node 2 sends the required input data to NG-RAN node 1 for Model training. The NG-RAN node 1 obtains the input data for training from the NG-RAN node2, where the input data for training includes the required input information from the NG-RAN node 2. If the NG-RAN node 2 executes the AI/ML model, the input data for training can include the corresponding inference result from the NG-RAN node 2. The AI/ML data can be included in a inter-node message between NG-RAN nodes (e.g. between NG-RAN node 1 and NG-RAN node 2). The inter-node message can also include indication(s) whether the AI/ML data is for Model training or Model inference or Model performance feedback or Model Deployment or Update. The inter-node message can be newly-defined for this purpose. In another embodiment, the legacy inter-node message can be used for this purpose by introducing a new container for AI/ML data and new indications/parameters in the message.

Step 5: NG-RAN node 1 trains AI/ML model for the configured purpose based on collected data. NG-RAN node 2 is assumed to have AI/ML model optionally, which can also generate predicted results/actions. An AI/ML Model Training is located at NG-RAN node 1. The AI/ML data, required measurements and input data from other NG-RAN nodes are leveraged to train the AI/ML model.

Step 6: NG-RAN node 2 sends AI/ML data (e.g. the required input data) to NG-RAN node 1 for model inference. NG-RAN node 1 receives AI/ML data (e.g. UE measurements and/or location information). The AI/ML data can be included in a inter-node message between NG-RAN nodes (e.g. between NG-RAN node 1 and NG-RAN node 2). The inter-node message can also include indication(s) whether the AI/ML data is for Model training or Model inference or Model performance feedback or Model Deployment or Update. The inter-node message can be newly-defined for this purpose. In another embodiment, the legacy inter-node message can be used for this purpose by introducing a new container for AI/ML data and new indications/parameters in the message.

Step 7: UE sends the AI/ML data (e.g. UE measurement report(s)) to NG-RAN node 1. NG-RAN node 1 can update the AI/ML configuration for AI/ML data or reporting. The same procedure can be done as Step 3-1 and 3-2.

Step 8: Based on AI/ML data (e.g. local inputs of NG-RAN node 1 and received inputs from NG-RAN node 2), NG-RAN node 1 generates model inference output (e.g., energy saving strategy, handover strategy, Load Balancing predictions or decisions, etc). AI/ML data are leveraged into Model Inference to output the prediction, including e.g., UE trajectory prediction, target cell prediction, target NG-RAN node prediction, etc.

Step 9: NG-RAN node 1 executes actions, e.g. Network energy saving actions or Load Balancing actions or Mobility Optimization/handover procedure according to the model inference output. NG-RAN node 1 may select the most appropriate target cell for each UE before it performs handover, if the output is handover strategy. NG-RAN node 1 may take Load Balancing actions and the UE is moved from NG-RAN node 1 to NG-RAN node 2. According to the prediction, recommended actions or configuration, the NG-RAN node 1, the target NG-RAN node (represented by NG-RAN node 2 of this step in the flowchart), and UE perform the Mobility Optimization/handover procedure to hand over UE from NG-RAN node 1 to the target NG-RAN node. The AI/ML data (e.g. actions) can be included in a inter-node message between NG-RAN nodes (e.g. between NG-RAN node 1 and NG-RAN node 2). The inter-node message can also include indication(s) whether the AI/ML data is for transferring actions or decision. The inter-node message can be newly-defined for this purpose. In another embodiment, the legacy inter-node message can be used for this purpose by introducing a new container for AI/ML data and new indications/parameters in the message.

Step 10: NG-RAN node 2 provides feedback to NG-RAN node 1. NG-RAN node 2 sends feedback information to NG-RAN node 1 (e.g., resource status updates after load balancing, etc). The AI/ML data (e.g. feedback) can be included in a inter-node message between NG-RAN nodes (e.g. between NG-RAN node 1 and NG-RAN node 2). The inter-node message can also include indication(s) whether the AI/ML data is for Model training or Model inference or Model performance feedback or Model Deployment or Update. The inter-node message can be newly-defined for this purpose. In another embodiment, the legacy inter-node message can be used for this purpose by introducing a new container for AI/ML data and new indications/parameters in the message.

Note: UE mobility information for training purposes is only sent to gNBs that requested such information or when triggered.

The configuration and mechanism can be extended to the following scenarios:
Scenario 1. AI/ML Model Training and AI/ML Model Inference are both located in the UE.

In case of UE configured with AI/ML model (or AI/ML model functions (e.g. training or inference)) by RRC messages or newly-defined messages, e.g. Federated learning model or split learning model:
Scenario 2. AI/ML Model Training is located in UE and AI/ML Model Inference is located in the gNB or OAM.
Scenario 3. AI/ML Model Training is located in the gNB or OAM and AI/ML Model Inference is located in the UE.

In this scenario, UE can collect AI/ML data or receive AI/ML data from the network (e.g NG-RAN or OAM). Based on AI/ML data, UE can train (or update) AI/ML Model or generate model inference outputs or take actions. UE can also send the trained AI/ML model or inference outputs or updated parameters to the network (e.g. NG-RAN or OAM). For this delivery, the AI/ML model or update parameters or AI/ML data can be included in a RRC message (or NAS message) between NG-RAN node (or OAM) and UE. The inter-node message can also include indication(s) whether this is for Model training or Model inference (or inference outputs) or Model performance feedback or Model Deployment or Update. The RRC message (or NAS (Non-Access Stratum) message) can be newly-defined for this purpose. In another embodiment, the legacy RRC message (or NAS message) can be used for this purpose by introducing a new container for AI/ML model and new indications/parameters in the message.

In this invention, the inter-node message can indicate Xn messages or NAS messages or RRC messages.

An embodiment of the invention relates to Network Energy Saving.

To predict the optimized network energy saving decisions, NG-RAN may need following information as input data for AI/ML-based network energy saving:

From local node:
UE mobility/trajectory prediction
Current/Predicted Energy efficiency
Current/Predicted resource status

From the UE:
UE location information (e.g., coordinates, serving cell ID, moving velocity) interpreted by gNB implementation when available
UE measurement report (e.g., UE RSRP, RSRQ, SINR measurement, etc), including cell level and beam level UE measurements

From neighbouring NG-RAN nodes:
Current/Predicted energy efficiency
Current/Predicted resource status
Current energy state (e.g., active, high, low, inactive)

If existing UE measurements are needed by a gNB for AI/ML-based network energy saving, RAN3 shall reuse the existing framework (including MDT and RRM measurements).

### Output of AI/ML-based Network Energy Saving

AI/ML-based network energy saving model can generate following information as output:
Energy saving strategy, such as recommended cell activation/deactivation.
Handover strategy, including recommended candidate cells for taking over the traffic
Predicted energy efficiency
Predicted energy state (e.g., active, high, low, inactive)
Model output validity time will be discussed during R18 normative work per inference output.

### Feedback of AI/ML-Based Network Energy Saving

To optimize the performance of AI/ML-based network energy saving model, following feedback can be considered to be collected from NG-RAN nodes:
Resource status of neighbouring NG-RAN nodes
Energy efficiency
UE performance affected by the energy saving action (e.g., handed-over UEs), including bitrate, packet loss, latency.
System KPIs (e.g., throughput, delay, RLF of current and neighbouring NG-RAN node)

A further embodiment relates to Load Balancing.

To predict the optimized load balancing decisions, NG-RAN may need following information as input data for AI/ML-based load balancing:

From the local node:
Current and predicted own resource status
UE trajectory prediction
Current and predicted UE traffic
Predicted resource status information of neighbouring NG-RAN node(s)

From the UE:
UE location information (e.g., coordinates, serving cell ID, moving velocity) interpreted by gNB implementation when available
UE Mobility History Information
UE measurement report (e.g., UE RSRP, RSRQ, SINR measurement, etc), including cell level and beam level UE measurements

From neighbouring NG-RAN Nodes:
Current and predicted resource status
UE performance measurement at traffic offloaded neighbouring cell

AI/ML-based load balancing model can generate following information as output:
Selection of target cell for load balancing
Predicted own resource status information
Predicted resource status information of neighbouring NG-RAN node(s)
Model output validity time will be discussed during R18 normative work per inference output.
The predicted UE(s) selected to be handed over to target NG-RAN node (will be used by RAN node internally)

To optimize the performance of AI/ML-based load balancing model, following feedback can be considered to be collected from NG-RAN nodes:
UE performance information from target NG-RAN (for those UEs handed over from the source NG-RAN node)
Resource status information updates from target NG-RAN
System KPIs (e.g., throughput, delay, RLF of current and neighbours)

An embodiment of the invention relates to Mobility Optimisation

The following data is required as input data for mobility optimization.

From the UE:
UE location information (e.g., coordinates, serving cell ID, moving velocity) interpreted by gNB implementation when available.
Radio measurements related to serving cell and neighbouring cells associated with UE location information, e.g., RSRP, RSRQ, SINR.
UE Mobility History Information.

From the neighbouring RAN nodes:
UE's history information from neighbour
Position, QoS parameters and the performance information of historical HO-ed UE (e.g., loss rate, delay, etc.)
Current/predicted resource status
UE handovers in the past that were successful and unsuccessful, including too-early, too-late, or handover to wrong (sub-optimal) cell, based on existing SON/RLF report mechanism.

From the local node:
UE trajectory prediction
Current/predicted resource status
Current/predicted UE traffic

AI/ML-based mobility optimization can generate following information as output:
UE trajectory prediction (Latitude, longitude, altitude, cell ID of UE over a future period of time)

Note: Whether the UE trajectory prediction is an external output to the node hosting the Model Inference function may be discussed during the normative work phase.
Estimated arrival probability in CHO and relevant confidence interval
Predicted handover target node, candidate cells in CHO, may together with the confidence of the predication
Priority, handover execution timing, predicted resource reservation time window for CHO.
UE traffic prediction (will be used by the RAN node internally and the details are left to normative work phase)
Model output validity time will be discussed during R18 normative work per inference output.

The following data is required as feedback data for mobility optimization.
QoS parameters such as throughput, packet delay of the handed-over UE, etc.
Resource status information updates from target NG-RAN.
Performance information from target NG-RAN. The details of performance information are to be discussed during normative work phase.

The following provides details regarding an RRC procedure to handle AI/ML functionality.

A UE is either in RRC_CONNECTED state or in RRC_INACTIVE state when an RRC connection has been established. If this is not the case, i.e. no RRC connection is established, the UE is in RRC_IDLE state. The RRC states can further be characterised as follows:
RRC_IDLE:
A UE specific DRX may be configured by upper layers;
At lower layers, the UE may be configured with a DRX for PTM transmission of MBS broadcast;
UE controlled mobility based on network configuration;
The UE:
Monitors Short Messages transmitted with P-RNTI over DCI (see clause 6.5);
Monitors a Paging channel for CN paging using 5G-S-TMSI, except if the UE is acting as a L2 U2N Remote UE;
If configured by upper layers for MBS multicast reception, monitors a Paging channel for CN paging using TMGI;
Performs neighbouring cell measurements and cell (re-)selection;
Acquires system information and can send SI request (if configured);
Performs logging of available measurements together with location and time for logged measurement configured UEs;
Performs idle/inactive measurements for idle/inactive measurement configured UEs;
Performs AI/ML functionality (e.g. collection of AI/ML data or measurements for AI/ML data or reporting AI/ML data) configured UEs;
If configured by upper layers for MBS broadcast reception, acquires MCCH change notification and MBS broadcast control information and data.
RRC_INACTIVE:
A UE specific DRX may be configured by upper layers or by RRC layer;
At lower layers, the UE may be configured with a DRX for PTM transmission of MBS broadcast;
UE controlled mobility based on network configuration;
The UE stores the UE Inactive AS context;
A RAN-based notification area is configured by RRC layer;
Transfer of unicast data and/or signalling to/from UE over radio bearers configured for SDT.

The UE:
Monitors Short Messages transmitted with P-RNTI over DCI (see clause 6.5);
During SDT procedure, monitors control channels associated with the shared data channel to determine if data is scheduled for it;
While SDT procedure is not ongoing, monitors a Paging channel for CN paging using 5G-S-TMSI and RAN paging using fullI-RNTI, except if the UE is acting as a L2 U2N Remote UE;
If configured by upper layers for MBS multicast reception, while SDT procedure is not ongoing, monitors a Paging channel for paging using TMGI;
Performs neighbouring cell measurements and cell (re-)selection;
Performs RAN-based notification area updates periodically and when moving outside the configured RAN-based notification area;
Acquires system information, while SDT procedure is not ongoing, and can send SI request (if configured);
While SDT procedure is not ongoing, performs logging of available measurements together with location and time for logged measurement configured UEs;
While SDT procedure is not ongoing, performs idle/inactive measurements for idle/inactive measurement configured UEs;
While SDT procedure is not ongoing, performs AI/ML functionality (e.g. collection of AI/ML data or measurements for AI/ML data or reporting AI/ML data) configured UEs;
If configured by upper layers for MBS broadcast reception, acquires MCCH change notification and MBS broadcast control information and data;
Transmits SRS for Positioning.
RRC_CONNECTED:
The UE stores the AS context;
Transfer of unicast data to/from UE;
Transfer of MBS multicast data to UE;
At lower layers, the UE may be configured with a UE specific DRX;
At lower layers, the UE may be configured with a DRX for PTM transmission of MBS broadcast and/or a DRX for MBS multicast;
For UEs supporting CA, use of one or more SCells, aggregated with the SpCell, for increased bandwidth;
For UEs supporting DC, use of one SCG, aggregated with the MCG, for increased bandwidth;
Network controlled mobility within NR, to/from E-UTRA, and to UTRA-FDD;
Network controlled mobility (path switch) between a serving cell and a L2 U2N Relay UE, or vice versa.
The UE:
Monitors Short Messages transmitted with P-RNTI over DCI (see clause 6.5), if configured;
Monitors control channels associated with the shared data channel to determine if data is scheduled for it;
Provides channel quality and feedback information;
Performs neighbouring cell measurements and measurement reporting;
Performs AI/ML functionality (e.g. collection of AI/ML data or measurements for AI/ML data or reporting AI/ML data) configured UEs;
Acquires system information;
Performs immediate MDT measurement together with available location reporting;
If configured by upper layers for MBS broadcast reception, acquires MCCH change notification and MBS broadcast control information and data.

FIG. 4 illustrates an overview of UE RRC state machine and state transitions in NR. A UE has only one RRC state in NR at one time.

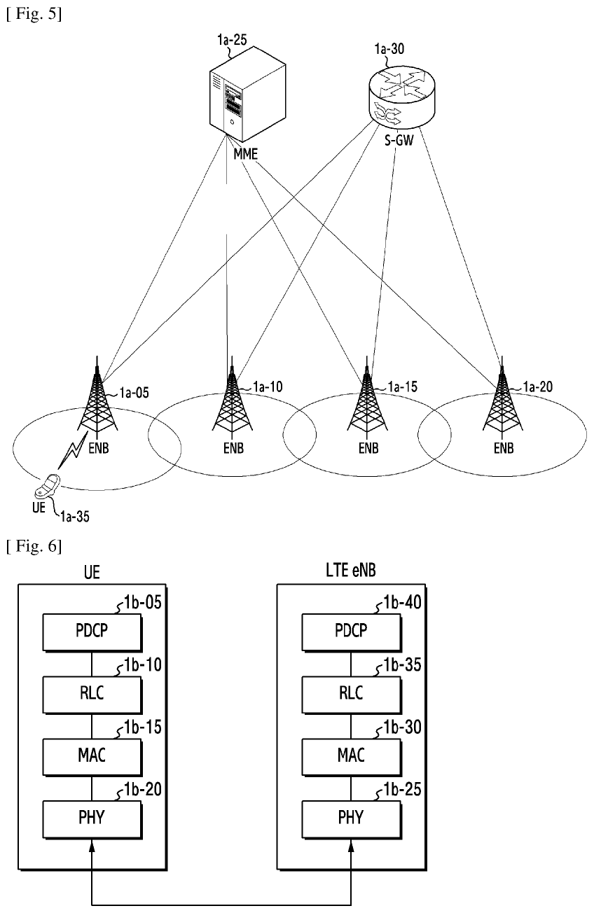

FIG. 5 relates to System architecture and RRC connection control and illustrates the structure of an LTE system to which an embodiment can be applied.

Referring to FIG. 5, a radio access network of an LTE system includes next-generation base stations (also referred to as evolved node Bs, hereinafter eNBs, node Bs, or base stations) 1a-05, 1a-10, 1a-15, and 1a-20, a mobility management entity (MME) 1a-25, and a serving gateway (S-GW) 1a-30. A user equipment (hereinafter UE or terminal) 1a-35 accesses an external network through the eNBs 1a-05 to 1a-20 and S-GW 1a-30.

In FIG. 5, the eNBs 1a-05 to 1a-20 correspond to an existing node B of an UMTS system. The eNBs are connected to the UE 1a-35 through a radio channel, and perform a more complicated role than the existing node B. In the LTE system, since all user traffic pertaining to real-time service, such as voice over IP (VOIP), via the Internet protocol, is serviced through a shared channel, a device that performs scheduling by collecting state information, such as buffer states, available transmit power states, and channel states of UEs, is required, and eNBs 1a-05 to 1a-20 are in charge of this function of the device. In general, one eNB controls multiple cells. For example, in order to implement a transmission rate of 100 Mbps, the LTE system uses orthogonal frequency division multiplexing (OFDM) as a radio access technology in the bandwidth of 20 MHz. In addition, the LTE system adopts an adaptive modulation & coding (hereinafter referred to as AMC) scheme for determining a modulation scheme and a channel coding rate based on the channel state of the UE. The S-GW 1a-30 is a device for providing a data bearer and generating or removing a data bearer under the control of the MME 1a-25. The MME is in charge of various control functions in addition to a mobility management function for the UE, and is connected to multiple base stations.

FIG. 6 illustrates a radio protocol structure in an LTE system to which an embodiment can be applied.

Referring to FIG. 6, the radio protocol of the LTE system includes packet data convergence protocols (PDCPs) 1b-05 and 1b-40, radio link controls (RLCs) 1b-10 and 1b-35, and medium access controls (MACs) 1b-15 and 1b-30, in a UE and an eNB, respectively. The packet data convergence protocols (PDCPs) 1b-05 and 1b-40 are used to perform operations, such as IP header compression/restoration. The main functions of PDCPs are summarized as follows.
Header compression and decompression: ROHC only
Transfer of user data
In-sequence delivery of upper layer PDUs at PDCP re-establishment procedure for RLC acknowledged mode (AM)
Sequence reordering (for split bearers in DC (only support for RLC AM): PDCP PDU routing for transmission and PDCP PDU reordering for reception)
Duplicate detection of lower layer service data units (SDUs) in a PDCP re-establishment procedure for RLC AM
Retransmission of PDCP SDUs at handover and, for split bearers in DC, of PDCP PDUs at PDCP data-recovery procedure, for RLC AM)
Ciphering and deciphering
Timer-based SDU discard in uplink

The radio link control (hereinafter referred to as RLC) 1b-10 and 1b-35 performs ARQ operation by reconfiguring a PDCP protocol data unit (PDU) or RLC service data unit (SDU) to an appropriate size. The main functions of RLC are summarized below.
Transfer of upper layer PDUs
ARQ function (Error correction through ARQ (only for AM data transfer))
Concatenation, segmentation and reassembly of RLC SDUs (only for unacknowledged mode (UM) and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MACs 1b-15 and 1b-30 are connected to multiple RLC layer devices configured in one UE, and may perform an operation of multiplexing RLC PDUs to MAC PDUs and demultiplexing RLC PDUs from MAC PDUs. The main functions of MACs are summarized as follows.
Mapping between logical channels and transport channels
Multiplexing/de-multiplexing of MAC SDUs belonging to one or different logical channels into/from transport blocks (TB) transferred to/from the physical layer on transport channels
Scheduling information reporting
Error correction through hybrid automatic repeat request (HARQ)
Priority handling between logical channels of one UE
Priority handling between UEs by means of dynamic scheduling
MBMS service identification
Transport format selection
Padding

Physical layers 1b-20 and 1b-25 may perform operations of channel coding and modulating upper layer data, forming the upper layer data into an OFDM symbol, transmitting the OFDM symbol through a radio channel, or of demodulating an OFDM symbol received through a radio channel, channel-decoding the OFDM symbol, and transmitting the OFDM symbol to an upper layer.

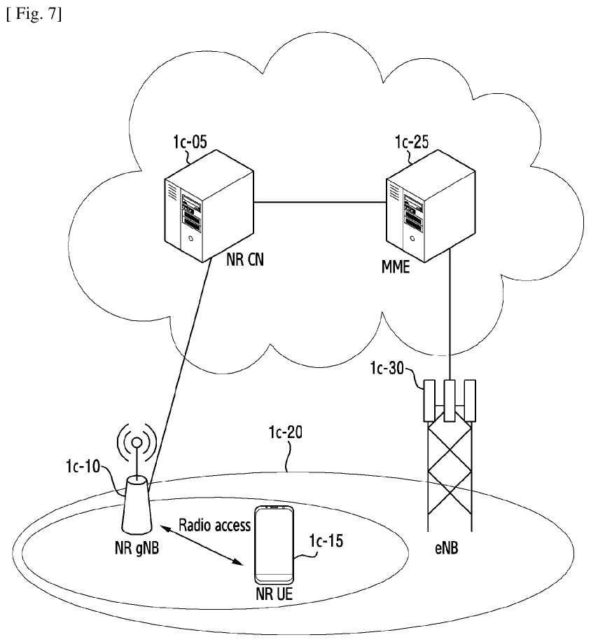

FIG. 7 illustrates the structure of a next-generation mobile communication system to which an embodiment can be applied.

Referring to FIG. 7, a radio access network of a next-generation mobile communication system (hereinafter referred to as NR or 5G) includes a new radio node B (hereinafter referred to as an NR gNB, or NR base station) 1c-10 and a new radio core network (NR CN) 1c-05. A user terminal (a new radio user equipment, hereinafter referred to as NR UE or a UE) 1c-15 accesses an external network via an NR gNB 1c-10 and an NR CN 1c-05.

In FIG. 7, the NR gNB 1c-10 corresponds to an evolved node B (eNB) of the existing LTE system. The NR gNB is connected to the NR UE 1c-15 via a radio channel, and may provide an excellent service as compared to the existing node B. In the next-generation mobile communication system, since all types of user traffics are serviced through a shared channel, there is a need for a device for performing scheduling by collecting state information, such as buffer states, available transmission power states, and channel states of UEs. Further, the NR NB 1c-10 is in charge of this function of the device. In general, one NR gNB typically controls multiple cells. In order to implement ultra-high speed data transmission as compared to the existing LTE, the NR gNB may have the existing maximum bandwidth or more, and may additionally employ beamforming technology using orthogonal frequency division multiplexing (hereinafter referred to as OFDM) as a radio access technology. In addition, the NR gNB adopts an adaptive modulation & coding (AMC) scheme that determines a modulation scheme and a channel coding rate based on the channel state of a UE. The NR CN 1c-05 performs functions, such as mobility support, bearer configuration, QoS configuration, and the like. The NR CN is a device that is in charge of various control functions in addition to a mobility management function for a UE, and is connected to multiple base stations. In addition, the next-generation mobile communication system may also operate in conjunction with the existing LTE system, and the NR CN may be connected to an MME 1c-25 via a network interface. The MME is connected to an eNB 1c-30, that is, to the existing base station.

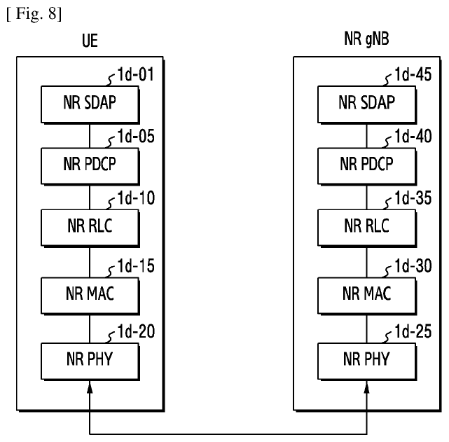

FIG. 8 illustrates a radio protocol structure of a next-generation mobile communication system to which an embodiment can be applied.

Referring to FIG. 8, the radio protocol of the next-generation mobile communication system includes NR SDAPs 1d-01 and 1d-45, NR PDCPs 1d-05 and 1d-40, NR RLCs 1d-10 and 1d-35, and NR MACs 1d-15 and 1d-30, respectively, in a UE and an NR base station.

The main functions of the NR SDAPs 1d-01 and 1d-45 may include some of the following functions.
Transfer of user plane data
Mapping between a QoS flow and a data bearer (DRB) for both downlink (DL) and uplink (UL)
Marking QoS flow ID in both DL and UL packets
Mapping reflective QoS flow to DRB for the UL SDAP PDUs

For the SDAP layer device, the UE may be configured as to whether or not use the header of the SDAP layer device (or new layer device) or the function of the SDAP layer device (or new layer device) for each PDCP layer device, for each bearer, and for each logical channel through an RRC message. When the SDAP header is configured, an NAS reflective QoS reflective configuration 1-bit indicator (NAS reflective QoS) and an AS QoS reflective configuration 1-bit indicator (AS reflective QoS) of the SDAP header are used to instruct the UE to enable updating or reconfiguration of the mapping information relating to the QoS flow of uplink and downlink and data bearer. The SDAP header may include QoS flow ID information indicating QoS. The QoS information may be used as data processing priority, scheduling information, etc., in order to support a smooth service.

The main functions of the NR PDCPs 1d-05 and 1d-40 may include some of the following functions.
Header compression and decompression (ROHC only)
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The reordering function of the NR PDCP device refers to a function of sequentially reordering PDCP PDUs, received from a lower layer, based on a PDCP sequence number (SN), and may include a function of transmitting data to an upper layer in the reordered sequence, a function of directly transmitting data to an upper layer without taking the sequence into consideration, a function of reordering the sequence and recording missing PDCP PDUs, a function of providing a state report on the missing PDCP PDUs to a transmission side, and a function of requesting retransmission of the missing PDCP PDUs.

The main functions of the NR RLCs 1d-10 and 1d-35 may include some of the following functions.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery function of the NR RLC device refers to a function of transmitting RLC SDUs, received from a lower layer, to an upper layer in a sequence of reception, and may include, if one RLC SDU is originally segmented into multiple RLC SDUs and received, a function of reassembling and transmitting the multiple RLC SDUs. The in-sequence delivery function may include a function of reordering the received RLC PDUs based on an RLC SN or PDCP SN, reordering the sequence and recording missing RLC PDUs, providing a state report on the missing RLC PDUs to a transmission side, and requesting retransmission of the missing RLC PDUs. Alternatively, the in-sequence delivery function of the NR RLC device may include a function of sequentially transmitting only RLC SDUs prior to the missing RLC SDU to an upper layer if an RLC SDU is missing, or sequentially transmitting all the RLC SDUs received before a timer starts to an upper layer if the timer expires even if there is a missing RLC SDU, or sequentially transmitting all RLC SDUs received so far to an upper layer if a predetermined timer expires even if there is a missing RLC SDU. In addition, the RLC PDUs may be processed in the sequence in which the RLC PDUS are received (in a sequence of arrival regardless of the serial number or sequence number), and may be transmitted to a PDCP device in out-of-sequence delivery. The in-sequence delivery function may include a function of receiving segments stored in a buffer or segments to be received later, reconfiguring the segments in one complete RLC PDU, processing the RLC PDU, and transmitting the RLC PDU to the PDCP device. The NR RLC layer may not include a concatenation function, and the concatenation function may be performed by the NR MAC layer, or may be replaced by a multiplexing function of the NR MAC layer.

The out-of-sequence delivery function of the NR RLC device refers to a function of directly transmitting the RLC SDUs, received from the lower layer, to an upper layer regardless of the order thereof, and may include, if one RLC SDU has been originally segmented into multiple RLC SDUs and received, a function of reassembling the multiple RLC SDUs and transmitting the same, and a function of storing the RLC SNs or PDCP SNs of the received RLC PDUs, reordering the sequence, and recording the missing RLC PDUs.

The NR MACs 1d-15 and 1d-30 may be connected to multiple NR RLC layer devices configured in one UE, and the main function of the NR MAC may include some of the following functions.
Mapping between logical channels and transport channels
Multiplexing/de-multiplexing of MAC SDUs
Scheduling information reporting
Error correction through HARQ
Priority handling between logical channels of one UE
Priority handling between UEs by means of dynamic scheduling
MBMS service identification
Transport format selection
Padding

The NR PHY layers 1d-20 and 1d-25 may perform operations of channel-coding and modulating upper layer data, forming the upper layer data into an OFDM symbol, transmitting the OFDM symbols via a radio channel or demodulating and channel decoding of the OFDM symbols received via the radio channel, and transferring the OFDM symbol to an upper layer.

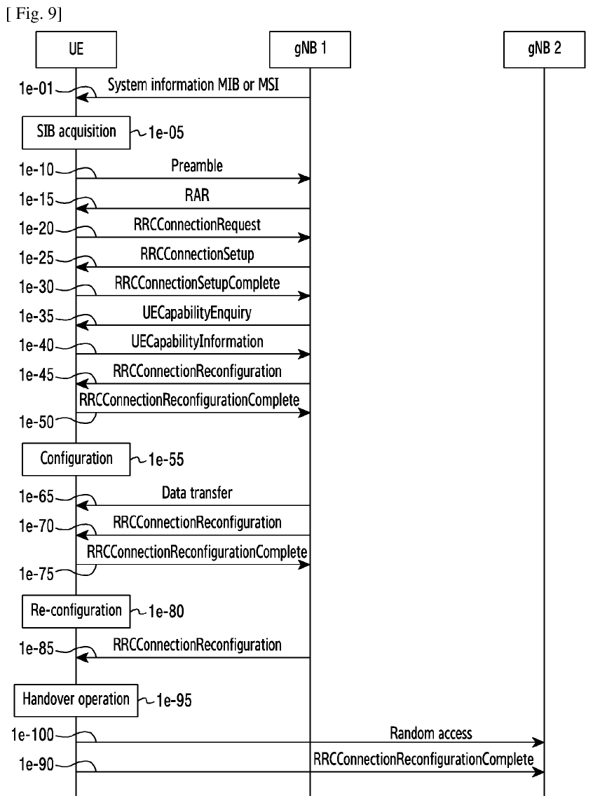

FIG. 9 illustrates a procedure in which a UE switches from an RRC idle mode to an RRC connected mode in a next-generation mobile communication system of a embodiment, and describes a method for configuring a protocol layer device or functions of the UE.

One cell to which a base station provides service may serve a very wide frequency band. First, the UE may search the entire frequency band provided by a service provider (PLMN) in units of predetermined resource blocks (for example, in units of 12 resource blocks (RBs)). That is, the UE may start discovering a primary synchronization sequence (PSS)/secondary synchronization sequence (SSS) in the entire system bandwidth in units of resource blocks. If the UE discovers the PSS/SSS in units of resource blocks and then detects the signals, the UE may read the signals, analyze (decode) the signals, and identify a boundary between a subframe and a radio transmission resource frame (radio frame). If the UE completes synchronization, the UE may read system information of a cell on which the UE currently camps. That is, the UE may identify information on a control resource set (CORESET) by identifying a master system information block (MIB) or minimum system information (MSI) and identify initial access bandwidth part (BWP) information by reading system information in operation 1e-01 and 1e-05. In the above, CORESET information refers to the location of time/frequency transmission resources through which a control signal is transmitted from the base station, and may be, for example, the location of resources through which a PDCCH channel is transmitted.

As described above, if the UE completes synchronization of the downlink signal with the base station and is able to receive a control signal, the UE may perform a random-access procedure in the initial BWP, receive a random-access response, make a request for configuring an RRC connection, receive an RRC message, and configure the RRC connection in operations 1e-10, 1e-15, 1e-20, 1e-25, and 1e-30.

In the above, the basic RRC connection is completed, the base station may transmit an RRC message which asks about a UE capability to the UE (UECapabilityEnquire) in order to identify the UE capability in operation 1e-35. In another method, the base station may ask the MME or the AMF about the UE capability in order to identify the UE capability. This is because the MME or the AMF may have UE capability information if the UE previously accessed the MME or the AMF.

In the above, the UE performs a UE capability report procedure, the RRC message (e.g., non-access stratum (NAS) message or access stratum (AS) message) for reporting UE capability may include some or multiple pieces of information for AI/ML functionality.

If there is no UE capability information desired by the base station, the base station may request the UE capability from the UE.

The base station transmits the RRC message to the UE to identify UE performance, for example, to identify how much of the frequency band the UE can read, or whether the UE supports functions or the area of frequency band that the UE can read. In addition, after identification of the UE performance, an appropriate partial bandwidth (BWP) or appropriate functions may be configured for the UE. When receiving the RRC message inquiring about the UE capability, the UE may transmit to the base station the RRC message including UE capability information relating to functions supported by the UE in response thereto in operation 1e-40.

In the above, the UE may configure bearer setup information, cell group setup information, cell setup information, AI/ML configuration, each layer device information (for example, SDAP layer device (or new layer device), PDCP layer device, RLC layer device, MAC layer device, or PHY layer device) through the RRCSetup message or RRCResume message 1e-25 or RRCReconfiguration messages 1e-45 and 1e-70 of the RRC connection configuration. The RRC message may include configuration information for a PCell, Pscell, or multiple cells, and may configure multiple partial bandwidths for each cell (PCell, Pscell, or Scell). In the above, when receiving the RRCReconfiguration message in which the configuration information of the UE is received, the UE may apply the configuration information to the bearer or layer device of the UE, and may configure the RRCReconfigurationComplete messages 1e-50 and 1e-75 indicating that the reconfiguration is completed is configured and transmit the same to the base station.

In addition, when the base station or network instructs the UE to handover to another cell or frequency, the base station or network may configure a handover message (RRCReconfiguration message 1e-85) including configuration information of a target base station for handover and transmit the handover message to the UE, and the UE may perform a handover procedure (for example, or a synchronization procedure or a random access procedure to a target base station, etc.) according to the handover setting, and may configure an RRCReconfigurationComplete message 1e-90 and transmit the same to the target base station when the handover is successfully performed. The configuration information of the target base station may include bearer configuration information, cell group configuration information, cell configuration information, AI/ML configuration, each layer device information (e.g., SDAP layer device (or new layer device) or PDCP layer device, or RLC layer device, MAC layer device, or PHY layer device).

In the above, the RRC message (RRCSetup message, RRCResume message 1e-25, or RRCReconfiguration message 1e-70 or 1e-80) may include cell group configuration information, cell configuration information, and bearer configuration information of the UE, AI/ML configuration, or each layer device information (for example, SDAP layer device (or new layer device), PDCP layer device, RLC layer device, MAC layer device, or PHY layer device) may be configured.

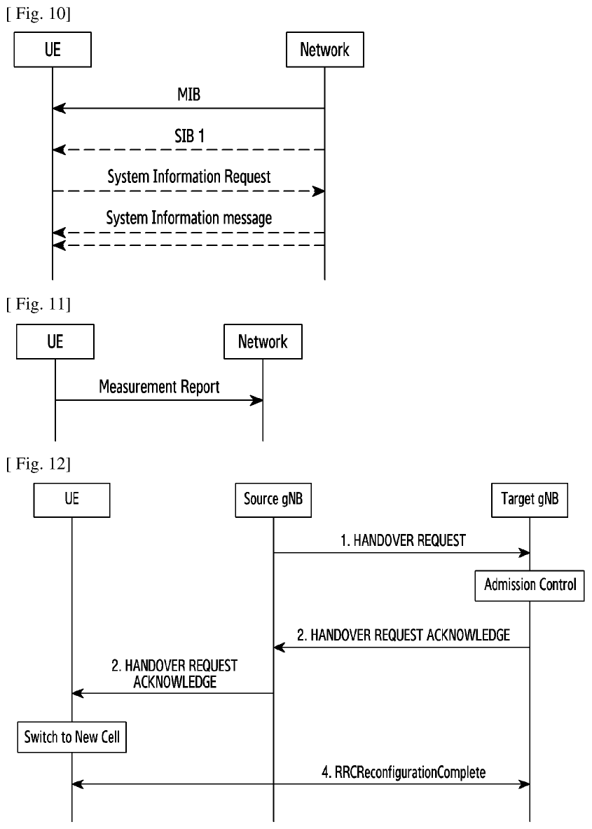

The UE applies the SI acquisition procedure to acquire the AS, NAS- and positioning assistance data information. The procedure applies to UEs in RRC_IDLE, in RRC_INACTIVE and in RRC_CONNECTED. FIG. 10 illustrates this.

The UE in RRC_IDLE and RRC_INACTIVE shall ensure having a valid version of (at least) the MIB, SIB1 through SIB4, SIB5 (if the UE supports E-UTRA), SIB11 (if the UE is configured for idle/inactive measurements), SIB12 (if UE is capable of NR sidelink communication/discovery and is configured by upper layers to receive or transmit NR sidelink communication/discovery), and SIB13, SIB14 (if UE is capable of V2X sidelink communication and is configured by upper layers to receive or transmit V2X sidelink communication), SIB15 (if UE is configured by upper layers to report disaster roaming related information), SIB16 (if the UE is capable of slice-based cell reselection and the UE receives NSAG information for cell reselection from upper layer), SIB19 (if UE is accessing NR via NTN access), SIBxx (e.g. SIB22) (if UE is capable of AI/ML functionality (e.g. AI/ML Model Training and Model Inference). SIBxx can broadcast whether the cell supports AI/ML Model Training or Model Inference or AI/ML functionalities or the information about AI/ML Model Training or Model Inference.

The UE capable of AI/ML functionality which is receiving or interested to receive AI/ML functionality via a SRB or DRB shall ensure having a valid version of SIBxx, regardless of the RRC state the UE is in.

There follows a more detailed description of a procedure for RRC connection control.

The UE shall perform the following actions upon reception of the RRCSetup:
1> if the RRCSetup is received in response to an RRCReestablishmentRequest; or
1> if the RRCSetup is received in response to an RRCResumeRequest or RRCResumeRequest1:
2> if sdt-MAC-PHY-CG-Config is configured:
3> instruct the MAC entity to stop the cg-SDT-TimeAlignmentTimer, if it is running;
3> instruct the MAC entity to start the timeAlignmentTimer associated with the PTAG, if it is not running;
2> if srs-PosRRC-InactiveConfig is configured:
3> instruct the MAC entity to stop the inactivePosSRS-TimeAlignmentTimer, if it is running;
2> discard any stored UE Inactive AS context and suspendConfig;
2> discard any current AS security context including the K_{RRCenc} key, the K_{RRCint} key, the K_{UPint} key and the K_{UPenc} key;
2> release radio resources for all established RBs except SRB0 and broadcast MRBs, including release of the RLC entities, of the associated PDCP entities and of SDAP;
2> release the RRC configuration except for the default L1 parameter values, default MAC Cell Group configuration, CCCH configuration and broadcast MRBs;
2> indicate to upper layers fallback of the RRC connection;
2> discard any application layer measurement reports which were not transmitted yet;
2> discard any AI/ML data (or measurement reports) which were not transmitted yet;
2> inform upper layers about the release of all application layer measurement configurations;
2> inform upper layers about the release of AI/ML configurations;
1> set the content of RRCSetupComplete message as follows:
2> if upper layers provide a 5G-S-TMSI:
3> if the RRCSetup is received in response to an RRCSetupRequest:
4> set the ng-5G-S-TMSI-Value to ng-5G-S-TMSI-Part2;
3> else:
4> set the ng-5G-S-TMSI-Value to ng-5G-S-TMSI;
2> if upper layers selected an SNPN or a PLMN and in case of PLMN UE is either allowed or instructed to access the PLMN via a cell for which at least one CAG ID is broadcast:
3> set the selectedPLMN-Identity from the npn-IdentityInfoList;
2> else:
3> set the selectedPLMN-Identity to the PLMN selected by upper layers from the plmn-IdentityInfoList;
2> if upper layers provide the ‘Registered AMF’:
3> include and set the registeredAMF as follows:
4> if the PLMN identity of the ‘Registered AMF’ is different from the PLMN selected by the upper layers:
5> include the plmnIdentity in the registeredAMF and set it to the value of the PLMN identity in the ‘Registered AMF’ received from upper layers;
4> set the amf-Identifier to the value received from upper layers;
3> include and set the guami-Type to the value provided by the upper layers;
2> if upper layers provide one or more S-NSSAI (see TS 23.003 [21]):
3> include the s-NSSAI-List and set the content to the values provided by the upper layers;
2> if upper layers provide onboarding request indication:
3> include the onboardingRequest;
2> set the dedicatedNAS-Message to include the information received from upper layers;
2> if connecting as an IAB-node:
3> include the iab-NodeIndication;
2> if the SIB1 contains idleModeMeasurementsNR and the UE has NR idle/inactive measurement information concerning cells other than the PCell available in VarMeasIdleReport; or
2> if the SIB1 contains idleModeMeasurementsEUTRA and the UE has E-UTRA idle/inactive measurement information available in VarMeasIdleReport:
3> include the idleMeasAvailable;
2> if the SIBx (e.g SIB1) contains the indication of AI/ML functionality support and the UE has AI/ML data available in VarAIMLTrainingDataReport (e.g. variable for buffered data or container in buffer):
3> include the AIMLDataAvailable (the indication of the availability of AI/ML data) or AI/ML data in RRC message (e.g. RRCSetupComplete message).

The UE shall perform the following actions upon reception of the RRCReconfiguration, or upon execution of the conditional reconfiguration (CHO, CPA or CPC). The UE can apply AI/ML configuration when the RRC message (RRCReconfiguration or RRCResume) includes the configuration information. If UE receives AI/ML configuration in otherConfig in RRCReconfguration, UE can include AI/ML data in subsequent RRC message to enable the network to utilize the information for network management. When UE receives a handover command message (i.e. RRCReconfiguration including reconfigurationWithSync) from the network (or gNB or the source gNB), the UE can send a handover complete message (i.e. RRCReconfigurationComplete) to the network (or gNB or the target gNB). The UE can include the indication of the availability of AI/ML data to report or AI/ML data in RRCReconfigurationComplete to inform it of the network. In addition to this, the UE can support retransmission of the RRC message including the AI/ML data, i.e. UE can retransmit it when its successful delivery has not been confirmed before (e.g. from the source gNB)
1> if the RRCReconfiguration (or RRCResume) message includes the AIMLConfig (i.e. AI/ML Configuration):
2> perform the AI/ML configuration procedure;
1> if the received otherConfig includes the AI/ML configuration:
2> if AI/ML configuration is set to setup, include available AI/ML data for any subsequent measurement report or any subsequent RLF report and SCGFailureInformation;
1> set the content of the RRCReconfigurationComplete message as follows:
2> if the RRCReconfiguration includes the reconfigurationWithSync in spCellConfig of an MCG:
3> if the UE has logged measurements available for NR and if the RPLMN is included in plmn-IdentityList stored in VarLogMeasReport:
4> include the logMeasAvailable in the RRCReconfigurationComplete message;
4> if Bluetooth measurement results are included in the logged measurements the UE has available for NR:
5> include the logMeasAvailableBT in the RRCReconfigurationComplete message;
4> if WLAN measurement results are included in the logged measurements the UE has available for NR:
5> include the logMeasAvailableWLAN in the RRCReconfigurationComplete message;
2> if the RRCReconfiguration includes the reconfigurationWithSync in spCellConfig of an MCG:
3> if the UE has AI/ML data available for NR or if the RPLMN is included in plmn-IdentityList stored in VarLogMeasReport:
4> include the AIMLDataAvailable (the indication of the availability of AI/ML data) or AI/ML data in the RRCReconfigurationComplete message;
1> if reconfigurationWithSync was included in spCellConfig of an MCG or SCG and when MAC of an NR cell group successfully completes a Random Access procedure triggered above; or,
2> stop timer T304 for that cell group if running;
2> stop timer T310 for source SpCell if running;
2> apply the parts of the CSI reporting configuration, the scheduling request configuration and the sounding RS configuration that do not require the UE to know the SFN of the respective target SpCell, if any;
2> apply the parts of the measurement and the radio resource configuration that require the UE to know the SFN of the respective target SpCell (e.g. measurement gaps, periodic CQI reporting, scheduling request configuration, sounding RS configuration), if any, upon acquiring the SFN of that target SpCell;
2> if reconfigurationWithSync was included in masterCellGroup:
3> if configured with application layer measurements and if application layer measurement report container has been received from upper layers for which the successful transmission of the message or at least one segment of the message has not been confirmed by lower layers:
4> re-submit the MeasurementReportAppLayer message or all segments of the MeasurementReportAppLayer message to lower layers for transmission via SRB4;
3> if configured with AI/ML functionality (e.g. AI/ML configuration) and if the RRC message including the report for AI/ML data has been generated (or transmitted) for which the successful transmission of the message or at least one segment of the message has not been confirmed by lower layers:
4> re-submit the RRC message including the report for AI/ML data or all segments of the RRC message to lower layers for transmission via configured RB (SRB1 or SRB2 or SRBx or DRB);
2> if reconfiguration ithSync was included in masterCellGroup and the target cell provides SIB21:
3> if the UE initiated transmission of an MBSInterestIndication message during the last 1 second preceding reception of this RRCReconfiguration message; or
3> if the RRCReconfiguration message is applied due to a conditional reconfiguration execution, and the UE has initiated transmission of an MBSInterestIndication message after having received this RRCReconfiguration message:
4> initiate transmission of an MBSInterestIndication message in accordance with clause 5.9.4;
2> the procedure ends.

Regarding AI/ML configuration, the UE shall:
1> if measConfigToReleaseList (e.g. the list for configuration release) is included in AIMLConfig (i.e. AI/ML configuration) within RRCReconfiguration or RRCResume:
2> for each measConfigId (e.g. target Identity for AI/ML data collection) value included in the measConfigToReleaseList:
3> discard any AI/ML data for the measConfigId;
3> consider itself not to be configured to send AI/ML data for the measConfigId.
1> if measConfigToAddModList (e.g. the list for configuration addition and modification) is included in AIMLConfig within RRCReconfiguration or RRCResume:
2> for each measConfigId value included in the measConfigToAddModList:
3> consider itself to be configured to send AI/ML data for the measConfigrId;
3> if pauseReporting (e.g, indication whether to stop (or deactivate) or start (or activate) AI/ML data reporting) is set to true:
4> if at least one segment, but not all segments, of a segmented RRC message containing an AI/ML data associated with the measConfigId has been submitted to lower layers for transmission:
5> submit the remaining segments of the RRC message to lower layers for transmission;
4> suspend submitting RRC message including AI/ML data to lower layers for the AI/ML configuration associated with the measConfigId;
4> store any previously or subsequently received AI/ML data containers associated with the measConfigId for which no segment, or full message, has been submitted to lower layers for transmission;
3> else if pauseReporting is set to false and if transmission of AI/ML data report has previously been suspended for the AI/ML configuration associated with the measConfigId:
4> submit the RRC message including the stored AI/ML data to lower layers, if any, for the AI/ML configuration associated with the measConfigId;
4> resume submitting RRC message including AI/ML data to lower layers for the AI/ML configuration associated with the measConfigId.

To support AI/ML functionality for a UE in RRC INACTIVE state, the procedure to store AI/ML configuration in UE Inactive AS Context is needed upon the reception of RRCRelease message. The UE can restore it when UE goes to RRC CONNECTED state upon the reception of RRCResume (or RRCReconfiguration) including indicating it.

The UE shall:
1> if the RRCRelease includes suspendConfig:
2> reset MAC and release the default MAC Cell Group configuration, if any;
2> apply the received suspendConfig except the received nextHopChainingCount;
2> re-establish RLC entities for SRB1;
2> if the RRCRelease message with suspendConfig was received in response to an RRCResumeRequest or an RRCResumeRequest1:
3> stop the timer T319 if running;
3> in the stored UE Inactive AS context:
4> replace the KgNB and KRRCint keys with the current KgNB and KRRCint keys;
4> replace the nextHopChainingCount with the value of nextHopChainingCount received in the RRCRelease message;
4> replace the cellIdentity with the cellIdentity of the cell the UE has received the RRCRelease message;
3> replace the nextHopChainingCount with the value associated with the current KgNB;
3> stop the timer T319a if running and consider SDT procedure is not ongoing;
2> else:
3> store in the UE Inactive AS Context the nextHopChainingCount received in the RRCRelease message, the current KgNB and KRRCint keys, the ROHC state, the EHC context(s), the UDC state, the stored QoS flow to DRB mapping rules, the application layer measurement configuration, AI/ML configuration, the C-RNTI used in the source PCell, the cellIdentity and the physical cell identity of the source PCell, the spCellConfigCommon within ReconfigurationWithSync of the NR PSCell (if configured) and all other parameters configured except for:
   parameters within ReconfigurationWithSync of the PCell;
   parameters within ReconfigurationWithSync of the NR PSCell, if configured;
   parameters within MobilityControlInfoSCG of the E-UTRA PSCell, if configured;
   servingCellConfigCommonSIB;
   sl-L2RelayUE-Config, if configured;
   sl-L2RemoteUE-Config, if configured;
3> store any previously or subsequently received application layer measurement reports for which no segment, or full message, has been submitted to lower layers for transmission;
2> suspend all SRB(s) and DRB(s) and multicast MRB(s), except SRB0 and broadcast MRBs;
2> indicate PDCP suspend to lower layers of all DRBs and multicast MRBs;
2> release the SRAP entity, if configured;
2> indicate the suspension of the RRC connection to upper layers;
2> enter RRC_INACTIVE and perform cell selection;
1> else
2> perform the actions upon going to RRC_IDLE, with the release cause ‘other’.

The UE can restore AI/ML configuration when UE goes to RRC CONNECTED state upon the reception of RRCResume including a indication of restoring it. If the indication is not included in RRCResume, UE can release the stored AI/ML configuration from UE Inactive AS context.

The UE shall:
1> if the RRCResume includes the fullConfig:
2> perform the full configuration procedure;
1> else:
2> if the RRCResume does not include the restoreMCG-SCells (indication to restore MCG (Master Cell Group) SCells (Secondary Cells)):
3> release the MCG SCell(s) from the UE Inactive AS context, if stored;
2> if the RRCResume does not include the restoreSCG (indication to restore SCG (Secondary Cell Group):
3> release the MR-DC related configurations from the UE Inactive AS context, if stored;
2> restore the masterCellGroup, mrdc-SecondaryCellGroup, if stored, and pdcp-Config or AI/ML configuration from the UE Inactive AS context;
2> configure lower layers to consider the restored MCG and SCG SCell(s) (if any) to be in deactivated state;
1> discard the UE Inactive AS context;
1> store the used nextHopChainingCount value associated to the current KgNB;
1> if the RRCResume includes the masterCellGroup:
2> perform the cell group configuration for the received masterCellGroup;
1> if the RRCResume includes the mrdc-SecondaryCellGroup:
2> if the received mrdc-SecondaryCellGroup is set to nr-SCG:
3> perform the RRC reconfiguration for the RRCReconfiguration message included in nr-SCG;
2> if the received mrdc-SecondaryCellGroup is set to eutra-SCG:
3> perform the RRC connection reconfiguration for the RRCConnectionReconfiguration message included in eutra-SCG;
1> if the RRCResume includes the radioBearerConfig:
2> perform the radio bearer configuration;
1> if the RRCResume message includes the sk-Counter:
2> perform security key update procedure;
1> if the RRCResume message includes the radioBearerConfig2:
2> perform the radio bearer configuration;
1> if the RRCResume message includes the appLayerMeasConfig:
2> perform the application layer measurement configuration procedure as specified in 5.3.5.13d;
1> resume SRB2 (if suspended), SRB3 (if configured), SRB4 (if configured), all DRBs (that are suspended) and multicast MRBs;

NOTE: If the SCG is deactivated, resuming SRB3 and all DRBs does not imply that PDCP or RRC PDUs can be transmitted or received on SCG RLC bearers.
1> if the RRCResume message includes the measConfig:
2> perform the measurement configuration procedure as specified in 5.5.2;
1> if the RRCResume message includes the AI/ML configuration:
2> perform the AI/ML configuration procedure as specified in Section AI/ML configuration;
1> else:
2> release the AI/ML configuration or discard AI/ML data;
1> resume measurements if suspended;
1> resume AI/ML training procedure if suspended;
1> enter RRC_CONNECTED;
1> indicate to upper layers that the suspended RRC connection has been resumed;
1> stop the cell re-selection procedure;
1> stop relay reselection procedure if any for L2 U2N Remote UE;
1> consider the current cell to be the PCell;
1> set the content of the of RRCResumeComplete message as follows:
2> if the UE has AI/ML data (or results or report) in VarAIMLReport:
3> if the AIMLReportReq (indication for the transmission of AI/ML data (or report)) is included in the RRCResume message:
4> set the AIMLData (the container for AI/ML data) in the RRCResumeComplete message to the value of AI/ML data in the VarAIMLReport (the variable for storing AI/ML data in buffer), if available;
4> discard the VarAIMLReport upon successful delivery of the RRCResumeComplete message is confirmed by lower layers;
3> else:
4> if the SIBx (e.g. SIB1) contains AIMLsupport (indication for the support of AI/ML functionality) and the UE has AI/ML data in VarAIMLReport; or
5> include the AIMLTrainingAvailable;
2> if the RRCResume message includes mrdc-SecondaryCellGroup set to eutra-SCG:
3> include in the eutra-SCG-Response the E-UTRA RRCConnectionReconfigurationComplete message;
2> if the RRCResume message includes mrdc-SecondaryCellGroup set to nr-SCG:
3> include in the nr-SCG-Response the SCG RRCReconfigurationComplete message;
1> submit the RRCResumeComplete message to lower layers for transmission;
1> the procedure ends.

If AI/ML functionality is not supported for a UE in RRC IDLE state, the procedure to discard AI/ML data or release AI/ML configuration is needed when UE goes to RRC IDLE state from RRC CONNECTED (or RRC INACTIVE) mode.

The UE shall:
1> reset MAC;
1> set the variable pendingRNA-Update to false, if that is set to true;
1> if the UE is leaving RRC_INACTIVE:
2> if going to RRC_IDLE was not triggered by reception of the RRCRelease message:
3> if stored, discard the cell reselection priority information provided by the cellReselectionPriorities;
3> stop the timer T320, if running;
1> stop all timers that are running except T302, T320, T325, T330, T331 and T400;
1> discard the UE Inactive AS context, if any;
1> release the suspendConfig, if configured;
1> remove all the entries within the MCG and the SCG VarConditionalReconfig, if any;
1> for each measId (e.g. target Identity for AI/ML data collection), if the associated reportConfig (e.g. configuration for AI/ML data report) has a reportType set to condTriggerConfig:
2> for the associated reportConfigId:
3> remove the entry with the matching reportConfigId from the reportConfigList within the VarMeasConfig;
2> if the associated measObjectId is only associated to a reportConfig with reportType set to condTriggerConfig:
3> remove the entry with the matching measObjectId from the measObjectList within the VarMeasConfig;
2> remove the entry with the matching measId from the measIdList within the VarMeasConfig;
1> discard the KgNB key, the S-KgNB key, the S-KeNB key, the KRRCenc key, the KRRCint key, the KUPint key and the KUPenc key, if any;
1> release all radio resources, including release of the RLC entity, the BAP entity, the MAC configuration and the associated PDCP entity and SDAP for all established RBs (except for broadcast MRBs), BH RLC channels, Uu Relay RLC channels, PC5 Relay RLC channels and SRAP entity;
1> indicate the release of the RRC connection to upper layers together with the release cause;
1> inform upper layers about the release of all application layer measurement configurations;
1> discard any application layer measurement reports which were not yet submitted to lower layers for transmission;
1> inform upper layers (e.g. application layer or NAS layer) about the release of AI/ML configuration or release AI/ML configuration;
1> discard any AI/ML data (e.g. report) which were not yet submitted to lower layers for transmission;
1> discard any segments of segmented RRC messages stored (e.g. the segment of AI/ML data);
1> except if going to RRC_IDLE was triggered by inter-RAT cell reselection while the UE is in RRC_INACTIVE or RRC_IDLE or when selecting an inter-RAT cell while T311 was running or when selecting an E-UTRA cell for EPS fallback for IMS voice:
2> enter RRC_IDLE and perform cell selection.

Regarding the reception of RRCReject by the UE, the UE shall:
1> stop timer T300, if running;
1> stop timer T319, if running;
1> stop timer T319a, if running and consider SDT procedure is not ongoing;
1> stop timer T302, if running;
1> reset MAC and release the default MAC Cell Group configuration;
1> if waitTime is configured in the RRCReject:
2> start timer T302, with the timer value set to the waitTime;
1> if RRCReject is received in response to a request from upper layers:
2> inform the upper layer that access barring is applicable for all access categories except categories ‘0’ and ‘2’;
1> if RRCReject is received in response to an RRCSetupRequest:
2> inform upper layers about the failure to setup the RRC connection, upon which the procedure ends;
1> else if RRCReject is received in response to an RRCResumeRequest or an RRCResumeRequest1:
2> if resume is triggered by upper layers:
3> inform upper layers about the failure to resume the RRC connection;
2> if resume is triggered due to an RNA update; or
2> if resume is triggered for SDT and T380 has expired:
3> set the variable pendingRNA-Update to true;
2> discard the current KgNB key, the KRRCenc key, the KRRCint key, the KUPint key and the KUPenc key derived in accordance with 5.3.13.3;
2> if any radio bearer is configured for SDT:
3> for SRB2, if it is resumed and for SRB1:
4> trigger the PDCP entity to perform SDU discard as specified in TS 38.323 [5];
3> for each radio bearer that is not suspended:
4> indicate PDCP suspend to lower layers;
4> re-establish the RLC entity as specified in TS 38.322 [4];
2> suspend SRB1 and the radio bearers configured for SDT, if any;
2> the procedure ends.

NOTE: If timer T331 is running, the UE continues to perform idle/inactive measurements according to 5.7.8.

NOTE: If timer Txxx (configured timer for AI/ML operation) is running, the UE continues to perform AI/ML operation (e.g. collection of AI/ML data or perform measurement) according to AI/ML configuration even if UE receives RRCReject message from the network.

The following relates to RRC Message structure.

A lot of the AI/ML data may need to be reported to the network. To avoid frequent reporting, UE can include many AI/ML data information in a proposed message structure of one RRC message (e.g. measurement reporting message or RRC message for reporting), i.e. UE can report a lot of AI/ML data with one message (e.g. RRC message or MAC CE). The proposed message can include a sequence number or a timing information for each AI/ML data to let the receiver sort them in chronological order. How many AI/ML data should be included in the reporting message can be configured by RRC message (e.g. in AI/ML configuration).

### CSI-MeasConfig or MeasConfig

The MeasConfig, ReportConfigNR, MeasResults, CSI-MeasConfig, CSIReportConfig, and MeasurementReport are the configuration information for measurement. The message structure and the parameters can be extended to new configuration information, e.g. MeasConfigAIML, ReportConfigNRAIML, MeasResultsAIML, CSI-MeasConfigAIML, CSI-ReportConfigAIML, MeasurementReportAIML and so forth to configure AI/ML configuration. For example, hereafter, MeasConfig, ReportConfigNR, MeasResults, CSI-MeasConfig, CSI-ReportConfig and MeasurementReport can be regarded as MeasConfigAIML, ReportConfigNRAIML, MeasResultsAIML, CSI-MeasConfigAIML, CSI-ReportConfigAIML and MeasurementReportAIML when the network configures AI/ML configuration to UE (or the network entity).

The measObject in MeasConfig includes the detailed information (e.g. time/frequency radio resource) for the target frequency. The measObjectID can be used to indicate each measObject. When the network configures AI/ML configuration to UE (or the network entity), the measObject in MeasConfigAIML can indicate the AI/ML model (e.g. can be used for AI/ML model identifier to configure AI/ML configuration for multiple AI/ML models) or the same information for measurement. The measObjectIDAIML can be used to indicate each measObjectAIML.

The measID in MeasConfig indicates the type of measurement or a identifier for separate measurement. When the network configures AI/ML configuration to UE (or the network entity), the measID in MeasConfigAIML can indicate the type of AI/ML data to be collected (e.g. can be used for AI/ML data identifier to configure AI/ML configuration for multiple type of AI/ML data) or the AI/ML model (e.g. can be used for AI/ML model identifier to configure AI/ML configuration for multiple AI/ML models) or the same information for measurement.

The ReportConfigNR includes the detailed information for reporting (e.g. which type of results should be reported or periodicity or time/frequency resources or when to trigger a reporting, i.e. events, etc). The ReportConfigID can be used to indicate each ReportConfigNR. When the network configures AI/ML configuration to UE (or the network entity), the ReportConfigNRAIML includes the detailed information for reporting (e.g. which type of results should be reported or periodicity or time/frequency resources or when to trigger a reporting, i.e. events, etc). The ReportConfigIDAIML can be used to indicate each ReportConfigNRAIML.

The MeasResults includes the detailed information to be reported (e.g. Physical Cell identity, cell list, frequency list, beam, beam list, RSRP, RSRQ, SINR, etc) for each measID. When the network configures AI/ML configuration to UE (or the network entity), the MeasResultsAIML includes the set of AI/ML data, the type of AI/ML data, the number of AI/ML data, time information, sequence number, and so on for each measIDAIML. The MeasResultsAIML can include the same information for measurement.

For AI/ML data, the sequence number of time information can be included to report multiple data for the same target (e.g. configured MeasObject as described above, AI/ML data or AI/ML model) in chronological sequence (i.e. time sequence) For example, Option 1 is to introduce a sequence number (or time information) for each measurement result and include it as shown below. Option 2 is to introduce a list with a sequence number (or time information), i.e. each measurement quantity of a measurement result can include the sequence number (or time information) as shown below. In another embodiment, a rule can be defined, which does not need a sequence number (or time information) for each result (or quantity), e.g. the first result in the report message is the first one in time sequence and the second result is the second one. The rule can be also defined in the opposite way, i.e. the first result in the report message is the most recent one in time sequence and the second result is the second most recent one. The rule can be defined in various way to report multiple data for the same target.

The MeasurementReport can includes the MeasResults for a measID. When AI/ML configuration is configured, the MeasurementReportAIML can includes the AI/ML data for a measIDAIML.

By mapping for measID, measObjectID, and ReportConfigID in MeasIdToAddMod, the measurement target, how to perform measurement for the target, how to report the results, which results should be reported and so on can be defined. By mapping for measIDAIML, measObjectIDAIML, and ReportConfigIDAIML in MeasIdToAddMod, the target data to be collected, how to perform measurement for the target (or collect it), how to report the results, which results should be reported and so on can be defined.

### MeasConfig

The IE MeasConfig specifies measurements to be performed by the UE, and covers intra-frequency, inter-frequency and inter-RAT mobility as well as configuration of measurement gaps.

### MeasConfig Information Element

-- ASN1START
-- TAG-MEASCONFIG-START

| | |
|---|---|
| MeasConfig ::= | SEQUENCE { |
| measObjectToRemoveList | MeasObjectToRemoveList |

OPTIONAL, -- Need N

| | |
|---|---|
| measObjectToAddModList | MeasObjectToAddModList |

OPTIONAL, -- Need N

| | |
|---|---|
| reportConfigToRemoveList | ReportConfigToRemoveList |

OPTIONAL, -- Need N

| | |
|---|---|
| reportConfigToAddModList | ReportConfigToAddModList |

OPTIONAL, -- Need N

| | |
|---|---|
| measIdToRemoveList | MeasIdToRemoveList |

OPTIONAL, -- Need N

| | |
|---|---|
| measIdToAddModList | MeasIdToAddModList |

OPTIONAL, -- Need N

| | |
|---|---|
| s-MeasureConfig | CHOICE { |
| ssb-RSRP | RSRP-Range, |
| csi-RSRP | RSRP-Range |

}
OPTIONAL, -- Need M

| | |
|---|---|
| quantityConfig | QuantityConfig |

OPTIONAL, -- Need M

| | |
|---|---|
| measGapConfig | MeasGapConfig |

OPTIONAL, -- Need M

| | |
|---|---|
| measGapSharingConfig | MeasGapSharingConfig |

```
OPTIONAL, -- Need M
  ...,
  [[
```

| | |
|---|---|
| interFrequencyConfig-NoGap-r16 | ENUMERATED {true} |

OPTIONAL -- Need R
]]
}

| | |
|---|---|
| MeasObjectToRemoveList ::= | SEQUENCE (SIZE (1..maxNrofObjectId)) OF MeasObjectId |
| MeasIdToRemoveList ::= | SEQUENCE (SIZE (1..maxNrofMeasId)) OF MeasId |
| ReportConfigToRemoveList ::= | SEQUENCE (SIZE (1..maxReportConfigId)) OF |

ReportConfigId
-- TAG-MEASCONFIG-STOP
-- ASN1STOP

MeasConfig field descriptions

interFrequencyConfig-NoGap-r16
If the field is set to true, UE is configured to perform SSB based inter-frequency measurement without
measurement gaps when the inter-frequency SSB is completely contained in the active DL BWP of
the UE. Otherwise, the SSB based inter-frequency measurement is performed within measurement
gaps. In NR-DC, the field can only be configured in the measConfig associated with MCG, and when
configured, it applies to all the inter-frequency measurements configured by MN and SN.
measGapConfig
Used to setup and release measurement gaps in NR.
measIdToAddModList
List of measurement identities to add and/or modify.
measIdToRemoveList
List of measurement identities to remove.
measObjectToAddModList
List of measurement objects to add and/or modify.
measObjectToRemoveList
List of measurement objects to remove.
reportConfigToAddModList
List of measurement reporting configurations to add and/or modify.
reportConfigToRemoveList
List of measurement reporting configurations to remove.
s-MeasureConfig
Threshold for NR SpCell RSRP measurement controlling when the UE is required to perform
measurements on non-serving cells. Choice of ssb-RSRP corresponds to cell RSRP based on
SS/PBCH block and choice of csi-RSRP corresponds to cell RSRP of CSI-RS.
measGapSharingConfig
Specifies the measurement gap sharing scheme and controls setup/release of measurement gap
sharing.

### MeasId

The IE MeasId is used to identify a measurement configuration, i.e., linking of a measurement object and a reporting configuration.

### MeasId Information Element

-- ASN1START
-- TAG-MEASIDTOADDMODLIST-START

| | |
|---|---|
| MeasIdToAddModList ::= | SEQUENCE (SIZE (1..maxNrofMeasId)) OF MeasIdToAddMod |
| MeasIdToAddMod ::= | SEQUENCE { |
| measId | MeasId, |
| measObjectId | MeasObjectId, |
| reportConfigId | ReportConfigId |

}
-- TAG-MEASIDTOADDMODLIST-STOP
-- ASN1STOP

### MeasObjectNR

The IE MeasObjectNR specifies information applicable for SS/PBCH block(s) intra/inter-frequency measurements and/or CSI-RS intra/inter-frequency measurements.

### MeasObjectNR Information Element

-- ASN1START
-- TAG-MEASOBJECTNR-START

| | |
|---|---|
| MeasObjectNR ::= | SEQUENCE { |
| ssbFrequency | ARFCN-ValueNR |

OPTIONAL, -- Cond SSBorAssociatedSSB

| | |
|---|---|
| ssbSubcarrierSpacing | SubcarrierSpacing |

OPTIONAL, -- Cond SSBorAssociatedSSB

| | |
|---|---|
| smtc1 | SSB-MTC |

OPTIONAL, -- Cond SSBorAssociatedSSB

| | |
|---|---|
| smtc2 | SSB-MTC2 |

OPTIONAL, -- Cond IntraFreqConnected

| | |
|---|---|
| refFreqCSI-RS | ARFCN-ValueNR |

OPTIONAL, -- Cond CSI-RS

| | |
|---|---|
| referenceSignalConfig | ReferenceSignalConfig, |
| absThreshSS-BlocksConsolidation | ThresholdNR |

OPTIONAL, -- Need R

| | |
|---|---|
| absThreshCSI-RS-Consolidation | ThresholdNR |

OPTIONAL, -- Need R

| | |
|---|---|
| nrofSS-BlocksToAverage | INTEGER (2..maxNrofSS-BlocksToAverage) |

OPTIONAL, -- Need R

| | |
|---|---|
| nrofCSI-RS-ResourcesToAverage | INTEGER (2..maxNrofCSI-RS-ResourcesToAverage) |

OPTIONAL, -- Need R

| | |
|---|---|
| quantityConfigIndex | INTEGER (1..maxNrofQuantityConfig), |
| offsetMO | Q-OffsetRangeList, |
| cellsToRemoveList | PCI-List |

OPTIONAL, -- Need N

| | |
|---|---|
| cellsToAddModList | CellsToAddModList |

OPTIONAL, -- Need N

| | |
|---|---|
| excludedCellsToRemoveList | PCI-RangeIndexList |

OPTIONAL, -- Need N

| | |
|---|---|
| excludedCellsToAddModList | SEQUENCE (SIZE (1..maxNrofPCI-Ranges)) OF PCI- |

RangeElement OPTIONAL, -- Need N

| | |
|---|---|
| allowedCellsToRemoveList | PCI-RangeIndexList |

OPTIONAL, -- Need N

| | |
|---|---|
| allowedCellsToAddModList | SEQUENCE (SIZE (1..maxNrofPCI-Ranges)) OF PCI- |

```
RangeElement OPTIONAL, -- Need N
  ...,
  [[
```

| | |
|---|---|
| freqBandIndicatorNR | FreqBandIndicatorNR |

OPTIONAL, -- Need R

| | |
|---|---|
| measCycleSCell | ENUMERATED {sf160, sf256, sf320, sf512, sf640, sf1024, |

```
sf1280} OPTIONAL -- Need R
  ]],
  [[
```

| | |
|---|---|
| smtc3list-r16 | SSB-MTC3List-r16 |

OPTIONAL, -- Need R

| | |
|---|---|
| rmtc-Config-r16 | SetupRelease {RMIC-Config-r16} |

OPTIONAL, -- Need M

| | |
|---|---|
| t312-r16 | SetupRelease { T312-r16 } |

```
OPTIONAL -- Need M
  ]],
  [[
```

| | |
|---|---|
| associatedMeasGapSSB-r17 | MeasGapId-r17 |

OPTIONAL, -- Need R

| | |
|---|---|
| associatedMeasGapCSIRS-r17 | MeasGapId-r17 |

OPTIONAL, -- Need R

| | |
|---|---|
| smtc4list-r17 | SSB-MTC4List-r17 |

OPTIONAL, -- Need R

| | |
|---|---|
| measCyclePSCell-r17 | ENUMERATED {ms160, ms256, ms320, ms512, ms640, ms1024, |

ms1280, spare1}
OPTIONAL, -- Cond SCG

| | |
|---|---|
| cellsToAddModListExt-v1710 | CellsToAddModListExt-v1710 |

```
OPTIONAL -- Need N
  ]],
  [[
```

| | |
|---|---|
| associatedMeasGapSSB2-v1720 | MeasGapId-r17 |

OPTIONAL, -- Cond AssociatedGapSSB

| | |
|---|---|
| associatedMeasGapCSIRS2-v1720 | MeasGapId-r17 |

OPTIONAL -- Cond AssociatedGapCSIRS
]]
}

| | |
|---|---|
| SSB-MTC3List-r16::= | SEQUENCE (SIZE(1..4)) OF SSB-MTC3-r16 |
| SSB-MTC4List-r17::= | SEQUENCE (SIZE(1..3)) OF SSB-MTC4-r17 |
| T312-r16 ::= | ENUMERATED { ms0, ms50, ms100, ms200, ms300, ms400, ms500, |

ms1000}

| | |
|---|---|
| ReferenceSignalConfig::= | SEQUENCE { |
| ssb-ConfigMobility | SSB-ConfigMobility |

OPTIONAL, -- Need M

| | |
|---|---|
| csi-rs-ResourceConfigMobility | SetupRelease { CSI-RS-ResourceConfigMobility } |

OPTIONAL -- Need M
}

| | |
|---|---|
| SSB-ConfigMobility::= | SEQUENCE { |
| ssb-ToMeasure | SetupRelease { SSB-ToMeasure } |

OPTIONAL, -- Need M

| | |
|---|---|
| deriveSSB-IndexFromCell | BOOLEAN, |
| ss-RSSI-Measurement | SS-RSSI-Measurement |

```
OPTIONAL, -- Need M
  ...,
  [[
```

| | |
|---|---|
| ssb-PositionQCL-Common-r16 | SSB-PositionQCL-Relation-r16 |

OPTIONAL, -- Cond SharedSpectrum

| | |
|---|---|
| ssb-PositionQCL-CellsToAddModList-r16 | SSB-PositionQCL-CellsToAddModList-r16 |

OPTIONAL, -- Need N

| | |
|---|---|
| ssb-PositionQCL-CellsToRemoveList-r16 | PCI-List |

```
OPTIONAL -- Need N
  ]],
  [[
```

| | |
|---|---|
| deriveSSB-IndexFromCellInter-r17 | ServCellIndex |

OPTIONAL, -- Need R

| | |
|---|---|
| ssb-PositionQCL-Common-r17 | SSB-PositionQCL-Relation-r17 |

OPTIONAL, -- Cond SharedSpectrum2

| | |
|---|---|
| ssb-PositionQCL-Cells-r17 | SetupRelease {SSB-PositionQCL-CellList-r17} |

OPTIONAL -- Need M
]]
}

| | |
|---|---|
| Q-OffsetRangeList ::= | SEQUENCE { |
| rsrpOffsetSSB | Q-OffsetRange DEFAULT dB0, |
| rsrqOffsetSSB | Q-OffsetRange DEFAULT dB0, |
| sinrOffsetSSB | Q-OffsetRange DEFAULT dB0, |
| rsrpOffsetCSI-RS | Q-OffsetRange DEFAULT dB0, |
| rsrqOffsetCSI-RS | Q-OffsetRange DEFAULT dB0, |
| sinrOffsetCSI-RS | Q-OffsetRange DEFAULT dB0 |

}

| | |
|---|---|
| ThresholdNR ::= | SEQUENCE{ |
| thresholdRSRP | RSRP-Range |

OPTIONAL, -- Need R

| | |
|---|---|
| thresholdRSRQ | RSRQ-Range |

OPTIONAL, -- Need R

| | |
|---|---|
| thresholdSINR | SINR-Range |

OPTIONAL -- Need R
}

| | |
|---|---|
| CellsToAddModList ::= | SEQUENCE (SIZE (1..maxNrofCellMeas)) OF CellsToAddMod |
| CellsToAddModListExt-v1710 ::= | SEQUENCE (SIZE (1..maxNrofCellMeas)) OF CellsToAddModExt- |

v1710

| | |
|---|---|
| CellsToAddMod ::= | SEQUENCE { |
| physCellId | PhysCellId, |
| cellIndividualOffset | Q-OffsetRangeList |

}

| | |
|---|---|
| CellsToAddModExt-v1710 ::= | SEQUENCE { |
| ntn-PolarizationDL-r17 | ENUMERATED {rhcp,lhcp,linear} |

OPTIONAL, -- Need R

| | |
|---|---|
| ntn-PolarizationUL-r17 | ENUMERATED {rhcp,lhcp,linear} |

OPTIONAL -- Need R
}

| | |
|---|---|
| RMTC-Config-r16 ::- | SEQUENCE { |
| rmtc-Periodicity-r16 | ENUMERATED {ms40, ms80, ms160, ms320, ms640}, |
| rmtc-SubframeOfset-r16 | INTEGER(0..639) |

OPTIONAL, -- Need M

| | |
|---|---|
| measDurationSymbols-r16 | ENUMERATED {sym1, sym14or12, sym28or24, sym42or36, |

sym70cr60},

| | |
|---|---|
| rmtc-Frequency-r16 | ARFCN-ValueNR, |
| ref-SCS-CP-r16 | ENUMERATED {kHz15, kHz30, kHz60-NCP, kHz60-ECP}, |

```
  ...,
  [[
```

| | |
|---|---|
| rmtc-Bandwidth-r17 | ENUMERATED {mhz100, mhz400, mhz800, mhz1600, mhz2000} |

OPTIONAL, -- Need R

| | |
|---|---|
| measDurationSymbols-v1700 | ENUMERATED {sym140, sym560, sym1120} |

OPTIONAL, -- Need R

| | |
|---|---|
| ref-SCS-CP-v1700 | ENUMERATED {kHz120, kHz480, kHz960} |

OPTIONAL, -- Need R

| | |
|---|---|
| tci-StateInfo-r17 | SEQUENCE { |
| tci-StateId-r17 | TCI-StateId, |
| ref-ServCellId-r17 | ServCellIndex |

```
OPTIONAL -- Need R
  } OPTIONAL -- Need R
  ]],
  [[
```

| | |
|---|---|
| ref-BWPId-r17 | BWP-Id |

OPTIONAL -- Need R
]]
}

| | |
|---|---|
| SSB-PositionQCL-CellsToAddModList-r16 ::= | SEQUENCE (SIZE (1..maxNrofCellMeas)) OF SSB- |

PositionQCL-CellsToAddMod-r16

| | |
|---|---|
| SSB-PositionQCL-CellsToAddMod-r16 ::= | SEQUENCE { |
| physCellId-r16 | PhysCellId, |
| ssb-PositionQCL-r16 | SSB-PositionQCI-Relation-r16 |

}

| | |
|---|---|
| SSB-PositionQCL-CellList-r17 ::= | SEQUENCE (SIZE (1..maxNrofCellMeas)) OF SSB-PositionQCL-Cell- |

r17

| | |
|---|---|
| SSB-PositionQCL-Cell-r17 | ::= SEQUENCE { |
| physCellId-r17 | PhysCellId, |
| ssb-PositionQCL-r17 | SSB-PositionQCL-Relation-r17 |

}
-- TAG-MEASOBJECTNR-STOP
-- ASN1STOP

CellsToAddMod field descriptions

cellIndividualOffset
Cell individual offsets applicable to a specific cell.
physCellId
Physical cell identity of a cell in the cell list.

### MeasObjectToAddModList

The IE MeasObjectToAddModList concerns a list of measurement objects to add or modify.

### MeasObjectToAddModList Information Element

-- ASN1START
-- TAG-MEASOBJECTTOADDMODLIST-START

| | |
|---|---|
| MeasObjectToAddModList ::= | SEQUENCE (SIZE (1..maxNrofObjectId)) OF |

MeasObjectToAddMod

| | |
|---|---|
| MeasObjectToAddMod ::= | SEQUENCE { |
| measObjectId | MeasObjectId, |
| measObject | CHOICE { |
| measObjectNR | MeasObjectNR, |

...,

| | |
|---|---|
| measObjectEUTRA | MeasObjectEUTRA, |
| measObjectUTRA-FDD-r16 | MeasObjectUTRA-FDD-r16, |
| measObjectNR-SL-r16 | MeasObjectNR-SL-r16, |
| measObjectCLI-r16 | MeasObjectCLI-r16, |
| measObjectRxTxDiff-r17 | MeasObjectRxTxDiff-r17, |
| measObjectRelay-r17 | SL-MeasObject-r16 |

}
}
-- TAG-MEASOBJECTTOADDMODLIST-STOP
-- ASN1STOP

### MeasurementReport

The MeasurementReport message is used for the indication of measurement results.
Signalling radio bearer: SRB1, SRB3
Data radio bearer: DRB (if configured)
RLC-SAP: AM
Logical channel: DCCH
Direction: UE to Network

### MeasurementReport Message

| -- ASN1START | |
|---|---|
| -- TAG-MEASUREMENTREPORT-START | |
| MeasurementReport ::= | SEQUENCE { |
| criticalExtensions | CHOICE { |
| measurementReport | MeasurementReport-IEs, |
| criticalExtensionsFuture | SEQUENCE { } |
| } | |
| } | |
| MeasurementReport-IEs ::= | SEQUENCE { |
| measResults | MeasResults, |
| lateNonCriticalExtension | OCTET STRING |
| OPTIONAL, | |
| nonCriticalExtension | SEQUENCE{ } |

OPTIONAL
}
-- TAG-MEASUREMENTREPORT-STOP
-- ASN1STOP

### MeasResults

The IE MeasResults covers measured results for intra-frequency, inter-frequency, inter-RAT mobility and measured results for NR sidelink communication/discovery.

### MeasResults Information Element

-- ASN1START
-- TAG-MEASRESULTS-START

| MeasResults ::= | SEQUENCE { | | | | |
|---|---|---|---|---|---|
| measID | | MeasID, | | | |
| massResultsServingMoList | | MeasResultsServMoList, | | | |
| measResultsNeighCells | | CHOICE { | | | |
| measResultListNR | | | MeasResultListNR, | | |
| ..., | | | | | |
| measResultListEUTRA | | | MeasResultListEUTRA, | | |
| measResultListUTRA-FDD-R16 | | | MeasResultListUTRA-FDD-r16, | | |
| sl-MeasResultsCandRelay-r17 | | | OCTET STRING -- ContainsPC5 SL- | | |
| MeasResultListRelay-r17 | | | | | |
| measResultListAIML | | | measResultListAIML | | |
| } | | | | | |
| OPTIONAL, | | | | | |
| ..., | | | | | |
| [[ | | | | | |
| measResultServFreqListEUTRA-SCG | | MeasResultServFreqListEUTRA-SCG | | | |
| OPTIONAL, | | | | | |
| measResultServFreqListNR-SCG | | MeasResultServFreqListNR-SCG | | | |
| OPTIONAL, | | | | | |
| measResultSFTD-EUTRA | | MeasResultSFTD-EUTRA | | | |
| OPTIONAL, | | | | | |
| measResultSFTD-NR | | MeasResultCellSFTD-NR | | | |
| OPTIONAL | | | | | |
| ]], | | | | | |
| [[ | | | | | |
| measResultCellListSFTD-NR | | MeasResultCellListSFTD-NR | | | |
| OPTIONAL | | | | | |
| ]], | | | | | |
| [[ | | | | | |
| measResultForRSSI-r16 | | MeasResultForRSSI-r16 | | | |
| OPTIONAL, | | | | | |
| locationInfo-r16 | | LocationInfo-r16 | | | |
| OPTIONAL, | | | | | |
| ul-PDCP-DelayValueResultList-r16 | | UL-PDCP-DelayValueResultList-r16 | | | |
| OPTIONAL, | | | | | |
| measResultsSL-r16 | | MeasResultsSL-r16 | | | |
| OPTIONAL, | | | | | |
| measResultCLI-r16 | | MeasResultCLI-r16 | | | |
| OPTIONAL | | | | | |
| ]], | | | | | |
| [[ | | | | | |
| measResultRxTxTimeDiff-r17 | | MeasResultRxTxTimeDiff-r17 | | | |
| OPTIONAL, | | | | | |
| sl-MeasResultServingRelay-r17 | | OCTET STRING | | | |
| OPTIONAL, | | | | | |
| | | | | | -- |
| Contains PC5 SL-MeasResultRelay-r17 | | | | | |
| ul-PDCP-ExcessDelayResultList-r17 | | UL-PDCP-ExcessDelayResultList-r17 | | | |
| OPTIONAL, | | | | | |
| coarseLocationInfo-r17 | | OCTET STRING | | | |
| OPTIONAL | | | | | |
| ]] | | | | | |
| } | | | | | |
| MeasResultsServMOList ::= | SEQUENCE (SIZE (1..maxNrofServingCells)) OF | | | | |
| MeasResultsServMO | | | | | |
| MeasResultServMO ::= | SEQUENCE { | | | | |
| servCellId | | ServCellIndex, | | | |
| measResultsServingCell | | MeasResultNR, | | | |
| measResultBestNeighCell | | MeasResultNR | | | |
| OPTIONAL, | | | | | |
| ... | | | | | |
| } | | | | | |
| MeasResultListNR ::= | SEQUENCE (SIZE (1..maxCellReport)) OF MeasResultNR | | | | |
| MeasResultNR ::= | SEQUENCE { | | | | |
| physCellId | | PhysCellId | | | |
| OPTIONAL, | | | | | |
| measResult | | SEQUENCE { | | | |
| cellResults | | | SEQUENCE { | | |
| resultsSSB-Cell | | | | MeasQuantityResults | |
| OPTIONAL, | | | | | |
| resultsCSI-RS-Cell | | | | MeasQuantityResults | |
| OPTIONAL | | | | | |
| }, | | | | | |
| rsIndexResults | | | SEQUENCE{ | | |
| resultsSSB-Indexes | | | | ResultsPerSSB-IndexList | |
| OPTIONAL, | | | | | |
| resultsCS-RS-Indexes | | | | ResultsPerCSI-RS-IndexList | |
| OPTIONAL | | | | | |
| } | | | | | |
| OPTIONAL | | | | | |
| }, | | | | | |

----------------------------------------------------------------------------------------------

| ------ | | | | |
|---|---|---|---|---|
| Option 1: Introduce TimeInfo or Sequence Number | | | | |
| MeasResultListAIML ::= | SEQUENCE (SIZE (1..maxCellReport)) OF MeasResultAIML | | | |
| MeasResultAIML::= | SEQUENCE { | | | |
| physCellId | | PhysCellId | | |
| Sequence number (or Time information) | | | | |
| OPTIONAL, | | | | |
| measResult | | SEQUENCE { | | |
| cellResults | | | SEQUENCE{ | |
| resultsSSB-Cell | | | | MeasQuantityResults |
| OPTIONAL, | | | | |
| resultsCSI-RS-Cell | | | | MeasQuantityResults |
| OPTIONAL | | | | |
| }, | | | | |
| rsIndexResults | | | SEQUENCE{ | |
| resultsSSB-Indexes | | | | ResultsPerSSB-IndexList |
| OPTIONAL, | | | | |
| resultsCSI-RS-Indexes | | | | ResultsPerCSI-RS-IndexList |
| OPTIONAL | | | | |
| } | | | | |
| OPTIONAL | | | | |
| }, | | | | |

----------------------------------------------------------------------------------------------

------

Option 2: Introduce a list with sequence number or without it(based on rule, e.g. FIFO (First

| In First Out) or FILO(First In Last Out) ) | | | | | | | |
|---|---|---|---|---|---|---|---|
| MeasResultListAIML ::= | | | | SEQUENCE (SIZE (1..maxCellReport)) OF MeasResultAIML | | | |
| MeasResultAIML::= | | | | SEQUENCE { | | | |
| physCellId | | | | | PhysCellId | | |
| | | | OPTIONAL, | | | | |
| measResult | | | | | SEQUENCE { | | |
| cellResults | | | | | | SEQUENCE{ | |
| resultsSSB-Cell | | | | | | | MeasQuantityResultsAIML |
| | | | | OPTIONAL, | | | |
| resultsCSI-RS-Cell | | | | | | | MeasQuantityResultsAIML |
| OPTIONAL | | | | | | | |
| }, | | | | | | | |
| rsIndexResults | | | | | | SEQUENCE{ | |
| resultsSS-Indexes | | | | | | | ResultsPerSSB-IndexList |
| OPTIONAL, | | | | | | | |
| resultsCSI-RS-Indexes | | | | | | | ResultsPerCSI-RS-IndexList |
| OPTIONAL | | | | | | | |
| } | | | | | | | |
| OPTIONAL | | | | | | | |
| }, | | | | | | | |
| MeasQuantityResultsAIML ::= | | | | | SEQUENCE { | | |
| rsrp-list | | | | | | ResultsRSRP-list | |
| OPTIONAL, | | | | | | | |
| rsrq-list | | | | | | ResultsRSRQ-list | |
| OPTIONAL, | | | | | | | |
| Sinr-list | | | | | | ResultsSINR-list | |
| OPTIONAL | | | | | | | |
| } | | | | | | | |
| ResultsRSRP-List::= | | SEQUECE (SIZE (1..maxNrofIndexesToReport3)) OF ResultsRSRP | | | | | |
| ResultsRSRP::= | SEQUENCE { | | | | | | |
| Sequnce number (or Time Info.) | | | | | Sequence number, | | |
| rsrp | | | | | | RSRP-Range | |
| OPTIONAL | | | | | | | |
| } | | | | | | | |
| ResultsRSRQ-List::= | | SEQUENCE (SIZE (1..maxNrofIndexesToReport4)) OF ResultsRSRQ | | | | | |
| ResultsRSRQ::= | SEQUENCE { | | | | | | |
| Sequnce number (or TimeInfo.) | | | | | Sequence number, | | |
| rsrq | | | | | | RSRQ-Range | |
| OPTIONAL | | | | | | | |
| } | | | | | | | |
| ResultsSINR-List::= | | SEQUENCE (SIZE (1..maxNrofIndexesToReport5)) OF ResultsSINR | | | | | |
| ResultsSINR::= | SEQUENCE { | | | | | | |
| Sequnce number (or Time Info.) | | | | | Sequence number, | | |
| sinr | | | | | | SINR-Range | |
| OPTIONAL | | | | | | | |
| } | | | | | | | |
| MeasQuantityResults ::= | | | | SEQUENCE { | | | |
| rsrp | | | | | RSRP-Range | | |
| OPTIONAL, | | | | | | | |
| rsrq | | | | | RSRQ-Range | | |
| OPTIONAL, | | | | | | | |
| sinr | | | | | SINR-Range | | |
| OPTIONAL | | | | | | | |
| } | | | | | | | |
| ResultsPerSSB-IndexList::= | | | | SEQUENCE (SIZE (1..maxNrofIndexesToReport2)) OF | | | |
| ResultsPerSSB-Index | | | | | | | |
| ResultsPerSSB-Index ::= | | | | SEQUENCE { | | | |
| ssb-Index | | | | | SSB-Index, | | |
| ssb-Results | | | | | MeasQuantityResults | | |
| OPTIONAL | | | | | | | |
| ] | | | | | | | |

----------------------------------------------------------------------------------------------

| ------ | | | |
|---|---|---|---|
| ..., | | | |
| [[ | | | |
| cgi-Info | | CGI-InfoNR | |
| OPTIONAL | | | |
| ]] , | | | |
| [[ | | | |
| choCandidate-r17 | | ENUMERATED {true} | |
| OPTIONAL, | | | |
| choConfig-r17 | | SEQUENCE (SIZE (1..2)) OF CondTriggerConfig-r16 | |
| OPTIONAL, | | | |
| triggeredEvent-r17 | | SEQUENCE { | |
| timeBetweenEvents-r17 | | | TimeBetweenEvent-r17 |
| OPTIONAL, | | | |
| firstTriggeredEvent | | | ENUMERATED {condFirstEvent, condSecondEvent} |
| OPTIONAL | | | |
| } | | | |
| OPTIONAL | | | |
| ]] | | | |
| } | | | |
| MeasResultListEUTRA ::= | SEQUENCE (SIZE (1..maxCellReport)) OF MeasResultEUTRA | | |
| MeasResultEUTRA ::= | SEQUENCE { | | |
| eutra-PhysCellId | | PhysCellId, | |
| measResult | | MeasQuantityResultsEUTRA, | |
| cgi-Info | | CGI-InfoEUTRA | |
| OPTIONAL, | | | |
| ... | | | |
| } | | | |
| MultiBandInfoListEUTRA ::= | SEQUENCE (SIZE (1..maxMultiBands)) OF | | |
| FreqBandIndicatorEUTRA | | | |
| MeasQuantityResults ::= | SEQUENCE { | | |
| rsrp | | RSRP-Range | |
| OPTIONAL, | | | |
| rsrq | | RSRQ-Range | |
| OPTIONAL, | | | |
| sinr | | SINR-Range | |
| OPTIONAL | | | |
| } | | | |
| MeasQuantityResultsEUTRA ::= | SEQUENCE { | | |
| rsrp | | RSRP-RangeEUTRA | |
| OPTIONAL, | | | |
| rsrq | | RSRQ-RangeEUTRA | |
| OPTIONAL, | | | |
| sinr | | SINR-RangeEUTRA | |
| OPTIONAL | | | |
| } | | | |
| ResultsPerSSB-IndexList::= | SEQUENCE (SIZE (1..maxNrofIndexesToReport2)) OF | | |
| ResultsPerSSB-Index | | | |
| ResultsPerSSB-Index ::= | SEQUENCE { | | |
| ssb-Index | | SSB-Index, | |
| ssb-Results | | MeasQuantityResults | |
| OPTIONAL | | | |
| } | | | |
| ResultsPerCSI-RS-IndexList::= | SEQUENCE (SIZE (1..maxNrofIndexesToReport2)) OF | | |
| ResultsPerCSI-RS-Index | | | |
| ResultsPerCSI-RS-Index ::= | SEQUENCE { | | |
| csi-RS-Index | | CSI-RS-Index, | |
| csi-RS-Results | | MeasQuantityResults | |
| OPTIONAL | | | |
| } | | | |

MeasResultsServFreqListEUTRA-SCG ::= SEQUENCE (SIZE (1..maxNrofServingCellsEUTRA)) OF

MeasResult2EUTRA

MeasResultServFreqListNR-SCG ::= SEQUENCE (SIZE (1..maxNrofServingCells)) OF MeasResult2NR

| MeasResultListUTRA-FDD-r16 ::= | | | SEQUENCE (SIZE (1..maxCellReport)) OF MeasResultUTRA- | | | |
|---|---|---|---|---|---|---|
| FDD-r16 | | | | | | |
| MeasResultUTRA-FDD-r16 ::= | | | SEQUENCE { | | | |
| physCellId-r16 | | | | PhysCellIdUTRA-FDD-r16, | | |
| measResult-r16 | | | | SEQUENCE { | | |
| utra-FDD-RSCP-r16 | | | | | INTEGER (−5..91) | OPTIONAL, |
| utra-FDD-EcNO-r16 | | | | | INTEGER (0..49) | OPTIONAL |
| } | | | | | | |
| } | | | | | | |
| MeasResultForRSSI-r16 ::= | SEQUENCE { | | | | | |
| rssi-Result-r16 | | RSSI-Range-r16, | | | | |
| channelOccupancy-r16 | | INTEGER (0..100) | | | | |
| } | | | | | | |
| MeasResultCLI-r16 ::= | SEQUENCE { | | | | | |
| measResultListSRS-RSRP-r16 | | MeasResultListSRS-RSRP-r16 | | | | |
| OPTIONAL, | | | | | | |
| measResultListCLI-RSSI-r16 | | MeasResultIistCLI-RSSI-r16 | | | | |
| OPTIONAL | | | | | | |
| } | | | | | | |
| MeasResultListSRS-RSRP-r16 ::= | SEQUENCE (SIZE (1..maxCLI-Report-r16)) OF MeasResultSRS- | | | | | |
| RSRP-r16 | | | | | | |
| MeasResultSRS-RSRP-r16 ::= | SEQUENCE { | | | | | |
| srs-ResourceId-r16 | | SRS-ResourceId, | | | | |
| srs-RSRP-Result-r16 | | SRS-RSRP-Range-r16 | | | | |
| } | | | | | | |
| MeasResultListCLI-RSSI-r16 ::= | SEQUENCE (SIZE (1..maxCLI-Report-r16)) OF MeasResultCLI- | | | | | |
| RSSI-r16 | | | | | | |
| MeasResultCLI-RSSI-r16 ::= | SEQUENCE { | | | | | |
| rssi-ResourceId-r16 | | RSSI-ResourceId-r16, | | | | |
| cli-RSSI-Result-r16 | | CLI-RSSI-Range-r16 | | | | |
| } | | | | | | |

UL-PDCP-DelayValueResultList-r16 ::= SEQUENCE (SIZE (1 .. maxDRB) ) OF UL-PDCP-DelayValueResult-

| r16 | |
|---|---|
| UL-PDCP-DelayValueResult-r16 ::= SEQUENCE { | |
| drb-Id-r16 | DRB-Identity, |
| averageDelay-r16 | INTEGER (0..10000), |
| ... | |
| } | |

UL-PDCP-ExcessDelayResultList-r17 ::= SEQUENCE (SIZE (1..maxDRB)) OF UL-PDCP-

| ExcessDelayResult-r17 | |
|---|---|
| UL-PDCP-ExcessDelayResult-r17 ::= SEQUENCE { | |
| drb-Id-r17 | DRB-Identity, |
| excessDelay-r17 | INTEGER (0..31), |
| ... | |
| } | |
| TimeBetweenEvent-r17 ::= INTEGER (0..1023) | |
| -- TAG-MEASRESULTS-STOP | |
| -- ASN1STOP | |

MeasResultEUTRA field descriptions

eutra-PhysCellId
Identifies the physical cell identity of the E-UTRA cell for which the reporting is being performed. The
UE reports a value in the range 0 . . . 503, other values are reserved.
averageDelay
Indicates average delay for the packets during the reporting period. Value 0 corresponds to 0
millisecond, value 1 corresponds to 0.1 millisecond, value 2 corresponds to 0.2 millisecond, and so
on.
cellResults
Cell level measurement results.
choCandidate
This field indicates whether the associated cell is a candidate target cell for conditional handover.
This field may be included only in the SuccessHO-Report within UEInformationResponse message.
choConfig
If the associated cell is a candidate target cell for conditional handover, this field indicates the
conditional handover execution condition for each measId within condTriggerConfig associated to
the cell. This field may be included only in the rlf-report within UEInformationResponse message.
drb-Id
Indicates DRB value for which uplink PDCP delay ratio or value is provided.
firstTriggeredEvent
This field is set to condFirstEvent if the execution condition associated to the first entry of choConfig
was fulfilled first in time. This field is set to condSecondEvent if the execution condition associated
to the second entry of choConfig was fulfilled first in time. This field may be included only in rlf-report
within UEInformationResponse message.
locationInfo
Positioning related information and measurements.
physCellId
The physical cell identity of the NR cell for which the reporting is being performed.
resultsSSB-Cell
Cell level measurement results based on SS/PBCH related measurements.
resultsSSB-Indexes
Beam level measurement results based on SS/PBCH related measurements.
resultsCSI-RS-Cell
Cell level measurement results based on CSI-RS related measurements.
resultsCSI-RS-Indexes
Beam level measurement results based on CSI-RS related measurements.
rsIndexResults
Beam level measurement results.

timeBetweenEvents
Indicates the time elapsed between fulfilling the conditional execution conditions included in
choConFIGURE Value in milliseconds. The maximum value 1023 means 1023 ms or longer. This
field may be included only in the reports associated to UEInformationResponse message, e.g., rlf-
Report.

MeasResultUTRA-FDD field descriptions

physCellId
The physical cell identity of the UTRA-FDD cell for which the reporting is being performed.
utra-FDD-EcN0
According to CPICH_Ec/No for FDD.
utra-FDD-RSCP
According to CPICH_RSCP for FDD.

MeasResults field descriptions

coarseLocationInfo
This field indicates the coarse location information reported by the UE. This field is coded as the
Ellipsoid-Point defined in TS 37.355. The first/leftmost bit of the first octet contains the most
significant bit. The least significant bits of degreesLatitude and degreesLongitude are set to 0 to meet
the accuracy requirement corresponds to a granularity of approximately 2 km.
It is up to UE implementation how many LSBs are set to 0 to meet the accuracy requirement
excessDelay
Indicates the ratio of packets in UL per DRB exceeding the configured delay threshold among the UL
PDCP SDUs, according to the UL PDCP Excess Packet Delay per DRB mapping table.
measId
Identifies the measurement identity for which the reporting is being performed.
measQuantityResults
The value sinr is not included when it is used for LogMeasReport-r16.
measResultCellListSFTD-NR
SFTD measurement results between the PCell and the NR neighbour cell(s) in NR standalone.
measResultCLI
CLI measurement results.
measResultEUTRA
Measured results of an E-UTRA cell.
measResultForRSSI
Includes measured RSSI result in dBm (see TS 38.215) and channelOccupancy which is the
percentage of samples when the RSSI was above the configured channelOccupancyThreshold for
the associated reportConFIGURE
coarseLocationInfo
This field indicates the coarse location information reported by the UE. This field is coded as the
Ellipsoid-Point defined in TS 37.355. The first/leftmost bit of the first octet contains the most
significant bit. The least significant bits of degreesLatitude and degreesLongitude are set to 0 to meet
the accuracy requirement corresponds to a granularity of approximately 2 km.
It is up to UE implementation how many LSBs are set to 0 to meet the accuracy requirement
excessDelay
Indicates the ratio of packets in UL per DRB exceeding the configured delay threshold among the UL
PDCP SDUs, according to the UL PDCP Excess Packet Delay per DRB mapping table.
measResultListEUTRA
List of measured results for the maximum number of reported best cells for an E-UTRA measurement
identity.
measResultListNR
List of measured results for the maximum number of reported best cells for an NR measurement
identity.
measResultListUTRA-FDD
List of measured results for the maximum number of reported best cells for a UTRA-FDD
measurement identity.
measResultNR
Measured results of an NR cell.
measResultServFreqListEUTRA-SCG
Measured results of the E-UTRA SCG serving frequencies: the measurement result of PSCell and
each SCell, if any, and of the best neighbouring cell on each E-UTRA SCG serving frequency.
measResultServFreqListNR-SCG
Measured results of the NR SCG serving frequencies: the measurement result of PSCell and each
SCell, if any, and of the best neighbouring cell on each NR SCG serving frequency.
measResultServingMOList
Measured results of measured cells with reference signals indicated in the serving cell measurement
objects including measurement results of SpCell, configured SCell(s) and best neighbouring cell
within measured cells with reference signals indicated in on each serving cell measurement object.
If the sending of the MeasurementReport message is triggered by a measurement configured by the
field sl-ConfigDedicatedForNR received within an E-UTRA RRCConnectionReconfiguration
message (i.e. CBR measurements), this field is not applicable and its contents is ignored by the
network.
measResultSFTD-EUTRA
SFTD measurement results between the PCell and the E-UTRA PScell in NE-DC.
measResultSFTD-NR
SFTD measurement results between the PCell and the NR PScell in NR-DC.
coarseLocationInfo
This field indicates the coarse location information reported by the UE. This field is coded as the
Ellipsoid-Point defined in TS 37.355. The first/leftmost bit of the first octet contains the most
significant bit. The least significant bits of degreesLatitude and degreesLongitude are set to 0 to meet
the accuracy requirement corresponds to a granularity of approximately 2 km.
It is up to UE implementation how many LSBs are set to 0 to meet the accuracy requirement
excessDelay
Indicates the ratio of packets in UL per DRB exceeding the configured delay threshold among the UL
PDCP SDUs, according to the UL PDCP Excess Packet Delay per DRB mapping table.
measResultsSL
CBR measurements results for NR sidelink communication/discovery.
measResultUTRA-FDD
Measured result of a UTRA-FDD cell.
sl-MeasResultsCandRelay
Measurement result(s) of candiate L2 U2N relay UE(s).
sl-MeasResultsServingRelay
Measurement result of serving L2 U2N relay UE.

### MeasResultIdleNR

The IE MeasResultIdleNR covers the NR measurement results performed in RRC_IDLE and RRC_INACTIVE.

### MeasResultIdleNR Information Element

-- ASN1START
-- TAG-MEASRESULTIDLENR-START

| MeasResultIdleNR-r16 ::= SEQUENCE { | |
|---|---|
| measResultServingCell-r16 SEQUENCE { | |
| rsrp-Result-r16 | RSRP-Range |
| OPTIONAL, | |
| rsrq-Result-r16 | RSRQ-Range |
| OPTIONAL, | |
| resultsSSB-Indexes-116 | ResultsPerSSB-IndexList-r16 |
| OPTIONAL | |
| }, | |

measResultsPerCarrierListIdleNR-r16 SEQUENCE (SIZE (1..maxFreqIdle-r16)) OF

| MeasResultsPerCarrierIdleNR-r16 | OPTIONAL, | | |
|---|---|---|---|
| ... | | | |
| } | | | |
| MeasResultsPerCarrierIdleNR-r16 ::= | | SEQUENCE { | |
| carrierFreq-r16 | | | ARFCN-ValueNR, |
| measResultsPerCellListIdleNR-r16 | | | SEQUENCE (SIZE (1..maxCellMeasIdle-r16)) OF |
| MeasResultsPerCellIdleNR-r16, | | | |
| ... | | | |
| } | | | |

MeasResultsPerCellIdleNR-r16 ::= SEQUENCE {

| physCellId-r16 | | PhysCellId, | |
|---|---|---|---|
| measIdleResultNR-r16 | | SEQUENCE { | |
| rsrp-Result-r16 | | | RSRP-Range |
| OPTIONAL, | | | |
| rsrq-Result-r16 | | | RSRQ-Range |
| OPTIONAL, | | | |
| resultsSSB-Indexes-r16 | | | ResultsPerSSB-IndexList-r16 |
| OPTIONAL | | | |
| }, | | | |
| ... | | | |
| } | | | |
| ResultsPerSSB-IndexList-r16 ::= | SEQUENCE (SIZE (1..maxNrofIndexesToReport)) OF | | |
| ResultsPerSSB-IndexIdle-r16 | | | |
| ResultsPerSSB-IndexIdle-r16 ::= | SEQUENCE { | | |
| ssb-Index-r16 | | SSB-Index, | |
| ssb-Results-r16 | | SEQUENCE { | |
| ssb-RSRP-Result-r16 | | | RSRP-Range |
| OPTIONAL, | | | |
| ssb-RSRQ-Result-r16 | | | RSRQ-Range |
| OPTIONAL | | | |
| } | | | |
| OPTIONAL | | | |
| } | | | |
| -- TAG-MEASRESULTIDLENR-STOP | | | |
| -- ASN1STOP | | | |

MeasResultIdleNR field descriptions

carrierFreq
Indicates the NR carrier frequency.
measIdleResultNR
Idle/inactive measurement results for an NR cell (optionally including beam level measurements).
measResultServingCell
Measured results of the serving cell (i.e., PCell) from idle/inactive measurements.
measResultsPerCellListIdleNR
List of idle/inactive measured results for the maximum number of reported best cells for a given NR
carrier.
resultsSSB-Indexes
Beam level measurement results (indexes and optionally, beam measurements).

### ReportConfigNR

The IE ReportConfigNR specifies criteria for triggering of an NR measurement reporting event or of a CHO, CPA or CPC event or of an L2 U2N relay measurement reporting event. For events labelled AN with N equal to 1, 2 and so on, measurement reporting events and CHO, CPA or CPC events are based on cell measurement results, which can either be derived based on SS/PBCH block or CSI-RS.
Event A1: Serving becomes better than absolute threshold;
Event A2: Serving becomes worse than absolute threshold;
Event A3: Neighbour becomes amount of offset better than PCell/PSCell;
Event A4: Neighbour becomes better than absolute threshold;
Event A5: PCell/PSCell becomes worse than absolute threshold1 AND Neighbour/SCell becomes better than another absolute threshold2;
Event A6: Neighbour becomes amount of offset better than SCell;
Event D1: Distance between UE and a reference location referenceLocation1 becomes larger than configured threshold distanceThreshFromReference1 and distance between UE and a reference location referenceLocation2 becomes shorter than configured threshold distanceThreshFromReference2;
CondEvent A3: Conditional reconfiguration candidate becomes amount of offset better than PCell/PSCell;
CondEvent A4: Conditional reconfiguration candidate becomes better than absolute threshold;
CondEvent A5: PCell/PSCell becomes worse than absolute threshold1 AND Conditional reconfiguration candidate becomes better than another absolute threshold2;
CondEvent D1: Distance between UE and a reference location referenceLocation1 becomes larger than configured threshold distanceThreshFromReference1 and distance between UE and a reference location referenceLocation2 of conditional reconfiguration candidate becomes shorter than configured threshold distanceThreshFromReference2;
CondEvent T1: Time measured at UE becomes more than configured threshold t1-Threshold but is less than t1-Threshold+duration;
Event X1: Serving L2 U2N Relay UE becomes worse than absolute threshold1 AND NR Cell becomes better than another absolute threshold2;
Event X2: Serving L2 U2N Relay UE becomes worse than absolute threshold;
For event I1, measurement reporting event is based on CLI measurement results, which can either be derived based on SRS-RSRP or CLI-RSSI.

Event I1: Interference becomes higher than absolute threshold.

### ReportConfigNR Information Element

-- ASN1START
-- TAG-REPORTCONFIGNR-START

| ReportConfigNR ::= | | | | SEQUENCE { | | | |
|---|---|---|---|---|---|---|---|
| reportType | | | | | CHOICE { | | |
| periodical | | | | | | PeriodicalReportConfig, | |
| eventTriggered | | | | | | EventTriggerConfig, | |
| ..., | | | | | | | |
| reportCGI | | | | | | ReportCGI, | |
| reportSFTD | | | | | | ReportSFTD-NR, | |
| condTriggerConfig-r16 | | | | | | CondTriggerConfig-r16, | |
| cli-Periodical-r16 | | | | | | CLI-PeriodicalReportConfig-r16, | |
| cli-EventTriggered-r16 | | | | | | CLI-EventTriggerConfig-r16, | |
| rxTxPeriodical-117 | | | | | | RxTxPeriodical-r17 | |
| } | | | | | | | |
| } | | | | | | | |
| ReportCGI ::= | SEQUENCE { | | | | | | |
| cellForWhichToReportCGI | | PhysCellId, | | | | | |
| ..., | | | | | | | |
| [[ | | | | | | | |
| useAutonomousGaps-r16 | | ENUMERATED {setup} | | | | | OPTIONAL -- Need R |
| ]] | | | | | | | |
| } | | | | | | | |
| ReportSFTD-NR ::= | SEQUENCE { | | | | | | |
| reportSFTD-Meas | | BOOLEAN, | | | | | |
| reportRSRP | | BOOLEAN, | | | | | |
| ..., | | | | | | | |
| [[ | | | | | | | |
| reportSFTD-NeighMeas | | ENUMERATED {true} | | | | | |
| OPTIONAL, -- Need R | | | | | | | |
| drx-SFTD-NeighMeas | | ENUMERATED {true} | | | | | |
| OPTIONAL, -- Need R | | | | | | | |
| cellsForWhichToReportSFTD | | SEQUENCE (SIZE (1..maxCellSFTD)) OF PhysCellId OPTIONAL | | | | | |
| -- Need R | | | | | | | |
| ]] | | | | | | | |
| } | | | | | | | |
| CondTriggerConfig-r16 ::= | SEQUENCE { | | | | | | |
| condEventId | | CHOICE { | | | | | |
| condEventA3 | | | SEQUENCE { | | | | |
| a3-Offset | | | | MeasTriggerQuantityOffset, | | | |
| hysteresis | | | | Hysteresis, | | | |
| timeToTrigger | | | | TimeToTrigger | | | |
| }, | | | | | | | |
| condEventA5 | | | SEQUENCE { | | | | |
| a5-Threshold1 | | | | MeasTriggerQuantity, | | | |
| a5-Threshold2 | | | | MeasTriggerQuantity, | | | |
| hysteresis | | | | Hysteresis, | | | |
| timeToTrigger | | | | TimeToTrigger | | | |
| }, | | | | | | | |
| ..., | | | | | | | |
| condEventA4-r17 | | | SEQUENCE { | | | | |
| a4-Threshold-r17 | | | | MeasTriggerQuantity, | | | |
| hysteresis-r17 | | | | Hysteresis, | | | |
| timeToTrigger-r17 | | | | TimeToTrigger | | | |
| }, | | | | | | | |
| condEventD1-r17 | | | SEQUENCE { | | | | |
| distanceThreshFromReference1-r17 | | | | INTEGER (0.. 65525), | | | |
| distanceThreshFromReference2-r17 | | | | INTEGER (0.. 65525), | | | |
| referenceLocation1-r17 | | | | ReferenceLocation-r17, | | | |
| referenceLocation2-r17 | | | | ReferenceLocation-r17, | | | |
| hysteresisLocation-r17 | | | | HysteresisLocation-r17, | | | |
| timeToTrigger-r17 | | | | TimeToTrigger | | | |
| }, | | | | | | | |
| condEventT1-r17 | | | SEQUENCE { | | | | |
| t1-Threshold-r17 | | | | INTEGER (0..549755813887), | | | |
| duration-r17 | | | | INTEGER (1..6000) | | | |
| } | | | | | | | |
| }, | | | | | | | |
| rsType-r16 | | NR-RS-Type, | | | | | |
| ... | | | | | | | |
| } | | | | | | | |
| EventTriggerConfig: ;= | | | | SEQUENCE { | | | |
| eventId | | | | | CHOICE { | | |
| eventA1 | | | | | | SEQUENCE { | |
| a1-Threshold | | | | | | | MeasTriggerQuantity, |
| reportOnLeave | | | | | | | BOOLEAN, |
| hysteresis | | | | | | | Hysteresis, |
| timeToTrigger | | | | | | | TimeToTrigger |
| }, | | | | | | | |
| eventA2 | | | | | | SEQUENCE { | |
| a2-Threshold | | | | | | | MeasTriggerQuantity, |
| reportOnLeave | | | | | | | BOOLEAN, |
| hysteresis | | | | | | | Hysteresis, |
| timeToTrigger | | | | | | | TimeToTrigger |
| }, | | | | | | | |
| eventA3 | | | | | | SEQUENCE { | |
| a3-Offset | | | | | | | MeasTriggerQuantityOffset, |
| reportOnLeave | | | | | | | BOOLEAN, |
| hysteresis | | | | | | | Hysteresis, |
| timeToTrigger | | | | | | | TimeToTrigger, |
| useAllowedCellList | | | | | | | BOOLEAN |
| }, | | | | | | | |
| eventA4 | | | | | | SEQUENCE { | |
| a4-Threshold | | | | | | | MeasTriggerQuantity, |
| reportOnLeave | | | | | | | BOOLEAN, |
| hysteresis | | | | | | | Hysteresis, |
| timeToTrigger | | | | | | | TimeToTrigger, |
| useAllowedCellList | | | | | | | BOOLEAN |
| }, | | | | | | | |
| eventA5 | | | | | | SEQUENCE { | |
| a5-Threshold1 | | | | | | | MeasTriggerQuantity, |
| a5-Threshold2 | | | | | | | MeasTriggerQuantity, |
| reportOnLeave | | | | | | | BOOLEAN, |
| hysteresis | | | | | | | Hysteresis, |
| timeToTrigger | | | | | | | TimeToTrigger, |
| useAllowedCellList | | | | | | | BOOLEAN |
| }, | | | | | | | |
| eventA6 | | | | | | SEQUENCE { | |
| a6-Offset | | | | | | | MeasTriggerQuantityOffset, |
| reportOnLeave | | | | | | | BOOLEAN, |
| hysteresis | | | | | | | Hysteresis, |
| timeToTrigger | | | | | | | TimeToTrigger, |
| useAllowedCellList | | | | | | | BOOLEAN |
| }, | | | | | | | |
| ..., | | | | | | | |
| [[ | | | | | | | |
| eventX1-r17 | | | | | | SEQUENCE { | |
| x1-Thresholdl-Relay-r17 | | | | | | | SL-MeasTriggerQuantity-r16, |
| x1-Threshold2-r17 | | | | | | | MeasTriggerQuantity, |
| reportOnLeave-r17 | | | | | | | BOOLEAN, |
| hysteresis-r17 | | | | | | | Hysteresis, |
| timeToTrigger-r17 | | | | | | | TimeToTrigger, |
| useAllowedCellList-r17 | | | | | | | BOOLEAN |
| }, | | | | | | | |
| eventX2-r17 | | | | | | SEQUENCE { | |
| x2-Threshold-Relay-r17 | | | | | | | SL-MeasTriggerQuantity-r16, |
| reportOnLeave-r17 | | | | | | | BOOLEAN, |
| hysteresis-r17 | | | | | | | Hysteresis, |
| timeToTrigger-r17 | | | | | | | TimeToTrigger |
| }, | | | | | | | |
| eventD1-r17 | | | | | | SEQUENCE { | |
| distanceThreshFromReference1-r17 | | | | | | | INTEGER (1.. 65525), |
| distanceThreshFromReference2-117 | | | | | | | INTEGER (1.. 65525) , |
| referenceLocation1-r17 | | | | | | | ReferenceLocation-r17, |
| referenceLocation2-r17 | | | | | | | ReferenceLocation-r17, |
| reportOnLeave-r17 | | | | | | | BOOLEAN, |
| hysteresisLocation-r17 | | | | | | | HysteresisLocation-r17, |
| timeToTrigger-r17 | | | | | | | TimeToTrigger |
| } | | | | | | | |
| ]] | | | | | | | |
| }, | | | | | | | |
| rsType | | | | | NR-RS-Type, | | |
| reportInterval | | | | | ReportInterval, | | |
| reportAmount | | | | | ENUMERATED {r1, r2, r4, r8, r16, r32, r64, | | |
| infinity), | | | | | | | |
| reportQuantityCell | | | | | MeasReportQuantity, | | |
| maxReportCells | | | | | INTEGER (1..maxCellReport), | | |
| reportQuantityRS-Indexes | | | | | MeasReportQuantity | | |
| OPTIONAL, -- Need R | | | | | | | |
| maxNrofRS-IndexesToReport | | | | | INTEGER (1..maxNrofIndexesToReport) | | |
| OPTIONAL, -- Need R | | | | | | | |
| includeBeamMeasurements | | | | | BOOLEAN, | | |
| reportAddNeighMeas | | | | | ENUMERATED {setup} | | |
| OPTIONAL, -- Need R | | | | | | | |
| measRSSI-ReportConfig-r16 | | | | | MeasRSSI-ReportConfig-r16 | | |
| OPTIONAL, -- Need R | | | | | | | |
| useT312-r16 | | | | | BOOLEAN | | |
| OPTIONAL, -- Need M | | | | | | | |
| includeCommonLocationInfo-r16 | | | | | ENUMERATED {true} | | |
| OPTIONAL, -- Need R | | | | | | | |
| includeBT-Meas-116 | | | | | SetupRelease {BT-NameList-r16} | | |
| OPTIONAL, -- Need M | | | | | | | |
| includeWLAN-Meas-r16 | | | | | SetupRelease {WLAN-NameList-r16} | | |
| OPTIONAL, -- Need M | | | | | | | |
| includeSensor-Meas-r16 | | | | | SetupRelease {Sensor-NameList-r16] | | |
| OPTIONAL -- Need M | | | | | | | |
| ]], | | | | | | | |
| [[ | | | | | | | |
| coarseLocationRequest-r17 | | | | | ENUMERATED {true} | | |
| OPTIONAL, -- Need R | | | | | | | |
| reportQuantityRelay-r17 | | | | | SL-MeasReportQuantity-r16 | | |
| OPTIONAL -- Need R | | | | | | | |
| ]] | | | | | | | |
| } | | | | | | | |
| PeriodicalReportConfig ::= | | | | SEQUENCE { | | | |
| rsType | | | | | NR-RS-Type, | | |
| reportInterval | | | | | ReportInterval, | | |
| reportAmount | | | | | ENUMERATED {r1, r2, x4, r8, r16, r32, r64, | | |
| infinity}, | | | | | | | |
| reportQuantityCell | | | | | MeasReportQuantity, | | |
| maxReportCells | | | | | INTEGER (1..maxCellReport), | | |
| reportQuantityRS-Indexes | | | | | MeasReportQuantity | | |
| OPTIONAL, -- Need R | | | | | | | |
| maxNrofRS-IndexesToReport | | | | | INTEGER (1..maxNrofIndexesToReport) | | |
| OPTIONAL, -- Need R | | | | | | | |
| includeBeamMeasurements | | | | | BOOLEAN, | | |
| useAllowedCellList | | | | | BOOLEAN, | | |
| ..., | | | | | | | |
| [[ | | | | | | | |
| measRSSI-ReportConfig-r16 | | | | | MeasRSSI-ReportConfig-r16 | | |
| OPTIONAL, -- Need R | | | | | | | |
| includeCommonLocationInfo-r16 | | | | | ENUMERATED {true} | | |
| OPTIONAL, -- Need R | | | | | | | |
| includeBT-Meas-r16 | | | | | SetupRelease {BT-NameList-r16) | | |
| OPTIONAL, -- Need M | | | | | | | |
| includeWLAN-Meas-r16 | | | | | SetupRelease {WLAN-NameList-r16} | | |
| OPTIONAL, -- Need M | | | | | | | |
| includeSensor-Meas-r16 | | | | | SetupRelease {Sensor-NameList-r16} | | |
| OPTIONAL, -- Need M | | | | | | | |
| ul-DelayValueConfig-r16 | | | | | SetupRelease { UL-DelayValueConfig-r16 } | | |
| OPTIONAL, -- Need M | | | | | | | |
| reportAddNeighMeas-r16 | | | | | ENUMERATED {setup] | | |
| OPTIONAL -- Need R | | | | | | | |
| ]], | | | | | | | |
| [[ | | | | | | | |
| ul-ExcessDelayConfig-r17 | | | | | SetupRelease { UL-ExcessDelayConfig-r17 } | | |
| OPTIONAL, -- Need M | | | | | | | |
| coarseLocationRequest-r17 | | | | | ENUMERATED {true} | | |
| OPTIONAL, -- Need R | | | | | | | |
| reportQuantityRelay-r17 | | | | | SL-MeasReportQuantity-r16 | | |
| OPTIONAL -- Need R | | | | | | | |
| ]] | | | | | | | |
| } | | | | | | | |
| NR-RS-Type ::= | | | | ENUMERATED {ssb, csi-rs} | | | |
| MeasTriggerQuantity ::= | | | | CHOICE { | | | |
| rsrp | | | | | RSRP-Range, | | |
| rsrg | | | | | RSRQ-Range, | | |
| sinr | | | | | SINR-Range | | |
| } | | | | | | | |
| MeasTriggerQuantityOffset ::= | | | | CHOICE { | | | |
| rsrp | | | | | INTEGER (−30..30), | | |
| rsrq | | | | | INTEGER (−30..30), | | |
| sinr | | | | | INTEGER (−30..30) | | |
| } | | | | | | | |
| MeasReportQuantity := | | | | SEQUENCE { | | | |
| rsrp | | | | | BOOLEAN, | | |
| rsrq | | | | | BOOLEAN, | | |
| sinr | | | | | BOOLEAN | | |
| } | | | | | | | |
| MeasRSSI-ReportConfig-r16 ::= | | | | SEQUENCE { | | | |
| channelOccupancyThreshold-r16 | | | | | RSSI-Range-r16 OPTIONAL -- Need R | | |
| } | | | | | | | |
| CLI-EventTriggerConfig-r16 ::= | | | | SEQUENCE { | | | |
| eventId-r16 | | | | | CHOICE { | | |
| eventI1-r16 | | | | | | SEQUENCE { | |
| i1-Threshold-r16 | | | | | | | MeasTriggerQuantityCLI-r16, |
| reportOnLeave-r16 | | | | | | | BOOLEAN, |
| hysteresis-r16 | | | | | | | Hysteresis, |
| timeToTrigger-r16 | | | | | | | TimeToTrigger |
| ], | | | | | | | |
| ... | | | | | | | |
| ], | | | | | | | |
| reportInterval-r16 | | | | | ReportInterval, | | |
| reportAmount-r16 | | | | | ENUMERATED {r1, r2, r4, r8, r16, r32, r64, | | |
| infinity), | | | | | | | |
| maxReportCLI-r16 | | | | | INTEGER (1..maxCLI-Report-r16), | | |
| ... | | | | | | | |
| } | | | | | | | |
| CLI-PeriodicalReportConfig-116 ::= | | | | SEQUENCE { | | | |
| reportInterval-r16 | | | | | ReportInterval, | | |
| reportAmount-r16 | | | | | ENUMERATED (r1, r2, r4, r8, r16, r32, r64, | | |
| infinity), | | | | | | | |
| reportQuantityCLI-r16 | | | | | MeasReportQuantityCLI-r16, | | |
| maxReportCLI-r16 | | | | | INTEGER (1..maxCLI-Report-r16), | | |
| ... | | | | | | | |
| } | | | | | | | |
| RxTxPeriodical-r17 ::= | | | | SEQUENCE { | | | |
| rxTxReportInterval-r17 | | | | | RxTxReportInterval-r17 | | |
| OPTIONAL, -- Need R | | | | | | | |
| reportAmount-r17 | | | | | ENUMERATED {r1, infinity, spare6, spare5, | | |
| spare4, spare3, spare2, spare1}, | | | | | | | |
| ... | | | | | | | |
| } | | | | | | | |

RxTxReportInterval-r17 ::= ENUMERATED

{ms80,ms120,ms160,ms240,ms320,ms480,ms640,ms1024,ms1280,ms2048,ms2560,ms5120,spare4,spare3,spa

| re2,spare1} | | |
|---|---|---|
| MeasTriggerQuantityCLI-r16 ::= | CHOICE { | |
| srs-RSRP-r16 | | SRS-RSRP-Range-r16, |
| cli-RSSI-r16 | | CLI-RSSI-Range-r16 |
| } | | |
| MeasReportQuantityCLI-r16 ::= | ENUMERATED (srs-rsrp, cli-rssi} | |
| -- TAG-REPORTCONFIGNR-STOP | | |
| -- ASN1STOP | | |

CondTriggerConfig field descriptions

a3-Offset
Offset value(s) to be used in NR conditional reconfiguration triggering condition for cond event a3.
The actual value is field value * 0.5 dB.
a4-Threshold
Threshold value associated to the selected trigger quantity (e.g. RSRP, RSRQ, SINR) per RS Type
(e.g. SS/PBCH block, CSI-RS) to be used in NR conditional reconfiguration triggering condition for
cond event a4.
a5-Threshold1/a5-Threshold2
Threshold value associated to the selected trigger quantity (e.g. RSRP, RSRQ, SINR) per RS Type
(e.g. SS/PBCH block, CSI-RS) to be used in NR conditional reconfiguration triggering condition for
cond event a5. In the same condeventA5, the network configures the same quantity for the
MeasTriggerQuantity of the a5-Threshold1 and for the MeasTriggerQuantity of the a5-Threshold2.
condEventId
Choice of NR conditional reconfiguration event triggered criteria.
distanceThreshFromReference1, distanceThreshFromReference2
Distance from a reference location configured with referenceLocation1 or referenceLocation2. Each
step represents 50 m.
duration
This field is used for defining the leaving condition T1-2 for conditional HO event condEventT1. Each
step represents 100 ms.
referenceLocation1, referenceLocation2
Reference locations used for condEventD1. The referenceLocation1 is associated to serving cell and
referenceLocation2 is associated to candidate target cell.
t1-Threshold
The field counts the number of UTC seconds in 10 ms units since 00:00:00 on Gregorian calendar
date 1 Jan. 1900 (midnight between Sunday, Dec. 31, 1899 and Monday, Jan. 1, 1900).
timeToTrigger
Time during which specific criteria for the event needs to be met in order to execute the conditional
reconfiguration evaluation.

ReportConfigNR field descriptions

reportType
Type of the configured measurement report. In MR-DC, network does not configure report of type
reportCGI using SRB3. The condTriggerConfig is used for CHO, CPA or CPC configuration.

ReportCGI field descriptions

useAutonomousGaps
Indicates whether or not the UE is allowed to use autonomous gaps in acquiring system information
from the NR neighbour cell. When the field is included, the UE applies the corresponding value for
T321.

### ReportConfigToAddModList

The IE ReportConfigToAddModList concerns a list of reporting configurations to add or modify.

### ReportConfigToAddModList Information Element

| -- ASN1START | | | |
|---|---|---|---|
| -- TAG-REPORTCONFIGTOADDMODLIST-START | | | |
| ReportConfigToAddModList ::= | SEQUENCE (SIZE (1..maxReportConfigId)) OF | | |
| ReportConfigToAddMod | | | |
| ReportConfigToAddMod ::= | SEQUENCE { | | |
| reportConfigId | | ReportConfigId, | |
| reportConfig | | CHOICE { | |
| reportConfigNR | | | ReportConfigNR, |
| ..., | | | |
| reportConfigInterRAT | | | ReportConfigInterRAT, |
| reportConfigNR-SL-r16 | | | ReportConfigNR-SL-r16 |
| } | | | |
| } | | | |
| -- TAG-REPORTCONFIGTOADDMODLIST-STOP | | | |
| -- ASNISTOP | | | |

### ServingCellConfig

The IE ServingCellConfig is used to configure (add or modify) the UE with a serving cell, which may be the SpCell or an SCell of an MCG or SCG. The parameters herein are mostly UE specific but partly also cell specific (e.g. in additionally configured bandwidth parts). Reconfiguration between a PUCCH and PUCCHless SCell is only supported using an SCell release and add.

### ServingCellConfig Information Element

| -- ASN1START | | | | |
|---|---|---|---|---|
| -- TAG-SERVINGCELLCONFIG-START | | | | |
| ServingCellConfig ::= | SEQUENCE { | | | |
| tdd-UL-DL-ConfigurationDedicated | | TDD-UL-DL-ConfigDedicated | | |
| OPTIONAL, -- Cond TDD | | | | |
| initialDownlinkBWP | | BWP-DownlinkDedicated | | |
| OPTIONAL, -- Need M | | | | |
| downlinkBWP-ToReleaseList | | SEQUENCE (SIZE (1..maxNrofBWPs)) OF BWP-ID | | |
| OPTIONAL, -- Need N | | | | |
| downlinkBWP-ToAddModList | | SEQUENCE (SIZE (1..maxNrofBWPs)) OF BWP-Downlink | | |
| OPTIONAL, -- Need N | | | | |
| firstActiveDownlinkBWP-Id | | BWP-Id | | |
| OPTIONAL, -- Cond SyncAndCellAdd | | | | |
| bwp-InactivityTimer | | ENUMERATED | {ms2, ms3, ms4, ms5, ms6, ms8, ms10, ms20 | |
| | | | ms40,ms50, ms60, ms80,ms00, ms200,ms300 | |
| | | | ms750, ms1280, ms1920, ms2560, spare10, | |
| | | | spare7, spare6, spare5, spare4, spare3, | |
| spare2, spare1 } OPTIONAL, -- Need R | | | | |
| defualtDownlinkBWP-Id | | BWP-Id | | |
| OPTIONAL, -- Need S | | | | |
| uplinkConfig | | UplinkConfig | | |
| OPTIONAL, -- Need M | | | | |
| supplementaryUplink | | UplinkConfig | | |
| OPTIONAL, -- Need M | | | | |
| pdcch-ServingCellConfig | | SetupRelease {PDCCH-ServingCellConfig } | | |
| OPTIONAL, -- Need M | | | | |
| pdsch-ServingCellConfig | | SetupRelease {PDSCH-ServingCellConfig } | | |
| OPTIONAL, -- Need M | | | | |
| csi-MeasConfig | | SetupRelease {CSI-MeasConfig } | | |
| OPTIONAL, -- Need M | | | | |
| sCellDeactivationTimer | | ENUMERATED | {ms20, ms40, ms80, ms160, ms200, ms240, | |
| | | | ms320, ms400, ms480, ms520, ms640, ms720, | |
| | | | ms840, ms1280, spare2,spare1} | |
| OPTIONAL, -- Cond ServingCellWithoutPUCCH | | | | |
| crossCarrierSchedulingConfig | | CrossCarrierSchedulingConfig | | |
| OPTIONAL, -- Need M | | | | |
| tag-Id | | TAG-Id, | | |
| dummy1 | | ENUMERATED {enabled} | | |
| OPTIONAL, -- Need R | | | | |
| pathlossReferenceLinking | | ENUMERATED {spCell, sCell} | | |
| OPTIONAL, -- Cond SCellOnly | | | | |
| servingCellMO | | MeasObjectId | | |
| OPTIONAL, -- Cond MeasObject | | | | |
| ..., | | | | |
| [[ | | | | |
| lte-CRS-ToMatchAround | | SetupRelease { RateMatchPatternLTE-CRS } | | |
| OPTIONAL, -- Need M | | | | |
| rateMatchPatternToAddModList | | SEQUENCE (SIZE (1..maxNrofRateMatchPatterns)) OF | | |
| RateMatchPattern OPTIONAL, -- Need N | | | | |
| rateMatchPatternToReleaseList | | SEQUENCE (SIZE (1..maxNrofRateMatchPatterns)) OF | | |
| RateMatchPatternId OPTIONAL, -- Need N | | | | |
| downlinkChannelBW-PerSCS-List | | SEQUENCE (SIZE (1..maxSCSs)) OF SCS-SpecificCarrier | | |
| OPTIONAL -- Need S | | | | |
| ]], | | | | |
| [[ | | | | |
| supplementaryUplinkRelease-r16 | | ENUMERATED {true} | | |
| OPTIONAL, -- Need N | | | | |
| tdd-UL-DL-ConfigurationDedicated-IAB-MT-R16 | | | | TDD-UL-DL-ConfigDedicated-IAB-MT-r16 |
| OPTIONAL, -- CondTDD_IAB | | | | |
| dormantBWP-Config-r16 | | SetupRelease { DormantBWP-Config-r16 } | | |
| OPTIONAL, -- Need M | | | | |
| ca-SlotOffset-r16 | | CHOICE { | | |
| refSCS15kHz | | | INTEGER (−2..2), | |
| refSCS30KHz | | | INTEGER (−5..5), | |
| refSCS60KHz | | | INTEGER (−10..10), | |
| refSCS120KHz | | | INTEGER (−20..20) | |
| } | | | | |
| OPTIONAL, -- Cond AsyncCA | | | | |
| dummy2 | | SetupRelease { DummyJ } | | |
| OPTIONAL, -- Need M | | | | |
| intraCellGuardBandsDL-List-r16 | | SEQUENCE (SIZE (1..maxSCSs)) OF | | |
| IntraCellGuardBandsPerSCS-r16 | | OPTIONAL, -- Need S | | |
| intraCellGuardBandsUL-List-r16 | | SEQUENCE (SIZE (1..maxSCSs)) OF | | |
| IntraCellGuardBandsPerSCS-r16 | | OPTIONAL, -- Need S | | |
| csi-RS-ValidationWithDCI-r16 | | ENUMERATED {enabled} | | |
| OPTIONAL, -- Need R | | | | |
| lte-CRS-PatternList1-r16 | | SetupRelease { LTE-CRS-PatternList-r16 } | | |
| OPTIONAL, -- Need M | | | | |
| lte-CRS-PatternList2-r16 | | SetupRelease { LTE-CRS-PatternList-r16 } | | |
| OPTIONAL, -- Need M | | | | |
| crs-RateMatch-PerCORESETPoolIndex-r16 | | | ENUMERATED {enabled} | |
| OPTIONAL, -- Need R | | | | |
| enableTwoDefaultTCI-States-r16 | | ENUMERATED {enabled} | | |
| OPTIONAL, -- Need R | | | | |

enableDefaultTCI-StatePerCoresetPoolIndex-r16 ENUMERATED {enabled}

| OPTIONAL, -- Need R | | |
|---|---|---|
| enableBeamSwitchTiming-r16 | ENUMERATED {true} | |
| OPTIONAL, -- Need R | | |
| cbg-TxDiffTBsProcessingType1-r16 | ENUMERATED {enabled} | |
| OPTIONAL, -- Need R | | |
| cbg-TxDiffTBsProcessingType2-r16 | ENUMERATED {enabled} | |
| OPTIONAL, -- Need R | | |
| ]], | | |
| [[ | | |
| directionalCollisionHandling-r16 | ENUMERATED {enabled} | |
| OPTIONAL, -- Need R | | |
| channelAccessConfig-r16 | SetupRelease {ChannelAccessConfig-r16 } | |
| OPTIONAL, -- Need M | | |
| ]], | | |
| [[ | | |
| nr-dl-PRS-PDC-Info-r17 | | SetupRelease {NR-DL-PRS-PDC-Info-r17} |
| OPTIONAL, -- Need M | | |
| semiStaticChannelAccessConfigUE-r17 | | SetupRelease {SemiStaticChannelAccessConfigUE-r17} |
| OPTIONAL, -- Need M | | |
| mimoParam-r17 | SetupRelease {MIMOParam-r17} | |
| OPTIONAL, -- Need M | | |
| channelAccessMode2-r17 | ENUMERATED {enabled} | |
| OPTIONAL, -- Need R | | |
| timeDomainHARQ-BundlingType1-r17 | ENUMERATED {enabled} | |
| OPTIONAL, -- Need R | | |
| nrofHARQ-BundlingGroups-r17 | ENUMERATED {n1, n2, n4} | |
| OPTIONAL, -- Need R | | |
| fdmed-ReceptionMulticast-r17 | ENUMERATED {true} | |
| OPTIONAL, -- Need R | | |
| moreThanOneNackOnlyMode-r17 | ENUMERATED {mode2} | |
| OPTIONAL, -- Need S | | |
| tci-ActivatedConfig-r17 | TCI-ActivatedConfig-r17 | |
| OPTIONAL, -- Cond TCI_ActivatedConfig | | |
| directionalCollisionHandling-DC-r17 | ENUMERATED {enabled} | |
| OPTIONAL, -- Need R | | |

lte-NeighCellsCRS-AssistInfoList-r17 SetupRelease { LTE-NeighCellsCRS-AssistInfoList-

| r17 } OPTIONAL -- Need M | | | | |
|---|---|---|---|---|
| ]], | | | | |
| [[ | | | | |
| lte-NeighCellsCRS-Assumptions-r17 | | ENUMERATED {false} | | |
| OPTIONAL -- Need R | | | | |
| ]] | | | | |
| } | | | | |
| UplinkConfig ::= | SEQUENCE { | | | |
| initialUplinkBWP | | BWP-UplinkDedicated | | |
| OPTIONAL, -- Need M | | | | |
| uplinkBWP-ToReleaseList | | SEQUENCE (SIZE (1..maxNrofBWPs)) OF BWP-Id | | |
| OPTIONAL, -- Need N | | | | |
| uplinkBWP-ToAddModList | | SEQUENCE (SIZE (1..maxNrofBWPs)) OF BWP-Uplink | | |
| OPTIONAL, -- Need N | | | | |
| firstActiveUplinkBWP-Id | | BWP-Id | | |
| OPTIONAL, -- Cond SyncAndCellAdd | | | | |
| pusch-ServingCellConfig | | SetupRelease { PUSCH-ServingCellConfig } | | |
| OPTIONAL, -- Need M | | | | |
| carrierSwitching | | SetupRelease { SRS-CarrierSwitching } | | |
| OPTIONAL, -- Need M | | | | |
| ..., | | | | |
| [[ | | | | |
| powerBoostPi2BPSK | | BOOLEAN | | |
| OPTIONAL, -- Need M | | | | |
| uplinkChannelBW-PerSCS-List | | SEQUENCE (SIZE (1..maxSCSs)) OF SCS-SpecificCarrier | | |
| OPTIONAL -- Need S | | | | |
| ]], | | | | |
| [[ | | | | |
| enablePL-RS-UpdateForPUSCH-SRS-r16 | | ENUMERATED {enabled} | | |
| OPTIONAL, -- Need R | | | | |
| enableDefaultBeamPL-ForPUSCH0-0-r16 | | ENUMERATED {enabled} | | |
| OPTIONAL, -- Need R | | | | |
| enableDefaultBeamPL-ForPUCCH-r16 | | ENUMERATED {enabled} | | |
| OPTIONAL, -- Need R | | | | |
| uplinkTxSwitching-r16 | | SetupRelease { UplinkTxSwitching-r16 } | | |
| OPTIONAL, -- Need M | | | | |
| mpr-PowerBoost-FR2-r16 | | ENUMERATED {true} | | |
| OPTIONAL -- Need R | | | | |
| ]] | | | | |
| } | | | | |
| DummyJ ::= | | SEQUENCE { | | |
| maxEnergyDetectionThreshold-r16 | | | INTEGER(−85..−52), | |
| energyDetectionThresholdOffset-r16 | | | INTEGER (−20..−13), | |
| ul-toDL-COT-SharingED-Threshold-r16 | | | INTEGER (−85..−52) | |
| OPTIONAL, -- Need R | | | | |
| absenceOfAnyOtherTechnology-r16 | | | ENUMERATED {true} | |
| OPTIONAL -- Need R | | | | |
| } | | | | |
| ChannelAccessConfig-r16 ::= | | SEQUENCE { | | |
| energyDetectionConfig-r16 | | | CHOICE { | |
| maxEnergyDetectionThreshold-r16 | | | | INTEGER (−85..−52), |
| energyDetectionThresholdOffset-r16 | | | | INTEGER (−13..20) |
| } | | | | |
| OPTIONAL, -- Need R | | | | |
| ul-toDL-COT-SharingED-Threshold-r16 | | | | INTEGER (−85..−52) |
| OPTIONAL, -- Need R | | | | |
| absenceOfAnyOtherTechnology-r16 | | | | ENUMERATED {true} |
| OPTIONAL -- Need R | | | | |
| } | | | | |
| IntraCellGuardBandsperSCS-r16 ::= | | SEQUENCE { | | |
| guardBandsSC3-r16 | | | SubcarrierSpacing, | |
| intraCellGuardBands-r16 | | | SEQUENCE (SIZE (1..4)) OF GuardBand-r16 | |
| } | | | | |
| GuardBand-r16 ::= | | SEQUENCE { | | |
| startCRB-r16 | | | INTEGER (0..274), | |
| nrofCRBs-r16 | | | INTEGER (0..15) | |
| } | | | | |
| DormancyGroupID-r16 ::= | INTEGER (0..4) | | | |
| DormantBWP-Config-r16::= | | SEQUENCE { | | |
| dormantBWP-Id-r16 | | | BWP-Id | |
| OPTIONAL, -- Need M | | | | |
| withinActiveTimeConfig-r16 | | | SetupRelease { WithinActiveTimeConfig-r16 } | |
| OPTIONAL, -- Need M | | | | |
| outsideActiveTimeConfig-r16 | | | SetupRelease { OutsideActiveTimeConfig-r16 } | |
| OPTIONAL -- Need M | | | | |
| } | | | | |
| WithinActiveTimeConfig-r16 ::= | | SEQUENCE { | | |
| firstWithinActiveTimeBWP-Id-r16 | | | BWP-Id | |
| OPTIONAL, -- Need M | | | | |
| dormancyGroupWithinActiveTime-r16 | | | DormancyGroupID-r16 | |
| OPTIONAL -- Need R | | | | |
| } | | | | |
| OutsideActiveTimeConfig-r16 ::= | | SEQUENCE { | | |
| firstOutsideActiveTimeBWP-Id-r16 | | | BWP-Id | |
| OPTIONAL, -- Need M | | | | |
| dormancyGroupOutsideActiveTime-r16 | | | DormancyGroupID-r16 | |
| OPTIONAL -- Need R | | | | |
| } | | | | |
| UplinkTxSwitching-r16 ::= | | SEQUENCE { | | |
| uplinkTxSwitchingPeriodLocation-r16 | | | BOOLEAN, | |
| uplinkTxSwitchingCarrier-r16 | | | ENUMERATED {carrier1, carrier2} | |
| } | | | | |
| MIMOParam-r17 ::= SEQUENCE { | | | | |
| additionalPCI-ToAddModList-r17 | | SEQUENCE (SIZE(1..maxNrofAdditionalPCI-r17)) OF SSB- | | |
| MTC-AdditionalPCI-r17 OPTIONAL, -- Need N | | | | |
| additionalPCI-ToReleaseList-r17 | | SEQUENCE (SIZE(1..maxNrofAdditionalPCI-r17)) OF | | |
| AdditionalPCIIndex-r17 OPTIONAL, -- Need N | | | | |
| unifiedTCI-StateType-r17 | | ENUMERATED {separate, joint} | | |
| OPTIONAL, -- Need R | | | | |
| uplink-PowerControlToAddModList-r17 | | | SEQUENCE (SIZE (1..maxUL-TCI-r17)) OF Uplink- | |
| powerControl-r17 OPTIONAL, -- Need N | | | | |
| uplink-PowerControlToReleaseList-r17 | | | SEQUENCE (SIZE (1..maxUL-TCI-r17)) OF Uplink- | |
| powerControlId-r17 OPTIONAL, -- Need N | | | | |
| sfnSchemePDCCH-r17 | | ENUMERATED { sfnSchemeA, sfnSchemeB} | | |
| OPTIONAL, -- Need R | | | | |
| sfnSchemePDSCH-r17 | | ENUMERATED { sfnSchemeA, sfnSchemeB} | | |
| OPTIONAL -- Need R | | | | |
| } | | | | |
| -- TAG-SERVINGCELLCONFIG-STOP | | | | |
| -- ASN1STOP | | | | |

### CSI-MeasConfig

The IE CSI-MeasConfig is used to configure CSI-RS (reference signals) belonging to the serving cell in which CSI-MeasConfig is included, channel state information reports to be transmitted on PUCCH on the serving cell in which CSI-MeasConfig is included and channel state information reports on PUSCH triggered by DCI received on the serving cell in which CSI-MeasConfig is included.

### CSI-MeasConfig Information Element

| -- ASN1START | | | |
|---|---|---|---|
| -- TAG-CSI-MEASCONFIG-START | | | |
| CSI-MeasConfig ::= | SEQUENCE { | | |
| nzp-CSI-RS-ResourceToAddModList | | SEQUENCE (SIZE (1..maxNrofNZP-CSI-RS-Resources)) OF | |
| NZP-CSI-RS-Resource OPTIONAL, -- Need N | | | |
| nzp-CSI-RS-ResourceToReleaseList | | SEQUENCE (SIZE (1..maxNrofNZP-CSI-RS-Resources)) OF | |
| NZP-CSI-RS-ResourceId OPTIONAL, -- Need N | | | |
| nzp-CSI-RS-ResourceSetToAddModList | | SEQUENCE (SIZE (1..maxNrofNZP-CSI-RS-ResourceSets)) CF | |
| NZP-CSI-RS-ResourceSet | | | |
| OPTIONAL, -- Need N | | | |
| nzp-CSI-RS-ResourceSetToReleaseList | | SEQUENCE (SIZE (1..maxNrofNZP-CSI-RS-ResourceSets)) OF | |
| NZP-CSI-RS-ResourceSetId | | | |
| OPTIONAL, -- Need N | | | |
| csi-IM-ResourceToAddModList | | SEQUENCE (SIZE (1..maxNrofCSI-IM-Resources)) OF CSI- | |
| IM-Resource OPTIONAL, -- Need N | | | |
| csi-IM-ResourceToReleaseList | | SEQUENCE (SIZE (1,.maxNrofCSI-IM-Resources)) OF CSI- | |
| TM-ResourceId OPTIONAL, -- Need N | | | |
| csi-IM-ResourceSetToAddModList | | SEQUENCE (SIZE (1..maxNrofCSI-IM-ResourceSets)) OF | |
| CSI-IM-ResourceSet OPTIONAL, -- Need N | | | |
| csi-IM-ResourceSetToReleaseList | | SEQUENCE (SIZE (1..maxNrofCSI-IM-ResourceSets)) OF | |
| CSI-IM-ResourceSetId OPTIONAL, -- Need N | | | |
| csi-SSB-ResourceSetToAddModList | | SEQUENCE (SIZE (1..maxNrofCSI-SSB-ResourceSets)) OF | |
| CSI-SSB-ResourceSet OPTIONAL, -- Need N | | | |
| csi-SSB-ResourceSetToReleaseList | | SEQUENCE (SIZE (1..maxNrofCSI-SSB-ResourceSets)) OF | |
| CSI-SSB-ResourceSetId OPTIONAL, -- Need N | | | |
| csi-ResourceConfigToAddModList | | SEQUENCE (SIZE (1..maxNrofCSI-ResourceConfigurations)) | |
| OF CST-ResourceConfig | | | |
| OPTIONAL, -- Need N | | | |
| csi-ResourceConfigToReleaseList | | SEQUENCE (SIZE (1.,maxNrofCSI-ResourceConfigurations)) | |
| OF CSI-ResourceConfigId | | | |
| OPTIONAL, -- Need N | | | |
| csi-ReportConfigToAddModList | | SEQUENCE (SIZE (1..maxNrofCSI-ReportConfigurations)) | |
| OF CSI-ReportConfig OPTIONAL, -- Need N | | | |
| csi-ReportConfigToReleaseList | | SEQUENCE (SIZE (1..maxNrofCSI-ReportConfigurations)) | |
| OF CSI-ReportConfigId | | | |
| OPTIONAL, -- Need N | | | |
| reportTriggerSize | | INTEGER (0..6) | |
| OPTIONAL, -- Need M | | | |
| aperiodicTriggerStateList | | SetupRelease { CSI-AperiodicTriggerStateList } | |
| OPTIONAL, -- Need M | | | |
| semiPersistentOnPUSCH-TriggerStateList | | | SetupRelease ( CSI-SemiPersistentOnPUSCH- |
| TriggerStateList } OPTIONAL, -- Need M | | | |
| ..., | | | |
| [[ | | | |
| reportTriggerSizeDCI-0-2-r16 | | INTEGER (0..6) | |
| OPTIONAL -- Need R | | | |
| ]], | | | |
| [[ | | | |

| | |
|---|---|
| sCellActivationRS-ConfigToAddModList-r17 | SEQUENCE (SIZE (1..maxNrofSCellActRS-r17)) OF |

SCellActivationRS-Config-r17 OPTIONAL, -- Need N

| | |
|---|---|
| sCellActivationRS-ConfigToReleaseList-r17 | SEQUENCE (SIZE (1..maxNrofSCellActRS-r17)) OF |

SCellActivationRS-ConfigId-r17 OPTIONAL -- Need N

]]
}
-- TAG-CSI-MEASCONFIG-STOP
-- ASNISTOP

CSI-MeasConfig field descriptions

aperiodicTriggerStateList
Contains trigger states for dynamically selecting one or more aperiodic and semi-persistent reporting
configurations and/or triggering one or more aperiodic CSI-RS resource sets for channel and/or
interference measurement (see TS 38.214, clause 5.2.1).
csi-IM-ResourceSetToAddModList
Pool of CSI-IM-ResourceSet which can be referred to from CSI-ResourceConfig or from MAC CEs.
csi-IM-ResourceToAddModList
Pool of CSI-IM-Resource which can be referred to from CSI-IM-ResourceSet.
csi-ReportConfigToAddModList
Configured CSI report settings as specified in TS 38.214 clause 5.2.1.1.
csi-ResourceConfigToAddModList
Configured CSI resource settings as specified in TS 38.214 clause 5.2.1.2.
csi-SSB-ResourceSetToAddModList
Pool of CSI-SSB-ResourceSet which can be referred to from CSI-ResourceConFIGURE
nzp-CSI-RS-ResourceSetToAddModList
Pool of NZP-CSI-RS-ResourceSet which can be referred to from CSI-ResourceConfig or from MAC
CEs.
nzp-CSI-RS-ResourceToAddModList
Pool of NZP-CSI-RS-Resource which can be referred to from NZP-CSI-RS-ResourceSet.
reportTriggerSize, reportTriggerSizeDCI-0-2
Size of CSI request field in DCI (bits) (see TS 38.214 [19], clause 5.2.1.5.1). The field
reportTriggerSize applies to DCI format 0_1 and the field reportTriggerSizeDCI-0-2 applies to DCI
format 0_2 (see TS 38.214, clause 5.2.1.5.1).
scellActivationRS-ConfigToAddModList
Configured RS for fast SCell activation as specified in TS 38.214.

### CSI-ReportConfig

The IE CSI-ReportConfig is used to configure a periodic or semi-persistent report sent on PUCCH on the cell in which the CSI-ReportConfig is included, or to configure a semi-persistent or aperiodic report sent on PUSCH triggered by DCI received on the cell in which the CSI-ReportConfig is included (in this case, the cell on which the report is sent is determined by the received DCI). See TS 38.214, clause 5.2.1.

### CSI-ReportConfig Information Element

-- ASNISTART
-- TAG-CSI-REPORTCONFIG-START

| CSI-ReportConfig ::= | SEQUENCE { | | | | |
|---|---|---|---|---|---|
| reportConfigId | | CSI-ReportConfigId, | | | |
| carrier | | ServCellIndex | | | OPTIONAL, -- |
| Need S | | | | | |
| resourcesForChannelMeasurement | | CSI-ResourceConfigId, | | | |
| csi-IM-ResourcesForInterference | | CSI-ResourceConfigId | | | OPTIONAL, -- |
| Need R | | | | | |
| nzp-CSI-RS-ResourcesForInterference | | CSI-ResourceConfigId | | | OPTIONAL, -- |
| Need R | | | | | |
| reportConfigType | | CHOICE { | | | |
| periodic | | | SEQUENCE { | | |
| reportSlotConfig | | | | CSI-ReportPeriodicityAndOffset, | |
| pucch-CSI-ResourceList | | | | SEQUENCE (SIZE (1..maxNrofBWPs)) OF PUCCH- | |
| CSI-Resource | | | | | |
| }, | | | | | |
| semiPersistentOnPUCCH | | | SEQUENCE { | | |
| reportSlotConfig | | | | CSI-ReportPeriodicityAndOffset, | |
| pucch-CSI-ResourceList | | | | SEQUENCE (SIZE (1..maxNrofBWPs) ) OF PUCCH- | |
| CSI-Resource | | | | | |
| }, | | | | | |
| semiPersistentOnPUSCH | | | SEQUENCE { | | |
| reportSlotConfig | | | | ENUMERATED {s15, s110, s120, s140, s180, | |
| s1160, s1320}, | | | | | |
| reportSlotOffsetList | | | | SEQUENCE (SIZE (1..maxNrofUL-Allocations)) OF | |
| INTEGER (0..32), | | | | | |
| p0alpha | | | | P0-PUSCH-AlphaSetId | |
| }, | | | | | |
| aperiodic | | | SEQUENCE { | | |
| reportSlotOffsetList | | | SEQUENCE (SIZE (1..maxNrofUL-Allocations)) OF | | |
| INTEGER (0..32) | | | | | |
| } | | | | | |
| }, | | | | | |
| reportQuantity | | CHOICE { | | | |
| none | | | NULL; | | |
| cri-RI-PMI-CQI | | | NULL, | | |
| cri-RI-i1 | | | NULL, | | |
| cri-RI-i1-CQI | | | SEQUENCE { | | |
| pdsch-BundleSizeForCSI | | | | ENUMERATED {n2, n4} | |
| OPTIONAL -- Need S | | | | | |
| }, | | | | | |
| cri-RI-CQI | | | NULL, | | |
| cri-RSRP | | | NULL, | | |
| ssb-Index-RSRP | | | NULL, | | |
| cri-RI-LI-PMI-CQI | | | NULL | | |
| }, | | | | | |
| reportFreqConfiguration | | SEQUENCE { | | | |
| cqi-Format Indicator | | | ENUMERATED { widebandCQI, subbandCQI } | | |
| OPTIONAL, -- Need R | | | | | |
| pmi-Format Indicator | | | ENUMERATED { widebandPMI, subbandPMI } | | |
| OPTIONAL, -- Need R | | | | | |
| csi-ReportingBand | | | CHOICE { | | |
| subbands3 | | | | BIT STRING(SIZE(3)), | |
| subbands4 | | | | BIT STRING(SIZE(4)), | |
| subbands5 | | | | BIT STRING(SIZE(5)), | |
| subbands6 | | | | BIT STRING(SIZE(6)), | |
| subbands7 | | | | BIT STRING(SIZE(7)), | |
| subbands8 | | | | BIT STRING(SIZE(8)), | |
| subbands9 | | | | BIT STRING(SIZE(9)), | |
| subbands10 | | | | BIT STRING(SIZE(10)), | |
| subbands11 | | | | BIT STRING(SIZE(11)), | |
| subbands12 | | | | BIT STRING(SIZE(12)), | |
| subbands13 | | | | BIT STRING(SIZE(13)), | |
| subbands14 | | | | BIT STRING(SIZE(14)), | |
| subbands15 | | | | BIT STRING(SIZE(15)), | |
| subbands16 | | | | BIT STRING(SIZE(16)), | |
| subbands17 | | | | BIT STRING(SIZE(17)), | |
| subbands18 | | | | BIT STRING(SIZE(18)), | |
| ..., | | | | | |
| subbands19-v1530 | | | | BIT STRING(SIZE (19)) | |
| } OPTIONAL -- Need S | | | | | |
| } | | | | | |
| OPTIONAL, -- Need R | | | | | |
| timeRestrictionForChannelMeasurements | | | | ENUMERATED {configured, notConfigured}, | |
| timeRestrictionForInterferenceMeasurements | | | | ENUMERATED {configured, notConfigured}, | |
| codebookConfig | | | | CodebookConfig | |
| OPTIONAL, -- Need R | | | | | |
| dummy | | | | ENUMERATED {n1, n2} | |
| OPTIONAL, -- Need R | | | | | |
| groupBasedBeamReporting | | | CHOICE { | | |
| enabled | | | | NULL, | |
| disabled | | | | SEQUENCE { | |
| nrofReportedRS | | | | ENUMERATED {n1, n2, n3, n4) | |
| OPTIONAL -- Need S | | | | | |
| } | | | | | |
| }, | | | | | |
| cqi-Table | ENUMERATED (table1, table2, table3, table4-r17} | | | | |
| OPTIONAL, -- Need R | | | | | |
| subbandSize | ENUMERATED (value1, value2}, | | | | |
| non-PMI-PortIndication | SEQUENCE (SIZE (1..maxNrofNZP-CSI-RS-ResourcesPerConfig)) OF | | | | |
| PortIndexFor8Ranks OPTIONAL -- Need R | | | | | |
| ..., | | | | | |
| [[ | | | | | |
| semiPersistentOnPUSCH-v1530 | | SEQUENCE { | | | |
| reportSlotConfig-v1530 | | | ENUMERATED {s14, s18, s116} | | |
| } | | | | | |
| OPTIONAL -- Need R | | | | | |
| ]], | | | | | |
| [[ | | | | | |
| semiPersistentOnPUSCH-v1610 | | SEQUENCE { | | | |
| reportSlotOffsetListDCI-0-2-r16 | | | SEQUENCE (SIZE (1..maxNrofUL-Allocations-r16)) OF | | |
| INTEGER (0..32) OPTIONAL, -- Need R | | | | | |
| reportSlotOffsetListDCI-0-1-r16 | | | SEQUENCE (SIZE (1..maxNrofUL-Allocations-r16)) OF | | |
| INTEGER (0..32) OPTIONAL -- Need R | | | | | |
| } | | | | | |
| OPTIONAL, -- Need R | | | | | |
| aperiodic-v1610 | | SEQUENCE { | | | |
| reportSlotOffsetListDCI-0-2-116 | | | SEQUENCE (SIZE (1..maxNrofUL-Allocations-r16)) OF | | |
| INTEGER (0..32) OPTIONAL, -- Need R | | | | | |
| reportSlotOffsetListDCI-0-1-r16 | | | SEQUENCE (SIZE (1..maxNrofUL-Allocations-r16)) OF | | |
| INTEGER (0..32) OPTIONAL -- Need R | | | | | |
| } | | | | | |
| OPTIONAL, -- Need R | | | | | |
| reportQuantity-r16 | | CHOICE { | | | |
| cri-SINR-r16 | | | NULL, | | |
| ssb-Index-SINR-r16 | | | NULL | | |
| } | | | | | |
| OPTIONAL, -- Need R | | | | | |
| codebookConfig-r16 | | | | CodebookConfig-r16 | |
| OPTIONAL -- Need R | | | | | |
| ]], | | | | | |
| [[ | | | | | |
| cqi-BitsPerSubband-r17 | | ENUMERATED {bits4] | | | |
| OPTIONAL, -- Need R | | | | | |
| groupBasedBeamReporting-v1710 | | SEQUENCE { | | | |
| nrofReportedGroups-r17 | | | ENUMERATED {n1, n2, n3, n4) | | |
| } | | | | | |
| OPTIONAL, -- Need R | | | | | |
| codebookConfig-r17 | | CodebockConfig-r17 | | | |
| OPTIONAL, -- Need R | | | | | |
| sharedCMR-r17 | | ENUMERATED {enable} | | | |
| OPTIONAL, -- Need R | | | | | |
| csi-ReportMode-r17 | | ENUMERATED {model, mode2} | | | |
| OPTIONAL, -- Need R | | | | | |
| numberOfSingleTRP-CSI-Model-r17 | | ENUMERATED {n0, n1, n2} | | | |
| OPTIONAL, -- Need R | | | | | |
| reportQuantity-r17 | | CHOICE { | | | |
| cri-RSRP-Index-r17 | | | NULL, | | |
| ssb-Index-RSRP-Index-r17 | | | NULL, | | |
| cri-SINR-Index-r17 | | | NULL, | | |
| ssb-Index-SINR-Index-r17 | | | NULL | | |
| } | | | | | |
| OPTIONAL -- Need R | | | | | |
| ]], | | | | | |
| [[ | | | | | |
| semiPersistentOnPUSCH-v1720 | | SEQUENCE { | | | |
| reportSlotOffsetList-r17 | | | SEQUENCE (SIZE (1..maxNrofUL-Allocations-16)) OF | | |
| INTEGER (0..128) OPTIONAL, -- Need R | | | | | |
| reportSlotOffsetListDCI-0-2-r17 | | | SEQUENCE (SIZE (1..maxNrofUL-Allocations-r16)) OF | | |
| INTEGER (0..128) OPTIONAL, -- Need R | | | | | |
| reportSlotOffsetListDCI-0-1-r17 | | | SEQUENCE (SIZE (1..maxNrofUL-Allocations-r16)) OF | | |
| INTEGER (0..128) OPTIONAL -- Need R | | | | | |
| } | | | | | |
| OPTIONAL, -- Need R | | | | | |
| aperiodic-v1720 | | SEQUENCE { | | | |
| reportSlotOffsetList-r17 | | | SEQUENCE (SIZE (1..maxNrofUL-Allocations-r16)) OF | | |
| INTEGER (0..128) OPTIONAL, -- Need R | | | | | |
| reportSlotOffsetListDCI-0-2-r17 | | | SEQUENCE (SIZE (1..maxNrofUL-Allocations-r16)) OF | | |
| INTEGER (0..128) OPTIONAL, -- Need R | | | | | |
| reportSlotOffsetListDCI-0-1-r17 | | | SEQUENCE (SIZE (1..maxNrofUL-Allocations-r16)) OF | | |
| INTEGER (0..128) OPTIONAL -- Need R | | | | | |
| } | | | | | |
| OPTIONAL -- Need R | | | | | |
| ]] | | | | | |
| } | | | | | |
| CSI-ReportPeriodicityAndOffset ::= | CHOICE { | | | | |
| slots4 | | INTEGER(0..3), | | | |
| slots5 | | INTEGER(0..4), | | | |
| slots8 | | INTEGER(0..7), | | | |
| slots10 | | INTEGER(0..9), | | | |
| slots16 | | INTEGER(0..15), | | | |
| slots20 | | INTEGER(0..19), | | | |
| slots40 | | INTEGER(0..39), | | | |
| slots80 | | INTEGER(0..79), | | | |
| slots160 | | INTEGER(0..159), | | | |
| slots320 | | INTEGER(0..319) | | | |
| } | | | | | |
| PUCCH-CSI-Resource ::= | SEQUENCE { | | | | |
| uplinkBandwidthPartId | | BWP-Id, | | | |
| pucch-Resource | | PUCCH-ResourceId | | | |
| } | | | | | |
| PortIndexFor8Ranks ::= | CHOICE ( | | | | |
| portIndex8 | | SEQUENCE { | | | |
| rank1-8 | | | PortIndex8 | | |
| OPTIONAL, -- Need R | | | | | |
| rank2-8 | | | SEQUENCE(SIZE(2)) OF PortIndex8 | | |
| OPTIONAL, -- Need R | | | | | |
| rank3-8 | | | SEQUENCE(SIZE(3)) OF PortIndex8 | | |
| OPTIONAL, -- Need R | | | | | |
| rank4-8 | | | SEQUENCE(SIZE(4)) OF PortIndex8 | | |
| OPTIONAL, -- Need R | | | | | |
| rank5-8 | | | SEQUENCE(SIZE(5)) OF PortIndex8 | | |
| OPTIONAL, -- Need R | | | | | |
| rank6-8 | | | SEQUENCE(SIZE(6)) OF PortIndex8 | | |
| OPTIONAL, -- Need R | | | | | |
| rank7-8 | | | SEQUENCE(SIZE(7)) OF PortIndex8 | | |
| OPTIONAL, -- Need R | | | | | |
| rank8-8 | | | SEQUENCE(SIZE(8)) OF PortIndex8 | | |
| OPTIONAL -- Need R | | | | | |
| }, | | | | | |
| portIndex4 | | SEQUENCE { | | | |
| rank1-4 | | | PortIndex4 | | |
| OPTIONAL, -- Need R | | | | | |
| rank2-4 | | | SEQUENCE(SIZE(2)) OF PortIndex4 | | |
| OPTIONAL, -- Need R | | | | | |
| rank3-4 | | | SEQUENCE(SIZE(3)) OF PortIndex4 | | |
| OPTIONAL, -- Need R | | | | | |
| rank4-4 | | | SEQUENCE(SIZE(4)) OF PortIndex4 | | |
| OPTIONAL -- Need R | | | | | |
| }, | | | | | |
| portIndex2 | | SEQUENCE { | | | |
| rank1-2 | | | PortIndex2 | | |
| OPTIONAL, -- Need R | | | | | |
| rank2-2 | | | SEQUENCE(SIZE(2)) OF PortIndex2 | | |
| OPTIONAL -- Need R | | | | | |
| }, | | | | | |
| portIndex1 | | NULL | | | |
| } | | | | | |
| PortIndex8 ::= | INTEGER (0..7) | | | | |
| PortIndex4::= | INTEGER (0..3) | | | | |
| PortIndex2::= | INTEGER (0..1) | | | | |
| -- TAG-CSI-REPORTCONFIG-STOP | | | | | |
| -- ASN1STOP | | | | | |

The following relates to Dual Connectivity (DC).

Multi-Radio Dual Connectivity (MR-DC) is a generalization of Dual Connectivity (DC), where a multiple Rx/Tx capable UE may be configured to utilise resources provided by two different nodes connected via non-ideal backhaul, one providing NR access and the other one providing either E-UTRA or NR access. One node acts as the MN and the other as the SN. The MN (Master Node or MCG (Master Cell Group)) and SN (Secondary Node or SCG (Secondary Cell Group)) are connected via a network interface and at least the MN is connected to the core network. The MN and/or the SN can be operated with shared spectrum channel access.

All functions specified for a UE may be used for an IAB-MT unless otherwise stated. Similar as specified for UE, the IAB-MT can access the network using either one network node or using two different nodes with EN-DC and NR-DC architectures. In EN-DC, the backhauling traffic over the E-UTRA radio interface is not supported.

In this invention, AI/ML configuration and its functionality we propose can be extended and applied to MR-DC scenarios as follows:
E-UTRAN supports MR-DC via E-UTRA-NR Dual Connectivity (EN-DC), in which a UE is connected to one eNB that acts as a MN and one en-gNB that acts as a SN. The eNB is connected to the EPC via the S1 interface and to the en-gNB via the X2 interface. The en-gNB might also be connected to the EPC via the S1-U interface and other en-gNBs via the X2-U interface.
NG-RAN supports NG-RAN E-UTRA-NR Dual Connectivity (NGEN-DC), in which a UE is connected to one ng-eNB that acts as a MN and one gNB that acts as a SN.
NG-RAN supports NR-E-UTRA Dual Connectivity (NE-DC), in which a UE is connected to one gNB that acts as a MN and one ng-eNB that acts as a SN.
NG-RAN supports NR-NR Dual Connectivity (NR-DC), in which a UE is connected to one gNB that acts as a MN and another gNB that acts as a SN. In addition, NR-DC can also be used when a UE is connected to a single gNB, acting both as a MN and as a SN, and configuring both MCG and SCG.

For example, AI/ML functionality would be difficult to support in LTE because it is state of the art technology while NR highly likely supports it. To support AI/ML functionality in LTE, when a UE is connected with eNB (or E-UTRAN or ng-eNB), the network can configure MR-DC for the UE. For the UE, SRB3 or a RB (configured for AI/ML functionality, e.g. SRBx or a DBR) can be configured and used for AI/ML (re-)configuration and reporting (e.g. AI/ML data) to support AI/ML functionality, which can be configured and used for SCG (NR gNB) of the UE, i.e. The NR can support AI/ML functionality via SCG (e.g. gNB) of the UE configured with MR-DC. To enable this, the MCG (eNB or E-UTRAN or ng-eNB) should negotiate the configuration or capability for AI/ML functionality with candidates of SCG (e.g. gNBs) by exchanging messages including such information before configuring MR-DC to the UE.

In (NG)EN-DC and NR-DC, SRB3 or a RB (configured for AI/ML functionality, e.g. SRBx or a DRB) can be used for measurement configuration and reporting, for UE assistance (re-)configuration and reporting for power savings, for AI/ML (re-)configuration and reporting (e.g. AI/ML data) for AI/ML functionality support, for IP address (re-)configuration and reporting for IAB-nodes, to (re-)configure MAC, RLC, BAP, physical layer and RLF timers and constants of the SCG configuration, and to reconfigure PDCP for DRBs associated with the S-KgNB or SRB3 or a RB (configured for AI/ML functionality, e.g. SRBx or a DRB), and to reconfigure SDAP for DRBs associated with S-KgNB in NGEN-DC and NR-DC, and to add/modify/release conditional PSCell change configuration, provided that the (re-)configuration does not require any MN involvement, and to transmit RRC messages between the MN and the UE during fast MCG link recovery. In (NG)EN-DC and NR-DC, only measConfig, radioBearerConfig, conditionalReconfiguration, bap-Config, iab-IP-AddressConfigurationList, otherConfig, secondaryCellGroup, and/or AI/ML (re-)configuration and reporting (e.g. AI/ML data) for AI/ML functionality support are included in RRCReconfiguration received via SRB3 or a RB (configured for AI/ML functionality, e.g. SRBx or a DRB), except when RRCReconfiguration is received within DLInformationTransferMRDC.

In NR-DC, the UE may receive two AI/ML configurations, one from MCG (Master Cell Group) and the other from SCG (Secondary Cell Group). To simplify UE operation and network configuration, we propose several options to handle AI/ML configurations and AI/ML data reporting when UE is configured with dual connectivity, i.e. configured with MCG and SCG. The following options can be also applied to UE configured with single connectivity (e.g. MCG only):

Option 1. UE can maintain AI/ML configurations (or reportings) for MCG and SCG, separately. Given that the network can configure multiple AI/ML models (or AI/ML configurations) to UE with the corresponding identifiers as we proposed in the above, this option gives more flexibility to the network, i.e. the network can run a AI/ML model for each cell group (MCG or SCG) as follows (e.g. with separate configuration or with separate cell group identifier). For AI/ML data reporting, the AI/ML data associated with MCG (or AI/ML configuration for MCG) can be reported to MCG via SRB1 while the AI/ML data associated with SCG (or AI/ML configuration for SCG) can be reported to SCG via SRB3 or a RB (configured for AI/ML functionality, e.g. SRBx or a DRB) or SRB1. For the AI/ML data associated with SCG (or AI/ML configuration for SCG), UE prioritizes SRB3 or a RB (configured for AI/ML functionality, e.g. SRBx or a DRB) over SRB1 when UE report it, if SRB3 or a RB (configured for AI/ML functionality, e.g. SRBx or a DRB) is configured. In another embodiment, the network can introduce a indica tor to indicate which SRB UE uses for AI/ML data reporting for SCG, i.e. SRB1 or SRB3 or a RB (configured for AI/ML functionality, e.g. SRBx or a DRB). In another example, if the indicator is included in RRC message, UE report AI/ML data for SCG via SRB3 or a RB (configured for AI/ML functionality, e.g. SRBx or a DRB). Otherwise, SRB1 (In this case, AI/ML data for SCG is included in RRC message embedded in RRC message for which MCG forward it to SCG). For example, if the indicator is included in RRC message, UE report AI/ML data for SCG via SRB1 (In this case, AI/ML data for SCG is included in RRC message embedded in RRC message which MCG forwards to SCG) Otherwise, SRB3 or a RB (configured for AI/ML functionality, e.g. SRBx or a DRB).
a AIMLConfigMCG, associated with MCG, that is included in the RRCReconfiguration message (e.g. generated by MCG) received via SRB1; and
a AIMLConfigSCG, associated with SCG, that is included in the RRCReconfiguration message (e.g. generated by SCG) received via SRB3 or a RB (configured for AI/ML functionality, e.g. SRBx or a DRB), or, alternatively, included within a RRCReconfiguration message (e.g. generated by SCG) embedded in a RRCReconfiguration message (e.g. generated by MCG) received via SRB1.

Option 2. UE can maintain a AI/ML configuration for MCG and SCG. The network can run a AI/ML configuration for MCG and SCG, i.e. only a AI/ML configuration is possible and the common AI/ML configuration (or AI/ML model) for MCG and SCG can be configured. For example, UE replaces (or override) the old AI/ML configuration with a new AI/ML configuration when UE receives the new AI/ML configuration via SRB1 or SRB3 or a RB (configured for AI/ML functionality, e.g. SRBx or a DRB) from MCG or SCG. For AI/ML data reporting, the AI/ML data can be reported to MCG via SRB1 or SRB3 or a RB (configured for AI/ML functionality, e.g. SRBx or a DRB). UE prioritizes SRB3 or a RB (configured for AI/ML functionality, e.g. SRBx or a DRB) over SRB1 when UE report it, if SRB3 or a RB (configured for AI/ML functionality, e.g. SRBx or a DRB) is configured. In another embodiment, the network can introduce a indicator to indicate which SRB UE uses for AI/ML data reporting, i.e. SRB1 or SRB3 or a RB (configured for AI/ML functionality, e.g. SRBx or a DRB). For example, if the indicator is included in RRC message, UE report AI/ML data via SRB3 or a RB (configured for AI/ML functionality, e.g. SRBx or a DRB). Otherwise, SRB1. In another example, if the indicator is included in RRC message, UE report AI/ML data via SRB1. Otherwise, SRB3 or a RB (configured for AI/ML functionality, e.g. SRBx or a DRB).
a AIMLConfig, that is included in the RRCReconfiguration message (e.g. generated by MCG) received via SRB1; and that is included in the RRCReconfiguration message (e.g. generated by SCG) received via SRB3 or a RB (configured for AI/ML functionality, e.g. SRBx or a DRB), alternatively, included within a RRCReconfiguration message (e.g. generated by SCG) embedded in a RRCReconfiguration message (e.g. generated by MCG) received via SRB1.

Option 3. To simplify UE's implementation, the option 3 can restrict the network implementation such that AI/ML configuration is configured by MCG only, e.g. it can be included in the RRCReconfiguration message (e.g. generated by MCG) received via SRB1 or it can be included within a RRCReconfiguration message (e.g. generated by SCG) embedded in a RRCReconfiguration message (e.g. generated by MCG) received via SRB1. The option 3 can restrict the UE/network implementation such that AI/ML data is reported to MCG only (i.e. SRB1), e.g. it can be reported in the RRC message via SRB1 or it can be reported within a RRC message embedded in a RRC message which MCG forwards to SCG. In another embodiment, Option 3 can be applied to Option 1 as Option 3-1. In another embodiment, Option 3 can be applied to Option 2 as Option 3-2.

In these options, delta configuration is supported. For example, MCG or SCG can reconfigure a part of the previous (or current) AI/ML configuration by RRC message. In another embodiment, we can introduce a indicator to indicate whether to release the previous (or current) AI/ML configuration fully, i.e. if this indicator is included together with a new AI/ML configuration in RRC message, UE releases the current AI/ML configuration and configure the received configuration. Else if the new AI/ML configuration is included without this indicator, UE can re-configure a part of the current AI/ML configuration with the received AI/ML configuration.

In an embodiment of this invention, the measurements includes (or indicates) the collection of AI/ML data, the measurement configuration includes (or indicates) AI/ML configuration, the measurement results include (or indicate) AI/ML data, the events for measurement triggering includes (or indicates) the events for AI/ML collection, and the measurement reporting includes (or indicates) AI/ML data reporting.

The network may configure an RRC_CONNECTED UE to perform measurements. The network may configure the UE to report them in accordance with the measurement configuration or perform conditional reconfiguration evaluation in accordance with the conditional reconfiguration. The measurement configuration is provided by means of dedicated signalling i.e. using the RRCReconfiguration or RRCResume.

The network may configure the UE to perform the following types of measurements:
NR measurements;
Inter-RAT measurements of E-UTRA frequencies;
Inter-RAT measurements of UTRA-FDD frequencies;
NR sidelink measurements of L2 U2N Relay UEs.

The network may configure the UE to report the following measurement information based on SS/PBCH block(s):
Measurement results per SS/PBCH block;
Measurement results per cell based on SS/PBCH block(s);
SS/PBCH block(s) indexes.

The network may configure the UE to report the following measurement information based on CSI-RS resources:
Measurement results per CSI-RS resource;
Measurement results per cell based on CSI-RS resource(s);
CSI-RS resource measurement identifiers.

The network may configure the UE to perform the following types of measurements for NR sidelink and V2X sidelink:
CBR measurements.

The network may configure the UE to report the following CLI measurement information based on SRS resources:
Measurement results per SRS resource;
SRS resource(s) indexes.

The network may configure the UE to report the following CLI measurement information based on CLI-RSSI resources:
Measurement results per CLI-RSSI resource;
CLI-RSSI resource(s) indexes.

The network may configure the UE to report the following Rx-Tx time difference measurement information based on CSI-RS for tracking or PRS:
UE Rx-Tx time difference measurement result.

The measurement configuration includes the following parameters:

1. Measurement objects: A list of objects on which the UE shall perform the measurements.
For intra-frequency and inter-frequency measurements a measurement object indicates the frequency/time location and subcarrier spacing of reference signals to be measured. Associated with this measurement object, the network may configure a list of cell specific offsets, a list of ‘exclude-listed’ cells and a list of ‘allow-listed’ cells. Exclude-listed cells are not applicable in event evaluation or measurement reporting. Allow-listed cells are the only ones applicable in event evaluation or measurement reporting.
The measObjectId of the MO which corresponds to each serving cell is indicated by servingCellMO within the serving cell configuration.
For inter-RAT E-UTRA measurements a measurement object is a single E-UTRA carrier frequency. Associated with this E-UTRA carrier frequency, the network can configure a list of cell specific offsets and a list of ‘exclude-listed’ cells. Exclude-listed cells are not applicable in event evaluation or measurement reporting.
For inter-RAT UTRA-FDD measurements a measurement object is a set of cells on a single UTRA-FDD carrier frequency.
For NR sidelink measurements of L2 U2N Relay UEs, a measurement object is a single NR sidelink frequency to be measured.
For CBR measurement of NR sidelink communication, a measurement object is a set of transmission resource pool(s) on a single carrier frequency for NR sidelink communication.
For CBR measurement of NR sidelink discovery, a measurement object is a set of discovery dedicated resource pool(s) or transmission resource pool(s) also used for NR sidelink discovery on a single carrier frequency for NR sidelink discovery.
For CLI measurements a measurement object indicates the frequency/time location of SRS resources and/or CLI-RSSI resources, and subcarrier spacing of SRS resources to be measured.

2. Reporting configurations: A list of reporting configurations where there can be one or multiple reporting configurations per measurement object. Each measurement reporting configuration consists of the following:
Reporting criterion: The criterion that triggers the UE to send a measurement report. This can either be periodical or a single event description.
RS type: The RS that the UE uses for beam and cell measurement results (SS/PBCH block or CSI-RS).
Reporting format: The quantities per cell and per beam that the UE includes in the measurement report (e.g. RSRP) and other associated information such as the maximum number of cells and the maximum number beams per cell to report.

In case of conditional reconfiguration, each configuration consists of the following:
Execution criteria: The criteria the UE uses for conditional reconfiguration execution.
RS type: The RS that the UE uses for obtaining beam and cell measurement results (SS/PBCH block-based or CSI-RS-based), used for evaluating conditional reconfiguration execution condition.

3. Measurement identities: For measurement reporting, a list of measurement identities where each measurement identity links one measurement object with one reporting configuration. By configuring multiple measurement identities, it is possible to link more than one measurement object to the same reporting configuration, as well as to link more than one reporting configuration to the same measurement object. The measurement identity is also included in the measurement report that triggered the reporting, serving as a reference to the network. For conditional reconfiguration triggering, one measurement identity links to exactly one conditional reconfiguration trigger configuration. And up to 2 measurement identities can be linked to one conditional reconfiguration execution condition.

4. Quantity configurations: The quantity configuration defines the measurement filtering configuration used for all event evaluation and related reporting, and for periodical reporting of that measurement. For NR measurements, the network may configure up to 2 quantity configurations with a reference in the NR measurement object to the configuration that is to be used. In each configuration, different filter coefficients can be configured for different measurement quantities, for different RS types, and for measurements per cell and per beam.

5. Measurement gaps: Periods that the UE may use to perform measurements.

A UE in RRC_CONNECTED maintains a measurement object list, a reporting configuration list, and a measurement identities list according to signalling and procedures in this specification. The measurement object list possibly includes NR measurement object(s), CLI measurement object(s), inter-RAT objects, and L2 U2N Relay objects. Similarly, the reporting configuration list includes NR, inter-RAT, and L2 U2N Relay reporting configurations. Any measurement object can be linked to any reporting configuration of the same RAT type. Some reporting configurations may not be linked to a measurement object. Likewise, some measurement objects may not be linked to a reporting configuration.

The measurement procedures distinguish the following types of cells:

1. The NR serving cell(s)—these are the SpCell and one or more SCells.

2. Listed cells—these are cells listed within the measurement object(s).

3. Detected cells—these are cells that are not listed within the measurement object(s) but are detected by the UE on the SSB frequency(ies) and subcarrier spacing(s) indicated by the measurement object(s).

For NR measurement object(s), the UE measures and reports on the serving cell(s)/serving Relay UE (for L2 U2N Remote UE), listed cells and/or detected cells. For inter-RAT measurements object(s) of E-UTRA, the UE measures and reports on listed cells and detected cells and, for RSSI and channel occupancy measurements, the UE measures and reports on the configured resources on the indicated frequency. For inter-RAT measurements object(s) of UTRA-FDD, the UE measures and reports on listed cells. For CLI measurement object(s), the UE measures and reports on configured measurement resources (i.e. SRS resources and/or CLI-RSSI resources). For L2 U2N Relay object(s), the UE measures and reports on the serving NR cell(s), as well as the discovered L2 U2N Relay UEs.

Whenever the procedural specification, other than contained in clause 5.5.2, refers to a field it concerns a field included in the VarMeasConfig unless explicitly stated otherwise i.e. only the measurement configuration procedure covers the direct UE action related to the received measConfig.

In NR-DC, the UE may receive two independent measConfig:
a measConfig, associated with MCG, that is included in the RRCReconfiguration message received via SRB1; and
a measConfig, associated with SCG, that is included in the RRCReconfiguration message received via SRB3 or a RB (configured for AI/ML functionality, e.g. SRBx or a DRB), or, alternatively, included within a RRCReconfiguration message embedded in a RRCReconfiguration message received via SRB1.

In this case, the UE maintains two independent VarMeasConfig and VarMeasReportList, one associated with each measConfig, and independently performs all the procedures in clause 6.5 for each measConfig and the associated VarMeasConfig and VarMeasReportList, unless explicitly stated otherwise.

In another embodiment, in NR-DC, the UE may receive common measConfig:
a measConfig, that is included in the RRCReconfiguration message received via SRB1; or that is included in the RRCReconfiguration message received via SRB3 or a RB (configured for AI/ML functionality, e.g. SRBx or a DRB), or, alternatively, included within a RRCReconfiguration message embedded in a RRCReconfiguration message received via SRB1.

In this case, the UE maintains common VarMeasConfig and VarMeasReportList, one associated with measConfig, and performs all the procedures in clause 6.5 for the measConfig and the associated VarMeasConfig and VarMeasReportList, unless explicitly stated otherwise.

The configurations related to CBR measurements are only included in the measConfig associated with MCG.

The configurations related to Rx-Tx time difference measurement are only included in the measConfig associated with MCG.

In relation to Measurement configuration, the network applies the procedure as follows:
to ensure that, whenever the UE has a measConfig associated with a CG, it includes a measObject for the SpCell and for each NR SCell of the CG to be measured;
to configure at most one measurement identity (or AI/ML identity) for across all CGs using a reporting configuration with the reportType set to reportCGI;
to configure at most one measurement identity (or AI/ML identity) per the node hosting PDCP entity using a reporting configuration with the ul-Delay ValueConfig;
to configure at most one measurement identity (or AI/ML identity) per the node hosting PDCP entity using a reporting configuration with the ul-ExcessDelayConfig;
to ensure that, in the measConfig associated with a CG:
for all SSB based measurements there is at most one measurement object with the same ssbFrequency;
an smtc1 included in any measurement object with the same ssbFrequency has the same value and that an smtc2 included in any measurement object with the same ssbFrequency has the same value and that an smtc3list included in any measurement object with the same ssbFrequency has the same value and that an smtc4list included in any measurement object with the same ssbFrequency has the same value;
to ensure that all measurement objects configured in this specification and with the same ssbFrequency have the same ssbSubcarrierSpacing;
to ensure that, if a measurement object associated with the MCG has the same ssbFrequency as a measurement object associated with the SCG:
for that ssbFrequency, the measurement window according to the smtc1 configured by the MCG includes the measurement window according to the smtc1 configured by the SCG, or vice-versa, with an accuracy of the maximum receive timing difference specified.
if both measurement objects are used for RSSI measurements, bits in measurementSlots in both objects corresponding to the same slot are set to the same value. Also, the endSymbol is the same in both objects.
to ensure that, if a measurement object has the same ssbFrequency as a measurement object configured:
for that ssbFrequency, the measurement window according to the smtc configured includes the measurement window according to the smtc1 configured, or vice-versa, with an accuracy of the maximum receive timing difference specified.
if both measurement objects are used for RSSI measurements, bits in measurementSlots in both objects corresponding to the same slot are set to the same value. Also, the endSymbol is the same in both objects.
when the UE is in NE-DC, NR-DC, or NR standalone, to configure at most one measurement identity across all CGs using a reporting configuration with the reportType set to reportSFTD;

For CSI-RS resources, the network applies the procedure as follows:
to ensure that all CSI-RS resources configured in each measurement object have the same center frequency, (startPRB+floor (nrofPRBs/2))
to ensure that the total number of CSI-RS resources configured in each measurement object does not exceed the maximum number specified.

In relation to Quantity Configuration, the UE shall:
1> for each RAT for which the received quantityConfig includes parameter(s):
2> set the corresponding parameter(s) in quantityConfig within VarMeasConfig to the value of the received quantityConfig parameter(s);
1> for each measId (or AIML identifier) included in the measIdList (or list of AIML identifiers) within VarMeasConfig:
2> remove the measurement reporting entry for this measId (or AIML identifier) from the VarMeasReportList (or list of AIML reports), if included;
2> stop the periodical reporting timer or timer T321 or timer T322, whichever one is running, and reset the associated information (e.g. timeToTrigger) for this measId (or AIML identifier).

In relation to Measurement reporting, the intention is to transfer measurement results from the UE to the network. The UE shall initiate this procedure only after successful AS security activation. FIG. 11 shows a representation of this process.

For the measId for which the measurement reporting procedure was triggered, the UE shall set the measResults within the MeasurementReport message as follows:
1> set the measId to the measurement identity that triggered the measurement reporting;
1> for each serving cell configured with servingCellMO:
2> if the reportConfig associated with the measId that triggered the measurement reporting includes rsType:
3> if the serving cell measurements based on the rsType included in the reportConfig that triggered the measurement report are available:
4> set the measResultServingCell within measResultServingMOList to include RSRP, RSRQ and the available SINR of the serving cell, derived based on the rsType included in the reportConfig that triggered the measurement report;
2> else:
3> if SSB based serving cell measurements are available:
4> set the measResultServingCell within measResultServingMOList to include RSRP, RSRQ and the available SINR of the serving cell, derived based on SSB;
3> else if CSI-RS based serving cell measurements are available:
4> set the measResultServingCell within measResultServingMOList to include RSRP, RSRQ and the available SINR of the serving cell, derived based on CSI-RS;
1> set the servCellId within measResultServingMOList to include each NR serving cell that is configured with servingCellMO, if any;
1> if the reportConfig associated with the measId that triggered the measurement reporting includes reportQuantityRS-Indexes and maxNrofRS-IndexesToReport:
2> for each serving cell configured with servingCellMO, include beam measurement information according to the associated reportConfig as described in 5.5.5.2;
1> if the reportConfig associated with the measId that triggered the measurement reporting includes reportAddNeighMeas:
2> for each measObjectId referenced in the measIdList which is also referenced with servingCellMO, other than the measObjectId corresponding with the measId that triggered the measurement reporting:
3> if the measObjectNR indicated by the servingCellMO includes the RS resource configuration corresponding to the rsType indicated in the reportConfig:
4> set the measResultBestNeighCell within measResultServingMOList to include the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR;
4> if the reportConfig associated with the measId that triggered the measurement reporting includes reportQuantityRS-Indexes and maxNrofRS-IndexesToReport:
5> for each best non-serving cell included in the measurement report:
6> include beam measurement information according to the associated reportConfig as described in 5.5.5.2;
1> if the reportConfig associated with the measId that triggered the measurement reporting is set to eventTriggered and eventID is set to eventA3, or eventA4, or eventA5, or eventB1, or eventB2:
2> if the UE is in NE-DC and the measurement configuration that triggered this measurement report is associated with the MCG (this condition is not needed when the proposed Option 2 (i.e. common AI/ML configuration is maintained for MCG and SCG) is applied):
3> set the measResultServFreqListEUTRA-SCG to include an entry for each E-UTRA SCG serving frequency with the following:
4> include carrierFreq of the E-UTRA serving frequency;
4> set the measResultServingCell to include the available measurement quantities that the UE is configured to measure by the measurement configuration associated with the SCG;
4> if reportConfig associated with the measId that triggered the measurement reporting includes reportAddNeighMeas:
5> set the measResultServFreqListEUTRA-SCG to include within measResultBestNeighCell the quantities of the best non-serving cell, based on RSRP, on the concerned serving frequency;
1> if reportConfig associated with the measId that triggered the measurement reporting is set to eventTriggered and eventID is set to eventA3, or eventA4, or eventA5:
2> if the UE is in NR-DC and the measurement configuration that triggered this measurement report is associated with the MCG (this condition is not needed when the proposed Option 2 (i.e. common AI/ML configuration is maintained for MCG and SCG) is applied):
3> set the measResultServFreqListNR-SCG to include for each NR SCG serving cell that is configured with servingCellMO, if any, the following:
4> if the reportConfig associated with the measId that triggered the measurement reporting includes rsType:
5> if the serving cell measurements based on the rsType included in the reportConfig that triggered the measurement report are available according to the measurement configuration associated with the SCG:
6> set the measResultServingCell within measResultServFreqListNR-SCG to include RSRP, RSRQ and the available SINR of the serving cell, derived based on the rsType included in the reportConfig that triggered the measurement report;
4> else:
5> if SSB based serving cell measurements are available according to the measurement configuration associated with the SCG:
6> set the measResultServingCell within measResultServFreqListNR-SCG to include RSRP, RSRQ and the available SINR of the serving cell, derived based on SSB;
5> else if CSI-RS based serving cell measurements are available according to the measurement configuration associated with the SCG:
6> set the measResultServingCell within measResultServFreqListNR-SCG to include RSRP, RSRQ and the available SINR of the serving cell, derived based on CSI-RS;
4> if results for the serving cell derived based on SSB are included:
5> include the ssbFrequency to the value indicated by ssbFrequency as included in the MeasObjectNR of the serving cell;
4> if results for the serving cell derived based on CSI-RS are included:
5> include the refFreqCSI-RS to the value indicated by refFreqCSI-RS as included in the MeasObjectNR of the serving cell;
4> if the reportConfig associated with the measId that triggered the measurement reporting includes reportQuantityRS-Indexes and maxNrofRS-IndexesToReport:
5> for each serving cell configured with servingCellMO, include beam measurement information according to the associated reportConfig as described in 6.5.5.2, where availability is considered according to the measurement configuration associated with the SCG;
4> if reportConfig associated with the measId that triggered the measurement reporting includes reportAddNeighMeas:
5> if the measObjectNR indicated by the servingCellMO includes the RS resource configuration corresponding to the rsType indicated in the reportConfig:
6> set the measResultBestNeighCellListNR within measResultServFreqListNR-SCG to include one entry with the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR, where availability is considered according to the measurement configuration associated with the SCG;
7> if the reportConfig associated with the measId that triggered the measurement reporting includes reportQuantityRS-Indexes and maxNrofRS-IndexesToReport:
8> for each best non-serving cell included in the measurement report:
9> include beam measurement information according to the associated reportConfig as described in 6.5.5.2, where availability is considered according to the measurement configuration associated with the SCG;
1> if the measRSSI-ReportConfig is configured within the corresponding reportConfig for this measId:
2> set the rssi-Result to the linear average of sample value(s) provided by lower layers in the reportInterval;
2> set the channelOccupancy to the rounded percentage of sample values which are beyond the channelOccupancy Threshold within all the sample values in the reportInterval;
1> if the UE is acting as L2 U2N Remote UE:
2> set the sl-MeasResultServingRelay in accordance with the following:
3> set the cellIdentity to include the cellAccessRelatedInfo contained in the discovery message received from the serving L2 U2N Relay UE;
3> set the sl-RelayUE-Identity to include the Source L2 ID of the serving L2 U2N Relay;
3> set the sl-MeasResult to include the SL-RSRP of the serving L2 U2N Relay UE;

NOTE 1: In case of no data transmission from L2 U2N Relay UE to L2 U2N Remote UE, it is left to UE implementation whether to use SL-RSRP or SD-RSRP when setting the sl-MeasResultServingRelay of the serving L2 U2N Relay UE.
1> if there is at least one applicable neighbouring cell or candidate L2 U2N Relay

UE to report:
2> if the reportType is set to eventTriggered or periodical:
3> if the measurement report concerns the candidate L2 U2N Relay UE:
4> set the sl-MeasResultsCandRelay in measResultNeighCells to include the best candidate L2 U2N Relay UEs up to maxReportCells in accordance with the following:
5> if the reportType is set to eventTriggered:
6> include the L2 U2N Relay UEs included in the relaysTriggeredList as defined within the VarMeasReportList for this measId;
5> else:
6> include the applicable L2 U2N Relay UEs for which the new measurement results became available since the last periodical reporting or since the measurement was initiated or reset;
5> for each L2 U2N Relay UE that is included in the sl-MeasResultsCandRelay:
6> set the cellIdentity to include the cellAccessRelatedInfo contained in the discovery message received from the concerned L2 U2N Relay UE;
6> set the sl-RelayUE-Identity to include the Source L2 ID of the concerned L2 U2N Relay UE;
6> set the sl-MeasResult to include the SD-RSRP of the concerned L2 U2N Relay

UE;

5> for each included L2 U2N Relay UE, include the layer 3 filtered measured results in accordance with the reportConfig for this measId, ordered as follows:
6> set the sl-MeasResult to include the quantity (ies) indicated in the reportQuantityRelay within the concerned reportConfigRelay in decreasing order of the sorting quantity, determined as specified in 6.5.5.3, i.e. the best L2 U2N Relay UE is included first;
3> else:
4> set the measResultNeighCells to include the best neighbouring cells up to maxReportCells in accordance with the following:
5> if the reportType is set to eventTriggered and eventId is not set to eventD1:
6> include the cells included in the cellsTriggeredList as defined within the VarMeasReportList for this measId;
5> else:
6> include the applicable cells for which the new measurement results became available since the last periodical reporting or since the measurement was initiated or reset;
5> for each cell that is included in the measResultNeighCells, include the physCellId;
5> if the reportType is set to eventTriggered or periodical:
6> for each included cell, include the layer 3 filtered measured results in accordance with the reportConfig for this measId, ordered as follows:
7> if the measObject associated with this measId concerns NR:
8> if rsType in the associated reportConfig is set to ssb:
9> set resultsSSB-Cell within the measResult to include the SS/PBCH block based quantity (ies) indicated in the reportQuantityCell within the concerned reportConfig, in decreasing order of the sorting quantity, determined as specified in 6.5.5.3, i.e. the best cell is included first;
9> if reportQuantityRS-Indexes and maxNrofRS-IndexesToReport are configured, include beam measurement information as described in 6.5.5.2;
8> else if rsType in the associated reportConfig is set to csi-rs:
9> set resultsCSI-RS-Cell within the measResult to include the CSI-RS based quantity (ies) indicated in the reportQuantityCell within the concerned reportConfig, in decreasing order of the sorting quantity, determined as specified in 6.5.5.3, i.e. the best cell is included first;
9> if reportQuantityRS-Indexes and maxNrofRS-IndexesToReport are configured, include beam measurement information as described in 6.5.5.2;
7> if the measObject associated with this measId concerns E-UTRA:
8> set the measResult to include the quantity (ies) indicated in the reportQuantity

within the concerned reportConfigInterRAT in decreasing order of the sorting quantity, determined as specified in 6.5.5.3, i.e. the best cell is included first;
7> if the measObject associated with this measId concerns UTRA-FDD and if ReportConfigInterRAT includes the reportQuantityUTRA-FDD:
8> set the measResult to include the quantity (ies) indicated in the reportQuantityUTRA-FDD within the concerned reportConfigInterRAT in decreasing order of the sorting quantity, determined as specified in 6.5.5.3, i.e. the best cell is included first;
2> else:
3> if the cell indicated by cellForWhichToReportCGI is an NR cell:
4> if plmn-IdentityInfoList of the cgi-Info for the concerned cell has been obtained:
5> include the plmn-IdentityInfoList including plmn-IdentityList, trackingAreaCode (if available), trackingAreaList (if available), ranac (if available), cellIdentity and cellReservedForOperatorUse for each entry of the plmn-IdentityInfoList;
5> include frequencyBandList if available;
5> for each PLMN-IdentityInfo in plmn-IdentityInfoList:
6> if the gNB-ID-Length is broadcast:
7> include gNB-ID-Length;
4> if nr-CGI-Reporting-NPN is supported by the UE and npn-IdentityInfoList of the cgi-Info for the concerned cell has been obtained:
5> include the npn-IdentityInfoList including npn-IdentityList, trackingAreaCode, ranac (if available), cellIdentity and cellReservedForOperatorUse for each entry of the npn-IdentityInfoList;
5> for each NPN-IdentityInfo in NPN-IdentityInfoList:
6> if the gNB-ID-Length is broadcast:
7> include gNB-ID-Length;
5> include cellReservedForOtherUse if available;
4> else if MIB indicates the SIB1 is not broadcast:
5> include the noSIB1 including the ssb-SubcarrierOffset and pdcch-ConfigSIB1 obtained from MIB of the concerned cell;
3> if the cell indicated by cellForWhichToReportCGI is an E-UTRA cell:
4> if all mandatory fields of the cgi-Info-EPC for the concerned cell have been obtained:
5> include in the cgi-Info-EPC the fields broadcasted in E-UTRA SystemInformationBlockType1 associated to EPC;
4> if the UE is E-UTRA/5GC capable and all mandatory fields of the cgi-Info-5GC for the concerned cell have been obtained:
5> include in the cgi-Info-5GC the fields broadcasted in E-UTRA SystemInformationBlockType1 associated to 5GC;
4> if the mandatory present fields of the cgi-Info for the cell indicated by the cellForWhichToReportCGI in the associated measObject have been obtained:
5> include the freqBandIndicator;
5> if the cell broadcasts the multiBandInfoList, include the multiBandInfoList;
5> if the cell broadcasts the freqBandIndicatorPriority, include the freqBandIndicatorPriority;
1> if the corresponding measObject concerns NR:
2> if the reportSFTD-Meas is set to true within the corresponding reportConfigNR for this measId:
3> set the measResultSFTD-NR in accordance with the following:
4> set sfn-OffsetResult and frameBoundaryOffsetResult to the measurement results provided by lower layers;
4> if the reportRSRP is set to true;
5> set rsrp-Result to the RSRP of the NR PSCell derived based on SSB;
2> else if the reportSFTD-NeighMeas is included within the corresponding reportConfigNR for this measId:
3> for each applicable cell which measurement results are available, include an entry in the measResultCellListSFTD-NR and set the contents as follows:
4> set physCellId to the physical cell identity of the concerned NR neighbour cell.
4> set sfn-OffsetResult and frameBoundaryOffsetResult to the measurement results provided by lower layers;
4> if the reportRSRP is set to true:
5> set rsrp-Result to the RSRP of the concerned cell derived based on SSB;
1> else if the corresponding measObject concerns E-UTRA:
2> if the reportSFTD-Meas is set to true within the corresponding reportConfigInterRAT for this measId:
3> set the measResultSFTD-EUTRA in accordance with the following:
4> set sfn-OffsetResult and frameBoundaryOffsetResult to the measurement results provided by lower layers;
4> if the reportRSRP is set to true;
5> set rsrpResult-EUTRA to the RSRP of the EUTRA PSCell;
1> if average uplink PDCP delay values are available:
2> set the ul-PDCP-DelayValueResultList to include the corresponding average uplink PDCP delay values;
1> if PDCP excess delay measurements are available:
2> set the ul-PDCP-ExcessDelayResultList to include the corresponding PDCP excess delay measurements;
1> if the includeCommonLocationInfo is configured in the corresponding reportConfig for this measId and detailed location information that has not been reported is available, set the content of commonLocationInfo of the locationInfo as follows:
2> include the locationTimestamp;
2> include the locationCoordinate, if available;
2> include the velocityEstimate, if available;
2> include the locationError, if available;
2> include the locationSource, if available;
2> if available, include the gnss-TOD-msec,
1> if the coarseLocationRequest is set to true in the corresponding reportConfig for this measId:
2> include coarseLocationInfo, if available;
1> if the includeWLAN-Meas is configured in the corresponding reportConfig for this measId, set the wlan-LocationInfo of the locationInfo in the measResults as follows:
2> if available, include the LogMeasResultWLAN, in order of decreasing RSSI for WLAN APS;
1> if the includeBT-Meas is configured in the corresponding reportConfig for this measId, set the BT-LocationInfo of the locationInfo in the measResults as follows:
2> if available, include the LogMeasResultBT, in order of decreasing RSSI for Bluetooth beacons;
1> if the includeSensor-Meas is configured in the corresponding reportConfig for this measId, set the sensor-LocationInfo of the locationInfo in the measResults as follows:
2> if available, include the sensor-MeasurementInformation;
2> if available, include the sensor-MotionInformation;
1> if there is at least one applicable transmission resource pool for NR sidelink communication/discovery (for measResultsSL):
2> set the measResultsListSL to include the CBR measurement results in accordance with the following:
3> if the reportType is set to eventTriggered:
4> include the transmission resource pools included in the poolsTriggeredList as defined within the VarMeasReportList for this measId;
3> else:
4> include the applicable transmission resource pools for which the new

measurement results became available since the last periodical reporting or since the measurement was initiated or reset;
3> if the corresponding measObject concerns NR sidelink communication/discovery, then for each transmission resource pool to be reported:
4> set the sl-poolReportIdentity to the identity of this transmission resource pool;
4> set the sl-CBR-ResultsNR to the CBR measurement results on PSSCH and PSCCH of this transmission resource pool provided by lower layers, if available;

NOTE 1: Void.
1> if there is at least one applicable CLI measurement resource to report:
2> if the reportType is set to cli-EventTriggered or cli-Periodical:
3> set the measResultCLI to include the most interfering SRS resources or most interfering CLI-RSSI resources up to maxReportCLI in accordance with the following:
4> if the reportType is set to cli-EventTriggered:
5> if trigger quantity is set to srs-RSRP i.e. i1-Threshold is set to srs-RSRP:
6> include the SRS resource included in the cli-TriggeredList as defined within the VarMeasReportList for this measId;
5> if trigger quantity is set to cli-RSSI i.e. i1-Threshold is set to cli-RSSI:
6> include the CLI-RSSI resource included in the cli-TriggeredList as defined within the VarMeasReportList for this measId;
4> else:
5> if reportQuantityCLI is set to srs-rsrp:
6> include the applicable SRS resources for which the new measurement results became available since the last periodical reporting or since the measurement was initiated or reset;
5> else:
6> include the applicable CLI-RSSI resources for which the new measurement results became available since the last periodical reporting or since the measurement was initiated or reset;
4> for each SRS resource that is included in the measResultCLI:
5> include the srs-ResourceId;
5> set srs-RSRP-Result to include the layer 3 filtered measured results in decreasing order, i.e. the most interfering SRS resource is included first;
4> for each CLI-RSSI resource that is included in the measResultCLI:
5> include the rssi-ResourceId;
5> set cli-RSSI-Result to include the layer 3 filtered measured results in decreasing order, i.e. the most interfering CLI-RSSI resource is included first;
1> if there is at least one applicable UE Rx-Tx time difference measurement to report:
2> set measResultRxTxTimeDiff to the latest measurement result;
1> increment the numberOfReportsSent as defined within the VarMeasReportList for this measId by 1;
1> stop the periodical reporting timer, if running;
1> if the numberOfReportsSent as defined within the VarMeasReportList for this measId is less than the reportAmount as defined within the corresponding reportConfig for this measId:
2> start the periodical reporting timer with the value of reportInterval as defined within the corresponding reportConfig for this measId;
1> else:
2> if the reportType is set to periodical or cli-Periodical or rxTxPeriodical:
3> remove the entry within the VarMeasReportList for this measId;
3> remove this measId from the measIdList within VarMeasConfig;
1> if the measurement reporting was configured by a sl-ConfigDedicatedNR received within the RRCConnectionReconfiguration:
2> submit the MeasurementReport message to lower layers for transmission via SRB1, embedded in E-UTRA RRC message ULInformationTransferIRAT as specified TS 36.331 [10], clause 5.6.28;
1> else if the UE is in (NG)EN-DC:
2> if SRB3 or a RB (configured for AI/ML functionality, e.g. SRBx or a DRB) is configured and the SCG is not deactivated or if indicator for SRB3 or a RB (configured for AI/ML functionality, e.g. SRBx or a DRB) is included in RRC message (or configuration):
3> submit the MeasurementReport message via SRB3 or a RB (configured for AI/ML functionality, e.g. SRBx or a DRB) to lower layers for transmission, upon which the procedure ends;
2> else:
3> submit the MeasurementReport message via E-UTRA embedded in E-UTRA RRC message ULInformationTransferMRDC as specified in TS 36.331 [10].
1> else if the UE is in NR-DC:
2> if the measurement configuration that triggered this measurement report is associated with the SCG:
3> if SRB3 or a RB (configured for AI/ML functionality, e.g. SRBx or a DRB) is configured and the SCG is not deactivated or if indicator for SRB3 or a RB (configured for AI/ML functionality, e.g. SRBx or a DRB) is included in RRC message (or configuration):
4> submit the MeasurementReport message via SRB3 or a RB (configured for AI/ML functionality, e.g. SRBx or a DRB) to lower layers for transmission, upon which the procedure ends;
3> else:
4> submit the MeasurementReport message via SRB1 embedded in NR RRC message ULInformationTransferMRDC as specified in 5.7.2a.3;
2> else:
3> submit the MeasurementReport message via SRB1 to lower layers for transmission, upon which the procedure ends;
1> else:
2> submit the MeasurementReport message to lower layers for transmission, upon which the procedure ends.

The following relates to Split SRB handling. SRB4 is for RRC messages which include application layer measurement report information, all using DCCH logical channel. SRB4 can only be configured by the network after AS security activation. The main purpose of SRB4 is for QoE (Quality of Experience) measurement. QoE is related to but differs from Quality of Service (QoS), which embodies the notion that hardware and software characteristics can be measured, improved and perhaps guaranteed. For SRB4, split SRB can be useful to enhance the reliability while it can complicate UE's implementation for all the MR-DC options. Regarding SRB4, we propose several options to handle split SRB as follows:
Option 1: Split SRB is supported for all the MR-DC options in both SRB1 and SRB2 (split SRB is not supported for SRB0, SRB3, and SRB4). The benefit of spilt SRB is to reduce the latency and increase the reliability of data transmission at the cost of UE implementation complexity. For SRB4, it can be more preferable to reduce UE implementation complexity rather than the benefit of split SRB given that SRB4 is mainly for QoE (Quality of Experience) enhancement. Hence, it would be better to limit network configuration, i.e. the network is not allowed to configure SRB4 with split SRB to UE. When the network configures SRB4 to UE with split SRB, the UE considers it as an error case or declare an error (e.g. configuration error or configuration failure).
Option 2: Split SRB is supported for all the MR-DC options in SRB1, SRB2, and SRB4 (split SRB is not supported for SRB0 and SRB3). The benefit of spilt SRB is to reduce the latency and increase the reliability of data transmission at the cost of UE implementation complexity. It can be extended to the configuration of SRB4 to give more flexibility of configuration to the network.

The RB (configured for AI/ML functionality, e.g. SRBx) is for RRC messages which include AI/ML functionality or configuration related information, all using DCCH logical channel. The SRBx can only be configured by the network after AS security activation. The main purpose of SRBx is for AI/ML functionality. For SRBx, split SRB can be useful to enhance the reliability while it can complicate UE's implementation for all the MR-DC options. Regarding SRBx, we propose several options to handle split SRB as follows:
Option 1: Split SRB is supported for all the MR-DC options in both SRB1 and SRB2 (split SRB is not supported for SRB0, SRB3, SRB4, and SRBx). The benefit of spilt SRB is to reduce the latency and increase the reliability of data transmission at the cost of UE implementation complexity. For SRBx, it can be more preferable to reduce UE implementation complexity rather than the benefit of split SRB given that SRBx is mainly for AI/ML functionality. Hence, it would be better to limit network configuration, i.e. the network is not allowed to configure SRBx with split SRB to UE. When the network configures SRBx to UE with split SRB, the UE considers it as an error case or declare an error (e.g. configuration error or configuration failure).
Option 2: Split SRB is supported for all the MR-DC options in SRB1, SRB2, and SRBx (split SRB is not supported for SRB0, SRB3, and SRB4). The benefit of spilt SRB is to reduce the latency and increase the reliability of data transmission at the cost of UE implementation complexity. It can be extended to the configuration of SRBx to give more flexibility of configuration to the network.

The following relates to Mobility Support (i.e. Handover). Network controlled mobility applies to UEs in RRC_CONNECTED and is categorized into two types of mobility: cell level mobility and beam level mobility. Beam level mobility includes intra-cell beam level mobility and inter-cell beam level mobility.

Cell Level Mobility requires explicit RRC signalling to be triggered, i.e. handover. For inter-gNB handover, i.e. RRC managed handover with PDCP entity re-establishment or handover with security update or handover by RRC message including the security update configuration (e.g. when masterKeyUpdate is received in RRCReconfiguration triggering the handover), the signalling procedures consist of at least the following elemental components illustrated in FIG. 8.1.2.1. For intra-gNB handover, i.e. RRC managed handover without PDCP entity re-establishment (or with PDCP data recovery) or handover without security update or handover by RRC message not including the security update configuration (e.g. when masterKeyUpdate is not received in RRCReconfiguration triggering the handover), the signalling procedures consist of at least the following elemental components illustrated in FIG. 12 where the targe gNB is the source gNB because it is intra-gNB handover. The step numbers are those shown in FIG. 12.

Step 1. The source gNB initiates handover and issues a HANDOVER REQUEST over the Xn interface. The HANDOVER REQUEST (i.e. Xn message) can include a indicator (a identifier) related to AI/ML functionality. The indicator related to AI/ML functionality can be used to indicate whether UE is using/configured with AI/ML functionality or to ask the target gNB if it supports AI/ML functionality. When the identifiers related to AI/ML functionality is included, they can be used to indicate which models (i.e. AI/ML models) UE is using/configured or to ask the target gNB if it supports the models. In another embodiment, the source gNB can include possible candidates for AI/ML models (or functionalities) and share them with the target gNB by including them in HANDOVER REQUEST. The target gNB can include supported AI/ML models (or functionalities) out of the possible candidates to response to the HANDOVER REQUEST by sending HANDOVER REQUEST ACKNOWLEDGE including them.

Step 2. The target gNB performs admission control and provides the new RRC configuration as part of the HANDOVER REQUEST ACKNOWLEDGE. The HANDOVER REQUEST ACKNOWLEDGE (i.e. Xn message) can include a indicator (a identifier) related to AI/ML functionality. The indicator related to AI/ML functionality can be used to configure UE with AI/ML functionality (or a model) or to let the source gNB know if the target gNB supports AI/ML functionality (or a model). When the identifiers related to AI/ML functionality is included, they can be used to indicate which models (i.e. AI/ML models) the target gNB configures UE with or to let the source gNB know if the target gNB supports the models. By using identifiers, the target gNB may not have to transfer the whole models to UE, which can reduce the signalling overhead, i.e. the source gNB or UE can generate or set up the AI/ML model corresponding to the identifiers on their own (e.g. pre-configured memory or SIM (Subscriber Identity Module)). In another embodiment, when the HANDOVER REQUEST ACKNOWLEDGE does not include the indicators or identifiers related to AI/ML functionality, the source gNB and UE can fall back to a mode not using AI/ML functionality (i.e. releasing AI/ML functionality).

Step 3. The source gNB provides the RRC configuration to the UE by forwarding the RRCReconfiguration message (including the indicators or identifiers related AI/ML functionality described above) received in the HANDOVER REQUEST ACKNOWLEDGE. The RRCReconfiguration message includes at least cell ID and all information required to access the target cell so that the UE can access the target cell without reading system information. For some cases, the information required for contention-based and contention-free random access can be included in the RRCReconfiguration message. The access information to the target cell may include beam specific information, if any. In another embodiment, when RRCReconfiguration n message does not include the indicators or identifiers related to AI/ML functionality (or indicate the release of AI/ML functionality (i.e. configuration), the UE can fall back to a mode not using AI/ML functionality (i.e. releasing AI/ML functionality).

Step 4. The UE moves the RRC connection to the target gNB and replies with the RRCReconfigurationComplete.

The following relates to a Dual Active Protocol Stack (DAPS) handover, which is a handover procedure that maintains the source gNB connection after reception of RRC message for handover and until releasing the source cell after successful random access to the target gNB.

In case of DAPS handover, the UE continues the downlink user data reception from the source gNB until releasing the source cell and continues the uplink user data transmission to the source gNB until successful random access procedure to the target gNB.

For DAPS handover, there are restrictions for configurations considering the pros and cons as follows:
Option 1 supports DAPS handover for AI/ML functionality to increase the flexibility of the network management. Only source and target PCell are used during DAPS handover. CA, DC, SUL, multi-TRP, EHC, CHO, UDC, NR sidelink configurations and V2X sidelink configurations are released by the source gNB before the handover command is sent to the UE and are not configured by the target gNB until the DAPS handover has completed (i.e. at earliest in the same message that releases the source PCell).
Option 2 does not support DAPS handover for AI/ML functionality to reduce implementation complexity. Only source and target PCell are used during DAPS handover. CA, DC, SUL, multi-TRP, EHC, CHO, UDC, NR sidelink configurations, V2X sidelink configurations, and AI/ML functionality related configurations are released by the source gNB before the handover command is sent to the UE and are not configured by the target gNB until the DAPS handover has completed (i.e. at earliest in the same message that releases the source PCell).

The handover mechanism triggered by RRC requires the UE at least to reset the MAC entity and re-establish RLC, except for DAPS handover, where upon reception of the handover command, the UE:
Creates a MAC entity for target;
Establishes the RLC entity and an associated DTCH logical channel for target for each DRB configured with DAPS;
For each DRB configured with DAPS, reconfigures the PDCP entity with separate security and ROHC functions for source and target and associates them with the RLC entities configured by source and target respectively;
Retains the rest of the source configurations until release of the source.

RRC managed handovers with PDCP entity re-establishment (inter-gNB handover) and without PDCP entity re-establishment (intra-gNB handover) are both supported. For DRBs using RLC AM mode and a SRB for AI/ML functionality (e.g. SRBx or SRB5), PDCP can either be re-established together with a security key change or initiate a data recovery procedure without a key change. For DRBs using RLC UM mode, PDCP can either be re-established together with a security key change or remain as it is without a key change. For SRBs except a SRB for AI/ML functionality (e.g. SRBx or SRB5), PDCP can either remain as it is, discard its stored PDCP PDUs/SDUs without a key change or be re-established together with a security key change. For a SRB for AI/ML functionality (e.g. SRBx or SRB5), PDCP can either be re-established together with a security key change or initiate a data recovery procedure without a key change.

In embodiments of this invention, a SRB for AI/ML functionality (e.g. SRBx or SRB5) can be extended to a normal SRB (e.g. SRB1 or SRB2 or SRB3 or SRB4) and a DRB for AI/ML functionality. The same proposals can be applied to a DRB for supporting AI/ML functionality.

The PDCP entity operations to support a handover for AI/ML functionality are set out specifically as follows:

The RRCReconfiguration described in FIG. 12 can trigger RRC managed handovers with PDCP entity re-establishment (inter-gNB handover) or without PDCP entity re-establishment (intra-gNB handover) or with PDCP data recovery (intra-gNB handover).

In embodiments of this invention, there is introduced a new indicator (e.g. recoverPDCP-rX) to indicate a PDCP data recovery for a SRB for AI/ML functionality (e.g. SRBx or SRB5). In another embodiment, the legacy indicator (i.e. recoverPDCP) can be used to indicate a PDCP data recovery for a SRB for AI/ML functionality (e.g. SRBx or SRB5)

To expedite RRC message processing, a new indicator (e.g. recoverPDCP-rX) or legacy indicator (i.e. recoverPDCP) can be introduced in SRB-ToAddMod of SRB-ToAddModList of RadioBearerConfig in RRCReconfiguration message, which indicates a PDCP data recovery for a SRB for AI/ML functionality (e.g. SRBx or SRB5).

To support lossless delivery during a handover, we propose to introduce a new indicator (e.g. statusReportRequired-rX) to trigger a PDCP status report for a SRB for AI/ML functionality (e.g. SRBx or SRB5). In another embodiment, the legacy indicator (i.e. statusReportRequired) can be used to trigger a PDCP status report for a SRB for AI/ML functionality (e.g. SRBx or SRB5).

To expedite RRC message processing and minimize the implementation impact, a new indicator (e.g. statusReportRequired-rX) or legacy indicator (i.e. statusReportRequired) can be introduced in pdcp-config in SRB-ToAddMod of SRB-ToAddModList of RadioBearerConfig in RRCReconfiguration message, which triggers a PDCP status report for a SRB for AI/ML functionality (e.g. SRBx or SRB5).

For a DRB configured for AI/ML functionality, the legacy indicators (i.e. recoverPDCP or reestablishPDCP or statusReportRequired) can be used and the corresponding behaviors can be performed according to the followings.

### RadioBearerConfig

The IE RadioBearerConfig is used to add, modify and release signalling, multicast MRBs and/or data radio bearers. Specifically, this IE carries the parameters for PDCP and, if applicable, SDAP entities for the radio bearers.

### RadioBearerConfig Information Element

-- ASN1START
-- TAG-RADIOBEARERCONFIG-START

| RadioBearerConfig ::= | SEQUENCE { | | | |
|---|---|---|---|---|
| srb-ToAddModList | SRB-ToAddModList | | | OPTIONAL, |
| -- Cond HO-Conn | | | | |
| srb3-ToRelease | ENUMERATED{true} | | | OPTIONAL, |
| -- Need N | | | | |
| drb-ToAddModList | DRB-ToAddModList | | | OPTIONAL, |
| -- Cond HO-toNR | | | | |
| drb-ToReleaseList | DRB-ToReleaseList | | | OPTIONAL, |
| -- Need N | | | | |
| securityConfig | SecurityConfig | | | OPTIONAL, |
| -- Need M | | | | |
| ..., | | | | |
| [[ | | | | |
| mrb-ToAddModList-r17 | MRB-ToAddModList-r17 | | | OPTIONAL, |
| -- Need N | | | | |
| mrb-ToReleaseList-r17 | | | MRB-ToReleaseList-r17 | |
| OPTIONAL, -- Need N | | | | |
| srb4-ToAddMod-r17 | SRB-ToAddMod | | | OPTIONAL, |
| -- Need N | | | | |
| srb4-ToRelease-r17 | ENUMERATED{true} | | | OPTIONAL |
| -- Need N | | | | |
| ]] | | | | |
| } | | | | |
| SRB-ToAddModList ::= | SEQUENCE (SIZE (1..2)) OF SRB-ToAddMod | | | |
| SRB-ToAddMod ::= | SEQUENCE { | | | |
| srb-Identity | | SRB-Identity, | | |
| reestablishPDCP | ENUMERATED{true} | | | OPTIONAL, |
| -- Need N | | | | |
| discardOnPDCP | ENUMERATED{true} | | | OPTIONAL, |
| -- Need N | | | | |
| pdcp-Config | PDCP-Config | | | OPTIONAL, |
| Cond PDCP | | | | |
| recoverPDCP-rX | ENUMERATED{true} | | | OPTIONAL, |
| -- Need N | | | | |
| recoverPDCP | ENUMERATED{true} | | | OPTIONAL, |
| -- Need N | | | | |
| ..., | | | | |
| [[ | | | | |
| srb-identity-v1700 | SRB-Identity-v1700 | | | OPTIONAL |
| -- Need M | | | | |
| ]] | | | | |
| } | | | | |
| DRB-ToAddModList ::= | SEQUENCE (SIZE (1..maxDRB)) OF DRB-ToAddMod | | | |
| DRB-ToAddMod ::= | SEQUENCE { | | | |
| cnAssociation | | CHOICE { | | |
| eps-BearerIdentity | | | INTEGER (0..15), | |
| sdap-Config | | | SDAP-Config | |
| } | | | | OPTIONAL, |
| -- Cond DRBSetup | | | | |
| drb-Identity | | DRB-Identity, | | |
| reestablishPDCP | ENUMERATED{true} | | | OPTIONAL, |
| -- Need N | | | | |
| recoverPDCP | ENUMERATED{true} | | | OPTIONAL, |
| -- Need N | | | | |
| pdcp-Config | PDCP-Config | | | OPTIONAL, |
| -- Cond PDCP | | | | |
| ..., | | | | |
| [[ | | | | |
| daps-Config-r16 | ENUMERATED{true} | | | OPTIONAL |
| -- Cond DAPS | | | | |
| ]] | | | | |
| } | | | | |
| DRB-ToReleaseList ::= | SEQUENCE (SIZE (1..maxDRB)) OF DRB-Identity | | | |
| SecurityConfig ::= | SEQUENCE { | | | |
| securityAlgorithmConfig | | | SecurityAlgorithmConfig | |
| OPTIONAL, -- Cond RBTermChange1 | | | | |
| keyToUse | ENUMERATED (master, secondary} OPTIONAL, | | | |
| -- Cond RBTermChange | | | | |
| ... | | | | |
| } | | | | |
| MRB-ToAddModList-r17 ::= | SEQUENCE (SIZE (1..maxMRB-r17)) OF MRB-ToAddMod-r17 | | | |
| MRB-ToAddMod-r17 ::= | SEQUENCE { | | | |
| mbs-SessionId-r17 | TMGI-r17 | | | OPTIONAL, |
| -- Cond MRBSetup | | | | |
| mrb-Identity-r17 | | MRB-Identity-r17, | | |
| mrb-IdentityNew-r17 | MRB-Identity-r17 | | | OPTIONAL, |
| -- Need N | | | | |
| reestablishPDCP-r17 | ENUMERATED{true} | | | OPTIONAL, |
| -- Need N | | | | |
| recoverPDCP-r17 | ENUMERATED{true} | | | OPTIONAL, |
| -- Need N | | | | |
| pdcp-Config-r17 | PDCP-Config | | | OPTIONAL, |
| -- Cond PDCP | | | | |
| ... | | | | |
| } | | | | |
| MRB-ToReleaseList-r17 ::= | SEQUENCE (SIZE (1..maxMRB-r17)) OF MRB-Identity-r17 | | | |
| -- TAG-RADIOBEARERCONFIG-STOP | | | | |
| -- ASN1STOP | | | | |

DRB-ToAddMod and MRB-ToAddMod field descriptions

cnAssociation
Indicates if the bearer is associated with the eps-bearerIdentity (when connected to EPC) or sdap-
Config (when connected to 5GC).
daps-Config
Indicates that the bearer is configured as DAPS bearer.
drb-Identity
In case of DC, the DRB identity is unique within the scope of the UE, i.e. an MCG DRB cannot use
the same value as a split DRB. For a split DRB the same identity is used for the MCG and SCG parts
of the configuration.
eps-BearerIdentity
The EPS bearer ID determines the EPS bearer.
mbs-SessionId
Indicates which multicast MBS session the bearer is associated with.
mrb-Identity
Identification of the multicast MRB.
mrb-IdentityNew
New identity of the multicast MRB when mrb-Identity needs to be changed, e.g. as a result of a
handover.
reestablishPDCP
Indicates that PDCP should be re-established. Network sets this to true whenever the security key
used for this radio bearer changes. Key change could for example be due to termination point change
for the bearer, reconfiguration with sync, resuming an RRC connection, or the first reconfiguration
after reestablishment. It is also applicable for LTE procedures when NR PDCP is configured. Network
doesn't include this field for DRB if the bearer is configured as DAPS bearer.
recoverPDCP
Indicates that PDCP should perform recovery according to PDCP operations. Network doesn't
include this field if the bearer is configured as DAPS bearer or if the bearer is a SRB for AI/ML
functionality (e.g. SRBx or SRB5) and a DAPS bearer is configured. Network doesn't include this
field for SRBs except a SRB for AI/ML functionality (e.g. SRBx or SRB5). In other words, Network
can include this field for a SRB for AI/ML functionality (e.g. SRBx or SRB5), i.e. if the bearer is a SRB
and the SRB is a SRB for AI/ML functionality (e.g. SRBx or SRB5).
sdap-Config
The SDAP configuration determines how to map QoS flows to DRBs when NR or E-UTRA connects
to the 5GC and presence/absence of UL/DL SDAP headers.

### PDCP-Config

The IE PDCP-Config is used to set the configurable PDCP parameters for signalling, MBS multicast and data radio bearers.

### PDCP-Config Information Element

-- ASN1START
-- TAG-PDCP-CONFIG-START

| PDCP-Config ::= | SEQUENCE { | | | | | | | |
|---|---|---|---|---|---|---|---|---|
| drb | | SEQUENCE { | | | | | | |
| discardTimer | | | ENUMERATED {ms10, ms20, ms30, ms40, ms50, ms60, ms75, ms100, | | | | | |
| ms150, ms200, | | | | | | | | |
| | | | | | | ms250, ms300, ms500, ms750, ms1500, infinity} | | |
| OPTIONAL, -- Cond Setup | | | | | | | | |
| pdcp-SN-SizeUL | | ENUMERATED {len12bits, len18bits} | | | | | | OPTIONAL, |
| -- Cond Setup1 | | | | | | | | |
| pdcp-SN-SizeDL | | ENUMERATED {len12bits, len18bits} | | | | | | OPTIONAL, |
| -- Cond Setup2 | | | | | | | | |
| headerCompression | | | CHOICE { | | | | | |
| notUsed | | | | NULL, | | | | |
| rohc | | | | SEQUENCE { | | | | |
| maxCID | | | | INTEGER (1..16383) | | | | DEFAULT |
| 15, | | | | | | | | |
| profiles | | | | | SEQUENCE ( | | | |
| profile0x0001 | | | | | | BOOLEAN, | | |
| profile0x0002 | | | | | | BOOLEAN, | | |
| profile0x0003 | | | | | | BOOLEAN, | | |
| profile0x0004 | | | | | | BOOLEAN, | | |
| profile0x0006 | | | | | | BOOLEAN, | | |
| profile0x0101 | | | | | | BOOLEAN, | | |
| profile0x0102 | | | | | | BOOLEAN, | | |
| profile0x0103 | | | | | | BOOLEAN, | | |
| profile0x0104 | | | | | | BOOLEAN | | |
| }, | | | | | | | | |
| drb-ContinueROHC | | | | | ENUMERATED { true } | | | OPTIONAL |
| -- Need N | | | | | | | | |
| }, | | | | | | | | |
| uplinkOnlyROHC | | | | SEQUENCE { | | | | |
| maxCID | | | | INTEGER (1..16383) | | | | DEFAULT |
| 15, | | | | | | | | |
| profiles | | | | | SEQUENCE { | | | |
| profile0x0006 | | | | | | BOOLEAN | | |
| }, | | | | | | | | |
| drb-ContinueROHC | | | | | ENUMERATED { true } | | | OPTIONAL |
| -- Need N | | | | | | | | |
| }, | | | | | | | | |
| ... | | | | | | | | |
| }, | | | | | | | | |
| integrityProtection | | | ENUMERATED { enabled } | | | | | OPTIONAL, |
| -- Cond ConnectedTo5GC1 | | | | | | | | |
| statusReportRequired | | | ENUMERATED { true } | | | | | OPTIONAL, |
| -- Cond Rlc-AM-UM | | | | | | | | |
| outOfOrderDelivery | | | ENUMERATED { true } | | | | | OPTIONAL |
| -- Need R | | | | | | | | |
| } | | | | | | | | OPTIONAL, |
| -- Cond DRB | | | | | | | | |
| moreThanOneRLC | | SEQUENCE { | | | | | | |
| primaryPath | | | SEQUENCE { | | | | | |
| cellGroup | | | CellGroupId | | | | | OPTIONAL, |
| -- Need R | | | | | | | | |
| logicalChannel | | | LogicalChannelIdentity | | | | | OPTIONAL |
| -- Need R | | | | | | | | |
| }, | | | | | | | | |
| ul-DataSplitThreshold | | | UL-DataSplitThreshold | | | | | OPTIONAL, |
| -- Cond SplitBearer | | | | | | | | |
| pdcp-Duplication | | | BOOLEAN | | | | | OPTIONAL |
| -- Need R | | | | | | | | |
| } | | | | | | | | OPTIONAL, |
| -- Cond MoreThanOneRLC | | | | | | | | |
| t-Reordering | | | ENUMERATED { | | | | | |
| | | | | ms0, msl, ms2, ms4, ms5, ms8, ms10, ms15, ms20, ms30, ms40, | | | | |
| | | | | ms50, ms60, ms80, ms100, ms120, ms140, ms160, ms180, ms200, | | | | |
| ms220, | | | | | | | | |
| | | | | ms240, ms260, ms280, ms300, ms500, ms750, ms1000, ms1250, | | | | |
| | | | | ms1500, ms1750, ms2000, ms2250, ms2500, ms2750, | | | | |
| | | | | ms3000, spare28, spare27, spare26, spare25, spare24, | | | | |
| | | | | spare23, spare22, spare21, spare20, | | | | |
| | | | | spare19, spare18, spare17, spare16, spare15, spare14, | | | | |
| | | | | spare13, spare12, spare11, spare10, spare09, | | | | |
| | | | | spare08, spare07, spare06, spare05, spare04, spare03, | | | | |
| | | | | spare02, spare01 } | | | | OPTIONAL, |
| -- Need S | | | | | | | | |
| ..., | | | | | | | | |
| [[ | | | | | | | | |
| cipheringDisabled | | ENUMERATED {true} | | | | | | OPTIONAL |
| -- Cond ConnectedTo5GC | | | | | | | | |
| ]], | | | | | | | | |
| [[ | | | | | | | | |
| discardTimerExt-r16 | | SetupRelease { DiscardTimerExt-r16 } | | | | | | OPTIONAL, |
| -- Cond DRB2 | | | | | | | | |
| moreThanTwoRLC-DRB-r16 | | SEQUENCE { | | | | | | |
| splitSecondaryPath-r16 | | | LogicalChannelIdentity | | | | | OPTIONAL, |
| -- Cond SplitBearer2 | | | | | | | | |
| duplicationState-r16 | | | SEQUENCE (SIZE (3) ) OF BOOLEAN | | | | | OPTIONAL |
| -- Need S | | | | | | | | |
| } | | | | | | | | OPTIONAL, |
| -- Cond MoreThanTwoRLC-DRB | | | | | | | | |
| ethernetHeaderCompression-r16 | | | | | SetupRelease { EthernetHeaderCompression-r16 } | | | |
| OPTIONAL -- Need M | | | | | | | | |
| ]], | | | | | | | | |
| [[ | | | | | | | | |
| survivalTimeStateSupport-r17 | | | | ENUMERATED {true} | | | | OPTIONAL, |
| -- Cond Drb-Duplication | | | | | | | | |
| uplinkDataCompression-r17 | | | | | | SetupRelease { UplinkDataCompression-r17 } | | |
| OPTIONAL, -- Cond Rlc-AM | | | | | | | | |
| discardTimerExt2-r17 | | | | | | | SetupRelease { DiscardTimerExt2-r17 } | |
| OPTIONAL, -- Need M | | | | | | | | |
| initialRX-DELIV-117 | | | BIT STRING (SIZE (32)) | | | | | OPTIONAL |
| -- Cond MRB-Initialization | | | | | | | | |
| ]] | | | | | | | | |
| } | | | | | | | | |
| EthernetHeaderCompression-r16 ::= | | | | SEQUENCE { | | | | |
| ehc-Common-r16 | | | | | SEQUENCE { | | | |
| ehc-CID-Length-r16 | | | | | | ENUMERATED { bits7, bits15 }, | | |
| ... | | | | | | | | |
| }, | | | | | | | | |
| ehc-Downlink-r16 | | | | SEQUENCE { | | | | |
| drb-ContinueEHC-DL-r16 | | | | ENUMERATED { true } | | | | OPTIONAL, |
| -- Need N | | | | | | | | |
| ... | | | | | | | | |
| } | | | | | | | | OPTIONAL, |
| -- Need M | | | | | | | | |
| ehc-Uplink-r16 | | | | SEQUENCE { | | | | |
| maxCID-EHC-UL-r16 | | | | | INTEGER (1..32767), | | | |
| drb-ContinueEHC-UL-r16 | | | | ENUMERATED { true } | | | | OPTIONAL, |
| -- Need N | | | | | | | | |
| ... | | | | | | | | |
| } | | | | | | | | OPTIONAL |
| -- Need M | | | | | | | | |
| } | | | | | | | | |
| UL-DataSplitThreshold ::= ENUMERATED { | | | | | | | | |
| | | | | | | b0, b100, b200, b400, b800, b1600, b3200, b6400, | | |
| b12800, b25600, b51200, b102400, b204800, | | | | | | | | |
| | | | | | | b409600, b819200, b1228800, b1638400, b2457600, | | |
| b3276800, b4096000, b4915200, b5734400, | | | | | | | | |
| | | | | | | b6553600, infinity, spare8, spare7, spare6, spare5, | | |
| spare4, spare3, spare2, spare1} | | | | | | | | |
| DiscardTimerExt-r16 ::= ENUMERATED {ms0dot5, ms1, ms2, ms4, ms6, ms8, spare2, spare1) | | | | | | | | |
| DiscardTimerExt2-r17 ::= ENUMERATED (ms2000, spare3, spare2, spare1} | | | | | | | | |
| UplinkDataCompression-r17 ::= CHOICE { | | | | | | | | |
| newSetup | | | SEQUENCE { | | | | | |
| bufferSize-r17 | | | | ENUMERATED {kbyte2, kbyte4, kbyte8, spare1}, | | | | |
| dictionary-r17 | | | ENUMERATED {sip-SDP, operator} | | | | | OPTIONAL |
| -- Need N | | | | | | | | |
| }, | | | | | | | | |
| drb-ContinueUDC | | NULL | | | | | | |
| } | | | | | | | | |
| -- TAG-PDCP-CONFIG-STOP | | | | | | | | |
| -- ASN1STOP | | | | | | | | |

PDCP-Config field descriptions

cipheringDisabled
If included, ciphering is disabled for this DRB regardless of which ciphering algorithm is configured
for the SRB/DRBs. The field may only be included if the UE is connected to 5GC. Otherwise the field
is absent. The network configures all DRBs with the same PDU-session ID with same value for this
field. The value for this field cannot be changed after the DRB is set up.
IntegrityProtectionDisabled
If included, ciphering is disabled for this DRB or SRB regardless of which ciphering algorithm is
configured for the SRB or DRBs. Otherwise the field is absent. The network configures all DRBs or
SRBs with the same PDU-session ID with same value for this field. The value for this field cannot be
changed after the DRB or SRB is set up.
discardTimer
Value in ms of discardTimer specified in TS 38.323 [5]. Value ms10 corresponds to 10 ms, value
ms20 corresponds to 20 ms and so on. The value for this field cannot be changed in case of
reconfiguration with sync, if the bearer is configured as DAPS bearer.
discardTimerExt
Value in ms of discardTimer specified in TS 38.323 [5]. Value ms0dot5 corresponds to 0.5 ms, value
ms1 corresponds to 1 ms and so on. If this field is present, the field discardTimer is ignored and
discardTimerExt is used instead.
discardTimerExt2
Value in ms of discardTimerExt specified in TS 38.323 [5]. Value ms2000 corresponds to 2000 ms.
If this field is present, the field discardTimer and discardTimerExt are ignored and discardTimerExt2
is used instead.
drb-ContinueROHC
Indicates whether the PDCP entity continues or resets the ROHC header compression protocol
during PDCP re-establishment, as specified in TS 38.323 [5]. This field is configured only in case of
resuming an RRC connection or reconfiguration with sync, where the PDCP termination point is not
changed and the fullConfig is not indicated. The network does not include the field if the bearer is
configured as DAPS bearer. This field can be configured for both DRB and multicast MRB.
duplicationState
This field indicates the uplink PDCP duplication state for the associated RLC entities at the time of
receiving this IE. If set to true, the PDCP duplication state is activated for the associated RLC entity.
The index for the indication is determined by ascending order of logical channel ID of all RLC entities
other than the primary RLC entity indicated by primaryPath in the order of MCG and SCG, as in
clause 6.1.3.32 of TS 38.321 [3]. If the number of associated RLC entities other than the primary
RLC entity is two, UE ignores the value in the largest index of this field. If the field is absent, the
PDCP duplication states are deactivated for all associated RLC entities.
ethernetHeaderCompression
This fields configures Ethernet Header Compression. This field can only be configured for a bi-
directional DRB or a bi-directional multicast MRB. The network reconfigures
ethernetHeaderCompression only upon reconfiguration involving PDCP re-establishment and with
neither drb-ContinueEHC-DL nor drb-ContinueEHC-UL configured. Network only configures this field
when uplinkDataCompression is not configured.
headerCompression
If rohc is configured, the UE shall apply the configured ROHC profile(s) in both uplink and downlink.
If uplinkOnlyROHC is configured, the UE shall apply the configured ROHC profile(s) in uplink (there
is no header compression in downlink). ROHC can be configured for any bearer type. ROHC and
EHC can be both configured simultaneously for a DRB or a multicast MRB. The network reconfigures
headerCompression only upon reconfiguration involving PDCP re-establishment or involving PDCP
entity reconfiguration to configure DAPS bearer(s), and without any drb-ContinueROHC. Network
configures headerCompression to notUsed when outOfOrderDelivery is configured. Network only
configures this field when uplinkDataCompression is not configured.
initialRX-DELIV
Indicates the initial value of RX_DELIV during PDCP window initialization for multicast MRB as
specified in TS 38.323 [5].
integrityProtection
Indicates whether or not integrity protection is configured for this radio bearer. The network configures
all DRBs with the same PDU-session ID with same value for this field. The value for this field cannot
be changed after the DRB is set up.
maxCID
Indicates the value of the MAX_CID parameter as specified in TS 38.323 [5].
The total value of MAX_CIDs across all bearers for the UE should be less than or equal to the value
of maxNumberROHC-ContextSessions parameter as indicated by the UE.
moreThanOneRLC
This field configures UL data transmission when more than one RLC entity is associated with the
PDCP entity. This field is not present if the bearer is configured as DAPS bearer.
moreThanTwoRLC-DRB
This field configures UL data transmission when more than two RLC entities are associated with the
PDCP entity for DRBs.
outOfOrderDelivery
Indicates whether or not outOfOrderDelivery specified in TS 38.323 [5] is configured. This field should
be either always present or always absent, after the radio bearer is established.
pdcp-Duplication
Indicates whether or not uplink duplication status at the time of receiving this IE is configured and
activated as specified in TS 38.323 [5]. The presence of this field indicates that duplication is
configured. PDCP duplication is not configured for CA packet duplication of LTE RLC bearer. The
value of this field, when the field is present, indicates the state of the duplication at the time of
receiving this IE. If set to true, duplication is activated. The value of this field is always true, when
configured for a SRB. For PDCP entity with more than two associated RLC entities for UL
transmission, this field is always present. If the field moreThanTwoRLC-DRB is present, the value of
this field is ignored and the state of the duplication is indicated by duplicationState. For PDCP entity
with more than two associated RLC entities, only NR RLC bearer is supported. In another
embodiment, the value of this field is always true, when configured for a SRB except a SRB for AI/ML
functionality (e.g. SRBx or SRB5)
primaryPath
Indicates the cell group ID and LCID of the primary RLC entity as specified in TS 38.323 [5], clause
5.2.1 for UL data transmission when more than one RLC entity is associated with the PDCP entity.
In this version of the specification, only cell group ID corresponding to MCG is supported for SRBs,
except for the split SRB2 of the IAB-MT, and, when the SCG is deactivated, for DRBs. The NW
indicates cellGroup for split bearers using logical channels in different cell groups. The NW always
indicates logicalChannel if CA based PDCP duplication is configured in the cell group indicated by
cellGroup of this field.
splitSecondaryPath
Indicates the LCID of the split secondary RLC entity as specified in TS 38.323 [5] for fallback to split
bearer operation when UL data transmission with more than two RLC entities is associated with the
PDCP entity. This RLC entity belongs to a cell group that is different from the cell group indicated by
cellGroup in the field primaryPath.
statusReportRequired
For AM DRBs, AM MRBs and DAPS UM DRBs, indicates whether the DRB or the multicast MRB is
configured to send a PDCP status report in the uplink, as specified in TS 38.323 [5]. For DAPS AM
DRBs, it also indicates whether the DRB is configured to send a second PDCP status report in the
uplink, as specified in TS 38.323 [5]. For a SRB for AI/ML functionality (e.g. SRBx or SRB5), it
indicates whether the SRB is configured to send a PDCP status report in the uplink, as specified in
Section 8.1.2.3.
t-Reordering
Value in ms of t-Reordering specified in TS 38.323 [5]. Value ms0 corresponds to 0 ms, value ms20
corresponds to 20 ms, value ms40 corresponds to 40 ms, and so on. When the field is absent the
UE applies the value infinity. The value for this field cannot be changed in case of reconfiguration
with sync, if the bearer is configured as DAPS bearer.
ul-DataSplitThreshold
Parameter specified in TS 38.323 [5]. Value b0 corresponds to 0 bytes, value b100 corresponds to
100 bytes, value b200 corresponds to 200 bytes, and so on. The network sets this field to infinity for
UEs not supporting splitDRB-withUL-Both-MCG-SCG and when the SCG is deactivated. If the field
is absent when the split bearer is configured for the radio bearer first time, then the default value
infinity is applied.
uplinkDataCompression
Indicates the UDC configuration that the UE shall apply. Network does not configure
uplinkDataCompression for a DRB, if headerCompression or ethernetHeaderCompression is already
configured or outOfOrderDelivery or DAPS is configured for the DRB. The maximum number of DRBs
where uplinkDataCompression can be applied is two. The network reconfigures
uplinkDataCompression only upon reconfiguration involving PDCP re-establishment. If the field is set
to drb-ContinueUDC, the PDCP entity continues the uplink data compression protocol during PDCP
re-establishment, as specified in TS 38.323 [5]. The field is set to drb-ContinueUDC only in case of
resuming an RRC connection or reconfiguration with sync, where the PDCP termination point is not
changed and the fullConfig is not indicated.

EthernetHeaderCompression field descriptions

drb-ContinueEHC-DL
Indicates whether the PDCP entity continues or resets the downlink EHC header compression
protocol during PDCP re-establishment, as specified in TS 38.323 [5]. The field is configured only in
case of resuming an RRC connection or reconfiguration with sync, where the PDCP termination point
is not changed and the fullConfig is not indicated.
drb-ContinueEHC-UL
Indicates whether the PDCP entity continues or resets the uplink EHC header compression protocol
during PDCP re-establishment, as specified in TS 38.323 [5]. The field is configured only in case of
resuming an RRC connection or reconfiguration with sync, where the PDCP termination point is not
changed and the fullConfig is not indicated.
ehc-CID-Length
Indicates the length of the CID field for EHC packet. The value bits7 indicates the length is 7 bits,
and the value bits15 indicates the length is 15 bits. Once the field ethernetHeaderCompression-r16
is configured for a DRB or a multicast MRB, the value of the field ehc-CID-Length for this DRB or
multicast MRB is not reconfigured to a different value.
ehc-Common
Indicates the configurations that apply for both downlink and uplink.
ehc-Downlink
Indicates the configurations that apply for only downlink. If the field is configured, then Ethernet
header compression is configured for downlink. Otherwise, it is not configured for downlink.
ehc-Uplink
Indicates the configurations that apply for only uplink. If the field is configured, then Ethernet header
compression is configured for uplnik. Otherwise, it is not configured for uplink.
maxCID-EHC-UL
Indicates the value of the MAX_CID_EHC_UL parameter as specified in TS 38.323 [5]. The total
value of MAX_CID_EHC_UL across all bearers for the UE should be less than or equal to the value
of maxNumberEHC-Contexts parameter as indicated by the UE.

UplinkDataCompression field descriptions

bufferSize
This field indicates the buffer size applied for UDC as specified in TS 38.323 [5]. Value kbyte2 means
2048 bytes, kbyte4 means 4096 bytes and so on.
dictionary
This field indicates which pre-defined dictionary is used for UDC as specified in TS 38.323 [5]. The
value sip-SDP means that UE shall prefill the buffer with standard dictionary for SIP and SDP defined
in TS 38.323 [5], and the value operator means that UE shall prefill the buffer with operator-defined
dictionary.

| Conditional | |
|---|---|
| presence | Explanation |
| DRB | This field is mandatory present when the corresponding DRB/multicast MRB |
| | is being set up, absent for SRBs. Otherwise this field is optionally present, |
| | need M. |
| DRB2 | This field is optionally present in case of DRB, need M. Otherwise, it is absent |
| | for SRBs and MRBs. |
| Drb-Duplication | For SRBs, this field is absent. For DRBs, this field is absent if duplication is |
| | not configured. Otherwise, this field is optional, need R. |
| MoreThanOneRLC | This field is mandatory present upon RRC reconfiguration with setup of a |
| | PDCP entity for a radio bearer with more than one associated logical channel |
| | and upon RRC reconfiguration with the association of additional logical |
| | channels to the PDCP entity. |
| | The field is also mandatory present in case the field moreThanTwoRLC-DRB |
| | is included in PDCP-ConFIGURE |
| | Upon RRC reconfiguration when a PDCP entity is associated with multiple |
| | logical channels, this field is optionally present need M. Otherwise, this field is |
| | absent. Need R. |
| MoreThanTwoRLC- | For SRBs, this field is absent. |
| DRB | For DRBs, this field is mandatory present upon RRC reconfiguration with setup |
| | of a PDCP entity for a radio bearer with more than two associated logical |
| | channels and upon RRC reconfiguration with the association of one or more |
| | additional logical channel(s) to the PDCP entity so that the PDCP entity has |
| | more than two associated logical channels. |
| | Upon RRC reconfiguration when a PDCP entity is associated with more than |
| | two logical channels, this field is optionally present, Need M. Otherwise, the |
| | field is absent, Need R. |
| Rlc-AM | For RLC AM, the field is optionally present, need M. Otherwise, the field is |
| | absent. |
| Rlc-AM-UM | In case of DRB, for RLC UM (if the UE supports DAPS handover) or RLC AM, |
| | the field is optionally present, need R. In case of multicast MRB, if multicast |
| | MRB is associated with at least one RLC AM entity, the field is optionally |
| | present, need R. In case of a SRB for AI/ML functionality (e.g. SRBx or SRB5), |
| | for RLC AM, the field is optionally present, need R. Otherwise, the field is |
| | absent. |
| Setup | The field is mandatory present in case of SRB or DRB setup. Otherwise the |
| | field is optionally present, need M. |
| DRB | This field is mandatory present when the corresponding DRB/multicast MRB |
| | is being set up, absent for SRBs. Otherwise this field is optionally present, |
| | need M. |
| DRB2 | This field is optionally present in case of DRB, need M. Otherwise, it is absent |
| | for SRBs and MRBs. |
| SplitBearer | The field is absent for SRBs. Otherwise, the field is optional present, need M, |
| | in case of radio bearer with more than one associated RLC mapped to different |
| | cell groups. |
| SplitBearer2 | The field is mandatory present, in case of a split bearer. Otherwise the field is |
| | absent. |
| ConnectedTo5GC | The field is optionally present, need R, if the UE is connected to 5GC. |
| | Otherwise the field is absent. |
| ConnectedTo5GC1 | The field is optionally present, need R, if the UE is connected to NR/5GC or if |
| | the UE supports user plane integrity protection when connected to E- |
| | UTRA/EPC (as specified in TS 33.401 [30]). Otherwise the field is absent. |
| Setup1 | This field is mandatory present in case of SRB and DRB setup for RLC-AM |
| | and RLC-UM. Otherwise, this field is absent, Need M. |
| Setup2 | This field is mandatory present in case for radio bearer setup for RLC-AM and |
| | RLC-UM. Otherwise, this field is absent, Need M. |
| MRB-Initialization | This field is mandatory present in case of multicast MRB setup and PDCP re- |
| | establishment for UM multicast MRB. Otherwise, this field is absent, Need N. |

The following relates to SRB addition or modification.

RRC managed handovers with PDCP entity re-establishment (inter-gNB handover) or without PDCP entity re-establishment (intra-gNB handover) or with PDCP data recovery (intra-gNB handover) can be supported for a SRB for AI/ML functionality (e.g. SRBx or SRB5) based on reestablishPDCP or recoverPDCP indicators as follows:

The UE shall:
1> If any DAPS bearer is configured, for each SRB:
2> establish a PDCP entity for the target cell group, with the same configuration as the PDCP entity for the source cell group;
2> if the masterKeyUpdate is received:
3> configure the PDCP entity with the security algorithms according to securityConfig and apply the keys (KRRCenc and KRRCint) associated with the master key (KgNB);
2> else:
3> configure the PDCP entity for the target cell group with state variables continuation as specified, and with the same security configuration as the PDCP entity for the source cell group;
1> for each srb-Identity value included in the srb-ToAddModList that is not part of the current UE configuration (SRB establishment or reconfiguration from E-UTRA PDCP to NR PDCP):
2> establish a PDCP entity;
2> if AS security has been activated:
3> if target RAT of handover is E-UTRA/5GC; or
3> if the UE is connected to E-UTRA/5GC:
4> if the UE is capable of E-UTRA/5GC, but not capable of NGEN-DC:
5> configure the PDCP entity with the security algorithms and keys (KRRCenc and KRRCint) configured/derived;
4> else (i.e., UE capable of NGEN-DC):
5> configure the PDCP entity with the security algorithms according to securityConfig and apply the keys (KRRCenc and KRRCint) associated with the master key (KeNB) or secondary key (S-KgNB) as indicated in keyToUse, if applicable;
3> else (i.e., UE connected to NR or UE connected to E-UTRA/EPC):
4> configure the PDCP entity with the security algorithms according to securityConfig and apply the keys (KRRCenc and KRRCint) associated with the master key (KeNB/KgNB) or secondary key (S-KgNB) as indicated in keyToUse, if applicable;
2> if the current UE configuration as configured by E-UTRA includes an SRB identified with the same srb-Identity value:
3> associate the E-UTRA RLC entity and DCCH of this SRB with the NR PDCP entity;
3> release the E-UTRA PDCP entity of this SRB;
2> if the pdcp-Config is included:
3> configure the PDCP entity in accordance with the received pdcp-Config;
2> else:
3> configure the PDCP entity in accordance with the default configuration defined in

9.2.1 for the corresponding SRB;
1> if any DAPS bearer is configured, for each srb-Identity value included in the srb-ToAddModList that is part of the current UE configuration: 2> if the pdcp-Config is included:
3> reconfigure the PDCP entity for the target cell group in accordance with the received pdcp-Config;
1> else, for each srb-Identity value included in the srb-ToAddModList that is part of the current UE configuration:
2> if the reestablishPDCP is set:
3> if target RAT of handover is E-UTRA/5GC; or
3> if the UE is connected to E-UTRA/5GC:
4> if the UE is capable of E-UTRA/5GC, but not capable of NGEN-DC:
5> configure the PDCP entity to apply the integrity protection algorithm and KRRCint key configured/derived, i.e. the integrity protection configuration shall be applied to all subsequent messages received and sent by the UE, including the message used to indicate the successful completion of the procedure;
5> configure the PDCP entity to apply the ciphering algorithm and KRRCenc key configured/derived, i.e. the ciphering configuration shall be applied to all subsequent messages received and sent by the UE, including the message used to indicate the successful completion of the procedure;
4> else (i.e., a UE capable of NGEN-DC):
5> configure the PDCP entity to apply the integrity protection algorithm and KRRCint key associated with the master key (KeNB) or secondary key (S-KgNB), as indicated in keyToUse, i.e. the integrity protection configuration shall be applied to all subsequent messages received and sent by the UE, including the message used to indicate the successful completion of the procedure;
5> configure the PDCP entity to apply the ciphering algorithm and KRRCenc key associated with the master key (KeNB) or secondary key (S-KgNB) as indicated in keyToUse, i.e. the ciphering configuration shall be applied to all subsequent messages received and sent by the UE, including the message used to indicate the successful completion of the procedure;
3> else (i.e., UE connected to NR or UE in EN-DC):
4> configure the PDCP entity to apply the integrity protection algorithm and KRRCint key associated with the master key (KeNB/KgNB) or secondary key (S-KgNB), as indicated in keyToUse, i.e. the integrity protection configuration shall be applied to all subsequent messages received and sent by the UE, including the message used to indicate the successful completion of the procedure;
4> configure the PDCP entity to apply the ciphering algorithm and KRRCenc key associated with the master key (KeNB/KgNB) or secondary key (S-KgNB) as indicated in keyToUse, i.e. the ciphering configuration shall be applied to all subsequent messages received and sent by the UE, including the message used to indicate the successful completion of the procedure;
3> re-establish the PDCP entity of this SRB as specified in Section 8.1.2.3;
2> else, if the recoverPDCP is set:
3> trigger the PDCP entity of this SRB to perform data recovery as specified in Section 8.1.2.3;
2> else, if the discardOnPDCP is set:
3> trigger the PDCP entity to perform SDU discard;
2> if the pdcp-Config is included:
3> reconfigure the PDCP entity in accordance with the received pdcp-Config.

The following relates to DRB (for AI/ML functionality) addition/modification.

The UE shall:
1> for each drb-Identity value included in the drb-ToAddModList that is not part of the current UE configuration (DRB establishment including the case when full configuration option is used):
2> establish a PDCP entity and configure it in accordance with the received pdcp-Config;
2> if the PDCP entity of this DRB is not configured with cipheringDisabled:
3> if target RAT of handover is E-UTRA/5GC; or
3> if the UE is connected to E-UTRA/5GC:
4> if the UE is capable of E-UTRA/5GC but not capable of NGEN-DC:
5> configure the PDCP entity with the ciphering algorithm and KUPenc key configured/derived as specified in TS 36.331 [10];
4> else (i.e., a UE capable of NGEN-DC):
5> configure the PDCP entity with the ciphering algorithms according to securityConfig and apply the key (KUPenc) associated with the master key (KeNB) or secondary key (S-KgNB) as indicated in keyToUse, if applicable;
3> else (i.e., UE connected to NR or UE connected to E-UTRA/EPC):
4> configure the PDCP entity with the ciphering algorithms according to securityConfig and apply the KUPenc key associated with the master key (KeNB/KgNB) or the secondary key (S-KgNB/S-KeNB) as indicated in keyToUse;
2> if the PDCP entity of this DRB is configured with integrityProtection:
3> configure the PDCP entity with the integrity protection algorithms according to securityConfig and apply the KUPint key associated with the master (KeNB/KgNB) or the secondary key (S-KgNB) as indicated in keyToUse;
2> if an sdap-Config is included:
3> if an SDAP entity with the received pdu-Session does not exist:
4> establish an SDAP entity as specified in TS 37.324 clause 5.1.1;
4> if an SDAP entity with the received pdu-Session did not exist prior to receiving this reconfiguration:
5> indicate the establishment of the user plane resources for the pdu-Session to upper layers;
3> configure the SDAP entity in accordance with the received sdap-Config as specified in TS 37.324 and associate the DRB with the SDAP entity;
3> for each QFI value added in mappedQoS-FlowsToAdd, if the QFI value is previously configured, the QFI value is released from the old DRB;
2> if the DRB is associated with an eps-BearerIdentity:
3> if the DRB was configured with the same eps-BearerIdentity either by NR or E-UTRA prior to receiving this reconfiguration:
4> associate the established DRB with the corresponding eps-BearerIdentity;
3> else:
4> indicate the establishment of the DRB(s) and the eps-BearerIdentity of the established DRB(s) to upper layers;
1> for each drb-Identity value included in the drb-ToAddModList that is part of the current UE configuration and configured as DAPS bearer:
2> reconfigure the PDCP entity to configure DAPS with the ciphering function, integrity protection function and ROHC function of the target cell group as specified in TS 38.323 [5] and configure it in accordance with the received pdcp-Config;
2> if the masterKeyUpdate is received:
3> if the ciphering function of the target cell group PDCP entity is not configured with cipheringDisabled:
4> configure the ciphering function of the target cell group PDCP entity with the ciphering algorithm according to securityConfig and apply the KUPenc key associated with the master key (KgNB), as indicated in keyToUse, i.e. the ciphering configuration shall be applied to all subsequent PDCP PDUs received from the target cell group and sent to the target cell group by the UE;
3> if the integrity protection function of the target cell group PDCP entity is configured with integrityProtection:
4> configure the integrity protection function of the target cell group PDCP entity with the integrity protection algorithms according to securityConfig and apply the KUPint key associated with the master key (KgNB) as indicated in keyToUse;
2> else:
3> configure the ciphering function and the integrity protection function of the target cell group PDCP entity with the same security configuration as the PDCP entity for the source cell group;
2> if the sdap-Config is included and when indication of successful completion of random access towards target cell is received from lower layers as specified in [3]:
3> reconfigure the SDAP entity in accordance with the received sdap-Config as specified in TS 37.324 [24];
3> for each QFI value added in mappedQoS-FlowsToAdd, if the QFI value is previously configured, the QFI value is released from the old DRB;
1> for each drb-Identity value included in the drb-ToAddModList that is part of the current UE configuration and not configured as DAPS bearer:
2> if the reestablishPDCP is set:
3> if target RAT of handover is E-UTRA/5GC; or
3> if the UE is connected to E-UTRA/5GC:
4> if the UE is capable of E-UTRA/5GC but not capable of NGEN-DC:
5> if the PDCP entity of this DRB is not configured with cipheringDisabled:
6> configure the PDCP entity with the ciphering algorithm and KUPenc key configured/derived as specified in TS 36.331 [10], clause 5.4.2.3, i.e. the ciphering configuration shall be applied to all subsequent PDCP PDUs received and sent by the UE;
4> else (i.e., a UE capable of NGEN-DC):
5> if the PDCP entity of this DRB is not configured with cipheringDisabled:
6> configure the PDCP entity with the ciphering algorithm and KUPenc key associated with the master key (KeNB) or the secondary key (S-KgNB), as indicated in keyToUse, i.e. the ciphering configuration shall be applied to all subsequent PDCP PDUs received and sent by the UE;
3> else (i.e., UE connected to NR or UE connected to E-UTRA/EPC (in EN-DC or capable of EN-DC)):
4> if the PDCP entity of this DRB is not configured with cipheringDisabled:
5> configure the PDCP entity with the ciphering algorithm and KUPenc key associated with the master key (KeNB/KgNB) or the secondary key (S-KgNB/S-KeNB), as indicated in keyToUse, i.e. the ciphering configuration shall be applied to all subsequent PDCP PDUs received and sent by the UE;
4> if the PDCP entity of this DRB is configured with integrityProtection:
5> configure the PDCP entity with the integrity protection algorithms according to securityConfig and apply the KUPint key associated with the master key (KeNB/KgNB) or the secondary key (S-KgNB) as indicated in keyToUse;
3> if drb-ContinueROHC is included in pdcp-Config:
4> indicate to lower layer that drb-ContinueROHC is configured;
3> if drb-ContinueEHC-DL is included in pdcp-Config:
4> indicate to lower layer that drb-ContinueEHC-DL is configured;
3> if drb-ContinueEHC-UL is included in pdcp-Config:
4> indicate to lower layer that drb-ContinueEHC-UL is configured;
3> if drb-ContinueUDC is included in pdcp-Config:
4> indicate to lower layer that drb-ContinueUDC is configured; 3> re-establish the PDCP entity of this DRB as specified in TS 38.323 [5], clause 5.1.2;
2> else, if the recoverPDCP is set:
3> trigger the PDCP entity of this DRB to perform data recovery as specified in TS 38.323 [5];
2> if the pdcp-Config is included:
3> reconfigure the PDCP entity in accordance with the received pdcp-Config.
2> if the sdap-Config is included:
3> reconfigure the SDAP entity in accordance with the received sdap-Config as specified in TS37.324 [24];
3> for each QFI value added in mappedQoS-FlowsToAdd, if the QFI value is previously configured, the QFI value is released from the old DRB.

The following relates to PDCP entity re-establishment. When upper layers (e.g. RRC layer or RRC entity upon the reception of RRC messages) request a PDCP entity re-establishment, the UE shall additionally perform once the procedures described in this clause for Uu or PC5 interface. After performing the procedures in this clause, the UE shall follow the normal PDCP procedures.

When upper layers request a PDCP entity re-establishment, the transmitting PDCP entity shall:
for UM DRBs and AM DRBs, reset the ROHC protocol for uplink and start with an IR state in U-mode (as defined in RFC 3095 [8] and RFC 4815 [9]) if drb-ContinueROHC is not configured in TS 38.331 [3];
for UM DRBs and AM DRBs, reset the EHC protocol for uplink if drb-ContinueEHC-UL is not configured in TS 38.331 [3];
for AM DRBs, reset the UDC compression buffer to all zeros and prefill the dictionary if drb-ContinueUDC is not configured in TS 38.331 [3];
for SRBs except a SRB for AI/ML functionality (e.g. SRBx or SRB5) and UM DRBs, set TX_NEXT to the initial value;
for SRBs except a SRB for AI/ML functionality (e.g. SRBx or SRB5), discard all stored PDCP SDUs and PDCP PDUs;
apply the ciphering algorithm and key provided by upper layers during the PDCP entity re-establishment procedure;
apply the integrity protection algorithm and key provided by upper layers during the PDCP entity re-establishment procedure;
for a SRB for AI/ML functionality (e.g. SRBx or SRB5), from the first PDCP SDU for which the successful delivery of the corresponding PDCP Data PDU has not been confirmed by lower layers, perform retransmission or transmission of all the PDCP SDUs already associated with PDCP SNs in ascending order of the COUNT values associated to the PDCP SDU prior to the PDCP entity re-establishment as specified below:
perform integrity protection and ciphering of the PDCP SDU using the COUNT value associated with this PDCP SDU (if integrity protection or cipherin is configured);
submit the resulting PDCP Data PDU to lower layer, as specified in clause 5.2.1.
for UM DRBs, for each PDCP SDU already associated with a PDCP SN but for which a corresponding PDU has not previously been submitted to lower layers, and;
for AM DRBs for Uu interface whose PDCP entities were suspended, from the first PDCP SDU for which the successful delivery of the corresponding PDCP Data PDU has not been confirmed by lower layers, for each PDCP SDU already associated with a PDCP SN:
consider the PDCP SDUs as received from upper layer;
perform transmission of the PDCP SDUs in ascending order of the COUNT value associated to the PDCP SDU prior to the PDCP re-establishment without restarting the discardTimer, as specified in clause 5.2.1;
For a SRB for AI/ML functionality (e.g. SRBx or SRB5) or for AM DRBs whose PDCP entities were not suspended, from the first PDCP SDU for which the successful delivery of the corresponding PDCP Data PDU has not been confirmed by lower layers, perform retransmission or transmission of all the PDCP SDUs already associated with PDCP SNs in ascending order of the COUNT values associated to the PDCP SDU prior to the PDCP entity re-establishment as specified below:
perform header compression of the PDCP SDU using ROHC as specified in the clause 5.7.4 and/or using EHC as specified in the clause 5.12.4;
If drb-ContinueUDC is configured and if the PDCP SDU has been compressed before:
submit the PDCP SDU previously compressed to integrity protection and ciphering function;
else:
perform uplink data compression of the PDCP SDU as specified in clause 5.14.4, and submit the PDCP SDU to integrity protection and ciphering function;
perform integrity protection and ciphering of the PDCP SDU using the COUNT value associated with this PDCP SDU as specified in the clause 5.9 and 5.8;
submit the resulting PDCP Data PDU to lower layer, as specified in clause 5.2.1.

When upper layers request a PDCP entity re-establishment, the receiving PDCP entity shall:
process the PDCP Data PDUs that are received from lower layers due to the re-establishment of the lower layers, as specified in the clause 5.2.2.1;
for SRBs except a SRB for AI/ML functionality (e.g. SRBx or SRB5), discard all stored PDCP SDUs and PDCP PDUs;
for SRBs except a SRB for AI/ML functionality (e.g. SRBx or SRB5), UM DRBs and UM MRBs, if t-Reordering is running:
stop and reset t-Reordering;
for UM DRBs and UM MRBs, deliver all stored PDCP SDUs to the upper layers in ascending order of associated COUNT values after performing header decompression;
for AM DRBs and AM MRBs for Uu interface, perform header decompression using ROHC for all stored PDCP SDUs if drb-ContinueROHC is not configured in TS 38.331 [3];
for AM DRBs for PC5 interface, perform header decompression using ROHC for all stored PDCP IP SDUS;
for AM DRBs and AM MRBs for Uu interface, perform header decompression using EHC for all stored PDCP SDUs if drb-ContinueEHC-DL is not configured in TS 38.331 [3];
for UM DRBs, AM DRBs, UM MRBs and AM MRBs, reset the ROHC protocol for downlink and start with NC state in U-mode (as defined in RFC 3095 [8] and RFC 4815 [9]) if drb-ContinueROHC is not configured in TS 38.331 [3];
for UM DRBs, AM DRBs, UM MRBs and AM MRBs, reset the EHC protocol for downlink if drb-ContinueEHC-DL is not configured in TS 38.331 [3];
for SRBs except a SRB for AI/ML functionality (e.g. SRBx or SRB5) and UM DRBs, set RX_NEXT and RX_DELIV to the initial value;
for UM MRBs and AM MRBs, set RX_NEXT and RX_DELIV to the initial value if initialRX-DELIV is configured in TS 38.331 [3];
apply the ciphering algorithm and key provided by upper layers during the PDCP entity re-establishment procedure;
apply the integrity protection algorithm and key provided by upper layers during the PDCP entity re-establishment procedure.

The following relates to Data Recovery. When upper layers (e.g. RRC layer or RRC entity upon the reception of RRC messages) trigger a PDCP data recovery, the UE shall additionally perform once the procedures described in this clause for Uu or PC5 interface. After performing the procedures in this clause, the UE shall follow the normal PDCP procedures. The PDCP data recovery is not supported for SRBs except a SRB for AI/ML functionality (e.g. SRBx or SRB5).

For a SRB for AI/ML functionality (e.g. SRBx or SRB5), when upper layers request a PDCP data recovery for a radio bearer, the transmitting PDCP entity shall:
perform retransmission of all the PDCP Data PDUs previously submitted to reestablished or released AM RLC entities in ascending order of the associated COUNT values for which the successful delivery has not been confirmed by lower layers, following the data submission procedure.

After performing the above procedures, the transmitting PDCP entity shall follow the normal PDCP procedures.

In another embodiment, for AM DRBs and a SRB for AI/ML functionality (e.g. SRBx or SRB5), when upper layers request a PDCP data recovery for a radio bearer, the transmitting PDCP entity shall:
perform retransmission of all the PDCP Data PDUs previously submitted to reestablished or released AM RLC entities in ascending order of the associated COUNT values for which the successful delivery has not been confirmed by lower layers, following the data submission procedure.

After performing the above procedures, the transmitting PDCP entity shall follow the normal PDCP procedures.

The following relates to Status reporting-Transmit operation. For AM DRBs configured by upper layers to send a PDCP status report in the uplink (statusReportRequired in pdcp-config in RRC message), the receiving PDCP entity shall trigger a PDCP status report when:
upper layer requests a PDCP entity re-establishment;
upper layer requests a PDCP data recovery;
upper layer requests a uplink data switching;
upper layer reconfigures the PDCP entity to release DAPS and daps-SourceRelease is configured in TS 38.331 [3].

For a SRB for AI/ML functionality (e.g. SRBx or SRB5) configured by upper layers to send a PDCP status report in the uplink (statusReportRequired in pdcp-config in RRC message), the receiving PDCP entity shall trigger a PDCP status report when:
upper layer requests a PDCP entity re-establishment;
upper layer requests a PDCP data recovery;

For UM DRBs configured by upper layers to send a PDCP status report in the uplink (statusReportRequired in TS 38.331 [3]), the receiving PDCP entity shall trigger a PDCP status report when:
upper layer requests a uplink data switching.

For AM DRBs in the sidelink, the receiving PDCP entity shall trigger a PDCP status report when:
upper layer requests a PDCP entity re-establishment.

For AM MRBs configured by upper layers to send a PDCP status report in the uplink (statusReportRequired in TS 38.331 [3]), the receiving PDCP entity shall trigger a PDCP status report when:
upper layer requests a PDCP entity re-establishment;
upper layer requests a PDCP data recovery.

If a PDCP status report is triggered, the receiving PDCP entity shall:
compile a PDCP status report as indicated below by:
setting the FMC field to RX_DELIV;
if RX_DELIV<RX_NEXT:
allocating a Bitmap field of length in bits equal to the number of COUNTs from and not including the first missing PDCP SDU up to and including the last out-of-sequence PDCP SDUs, rounded up to the next multiple of 8, or up to and including a PDCP SDU for which the resulting PDCP Control PDU size is equal to 9000 bytes, whichever comes first;
setting in the bitmap field as ‘0’ for all PDCP SDUs that have not been received, and optionally PDCP SDUs for which decompression have failed;
setting in the bitmap field as ‘1’ for all PDCP SDUs that have been received;
submit the PDCP status report to lower layers as the first PDCP PDU for transmission via the transmitting PDCP entity as specified in clause 5.2.1 for Uu interface and in clause 5.2.3 for PC5 interface.

The following relates to Status reporting-Receive operation. For a SRB for AI/ML functionality (e.g. SRBx or SRB5), when a PDCP status report is received in the downlink or in the sidelink, the transmitting PDCP entity shall:
consider for each PDCP SDU, if any, with the bit in the bitmap set to ‘1’, or with the associated COUNT value less than the value of FMC field as successfully delivered, and discard the PDCP SDU as specified in clause 5.3.

In another embodiment, for a SRB for AI/ML functionality (e.g. SRBx or SRB5) and for AM DRBs, when a PDCP status report is received in the downlink or in the sidelink, the transmitting PDCP entity shall:
consider for each PDCP SDU, if any, with the bit in the bitmap set to ‘1’, or with the associated COUNT value less than the value of FMC field as successfully delivered, and discard the PDCP SDU as specified in clause 5.3.

The following relates to State variables. This clause describes the state variables used in PDCP entities in order to specify the PDCP protocol. The state variables defined in this clause are normative.

All state variables are non-negative integers, and take values from 0 to [232-1].

PDCP Data PDUs are numbered integer sequence numbers (SN) cycling through the field: 0 to [2[pdcp-SN-SizeUL]−1] or 0 to [2[pdcp-SN-SizeDL]−1] or 0 to [2[sl-PDCP-SN-Size]−1].

The transmitting PDCP entity shall maintain the following state variables:

### a) TX_NEXT

This state variable indicates the COUNT value of the next PDCP SDU to be transmitted. The initial value is 0, except for SRBs configured with state variables continuation. For target SRB configured with state variables continuation, the initial value is the value stored in PDCP entity for the corresponding source SRB. For source SRB configured with state variables continuation, the initial value is the value stored in PDCP entity for the corresponding target SRB.

In another embodiment not to support DAPS handover for a SRB for AI/ML functionality (e.g. SRBx or SRB5), this state variable indicates the COUNT value of the next PDCP SDU to be transmitted. The initial value is 0, except for SRBs configured with state variables continuation except a SRB for AI/ML functionality (e.g. SRBx or SRB5). For target SRB configured with state variables continuation, the initial value is the value stored in PDCP entity for the corresponding source SRB. For source SRB configured with state variables continuation, the initial value is the value stored in PDCP entity for the corresponding target SRB.

The receiving PDCP entity shall maintain the following state variables:

### a) RX_NEXT

This state variable indicates the COUNT value of the next PDCP SDU expected to be received. The initial value is 0, except for sidelink broadcast and groupcast, for SRBs configured with state variables continuation, and for broadcast MRBs. For NR sidelink communication for broadcast and groupcast or sidelink SRB4 for NR sidelink discovery, the initial value of the SN part of RX_NEXT is (x+1) modulo (2[sl-PDCPSN-Size]), where x is the SN of the first received PDCP Data PDU. For broadcast MRBs, the initial value of the SN part of RX_NEXT is (x+1) modulo (2[PDCP-SNSizeDL]), where x is the SN of the first received PDCP Data PDU. For target SRB configured with state variables continuation, the initial value is the value stored in PDCP entity for the corresponding source SRB. For source SRB configured with state variables continuation, the initial value is the value stored in PDCP entity for the corresponding target SRB.

In another embodiment not supporting DAPS handover for a SRB for AI/ML functionality (e.g. SRBx or SRB5), this state variable indicates the COUNT value of the next PDCP SDU expected to be received. The initial value is 0, except for sidelink broadcast and groupcast, for SRBs configured with state variables continuation except a SRB for AI/ML functionality (e.g. SRBx or SRB5), and for broadcast MRBs. For NR sidelink communication for broadcast and groupcast or sidelink SRB4 for NR sidelink discovery, the initial value of the SN part of RX_NEXT is (x+1) modulo (2[sl-PDCPSN-Size]), where x is the SN of the first received PDCP Data PDU. For broadcast MRBs, the initial value of the SN part of RX_NEXT is (x+1) modulo (2[PDCP-SNSizeDL]), where x is the SN of the first received PDCP Data PDU. For target SRB configured with state variables continuation, the initial value is the value stored in PDCP entity for the corresponding source SRB. For source SRB configured with state variables continuation, the initial value is the value stored in PDCP entity for the corresponding target SRB.

### b) RX_DELIV

This state variable indicates the COUNT value of the first PDCP SDU not delivered to the upper layers, but still waited for. The initial value is 0, except for sidelink broadcast and groupcast, for SRBs configured with state variables continuation, and for MRBs. For NR sidelink communication for broadcast and groupcast or sidelink SRB4 for NR sidelink discovery, the initial value of the SN part of RX_DELIV is (x−0.5×2[sl-PDCP-SN-Size−1]) modulo (2[sl-PDCP-SN-Size]), where x is the SN of the first received PDCP Data PDU. For broadcast MRBs, the initial value of the SN part of RX_DELIV is set to (x−0.5×2[PDCP-SN-SizeDL−1]) modulo (2[PDCPSN-SizeDL]), where x is the SN of the first received PDCP Data PDU. For multicast MRBs, the initial value of RX_DELIV is set, if provided, by initialRX-DELIV in TS 38.331 [3]. For target SRB configured with state variables continuation, the initial value is the value stored in PDCP entity for the corresponding source SRB. For source SRB configured with state variables continuation, the initial value is the value stored in PDCP entity for the corresponding target SRB.

In another embodiment not supporting DAPS handover for a SRB for AI/ML functionality (e.g. SRBx or SRB5), this state variable indicates the COUNT value of the first PDCP SDU not delivered to the upper layers, but still waited for. The initial value is 0, except for sidelink broadcast and groupcast, for SRBs configured with state variables continuation except a SRB for AI/ML functionality (e.g. SRBx or SRB5), and for MRBs. For NR sidelink communication for broadcast and groupcast or sidelink SRB4 for NR sidelink discovery, the initial value of the SN part of RX_DELIV is (x−0.5×2[sl-PDCP-SN-Size−1]) modulo (2[sl-PDCP-SN-Size]), where x is the SN of the first received PDCP Data PDU. For broadcast MRBs, the initial value of the SN part of RX_DELIV is set to (x−0.5×2[PDCP-SN-SizeDL−1]) modulo (2[PDCPSN-SizeDL]), where x is the SN of the first received PDCP Data PDU. For multicast MRBs, the initial value of RX_DELIV is set, if provided, by initialRX-DELIV in TS 38.331

### c) RX_REORD

This state variable indicates the COUNT value following the COUNT value associated with the PDCP Data PDU which triggered t-Reordering. For target SRB configured with state variables continuation, the initial value is the value stored in PDCP entity for the corresponding source SRB. For source SRB configured with state variables continuation, the initial value is the value stored in PDCP entity for the corresponding target SRB.

In another embodiment not supporting DAPS handover for a SRB for AI/ML functionality (e.g. SRBx or SRB5), this state variable indicates the COUNT value following the COUNT value associated with the PDCP Data PDU which triggered t-Reordering. For target SRB configured with state variables continuation except a SRB for AI/ML functionality (e.g. SRBx or SRB5), the initial value is the value stored in PDCP entity for the corresponding source SRB. For source SRB configured with state variables continuation except a SRB for AI/ML functionality (e.g. SRBx or SRB5), the initial value is the value stored in PDCP entity for the corresponding target SRB.

The following relates to ciphering/de-ciphering. The ciphering function includes both ciphering and deciphering and is performed in PDCP, if configured. The data unit that is ciphered is the MAC-I (see clause 6.3.4) and the data part of the PDCP Data PDU (see clause 6.3.3) except the SDAP header and the SDAP Control PDU if included in the PDCP SDU. The ciphering is not applicable to PDCP Control PDUs.

For downlink and uplink, the ciphering algorithm and key to be used by the PDCP entity are configured by upper layers TS 38.331 [3] and the ciphering method shall be applied as specified in TS 33.501 [6].

The ciphering function is activated/suspended/resumed by upper layers TS 38.331 [3]. When security is activated and not suspended, the ciphering function shall be applied to all PDCP Data PDUs indicated by upper layers TS 38.331 [3] for the downlink and the uplink, respectively.

The following relates to Integrity Protection and Verification. The integrity protection function includes both integrity protection and integrity verification and is performed in PDCP, if configured. The data unit that is integrity protected is the PDU header and the data part of the PDU before ciphering. The integrity protection is always applied to PDCP Data PDUs of SRBs. The integrity protection is applied to sidelink SRB1, SRB2 and SRB3.

In another embodiment, the integrity protection function includes both integrity protection and integrity verification and is performed in PDCP, if configured. The data unit that is integrity protected is the PDU header and the data part of the PDU before ciphering. The integrity protection is always applied to PDCP Data PDUs of SRBs except a SRB for AI/ML functionality (e.g. SRBx or SRB5). For a SRB for AI/ML functionality (e.g. SRBx or SRB5), the integrity protection function is activated/suspended/resumed by upper layers. The integrity protection is applied to sidelink SRB1, SRB2 and SRB3.

The following relates to MAC-I.

This field (Length: 32 bits) carries a message authentication code calculated as specified in clause 5.9.

For SRBs for Uu interface, the MAC-I field is always present. If integrity protection is not configured, the MAC-I field is still present but should be padded with padding bits set to 0.

In another embodiment, for SRBs except a SRB for AI/ML functionality (e.g. SRBx or SRB5) for Uu interface, the MAC-I field is always present. For a SRB for AI/ML functionality (e.g. SRBx or SRB5), if integrity protection is not configured, the MAC-I field is still present but should be padded with padding bits set to 0.

For sidelink SRB1, SRB2 and SRB3, the MAC-I field is present only when the sidelink SRB1, SRB2 and SRB3 are configured with integrity protection.

For DRBs (including sidelink DRBs for unicast), the MAC-I field is present only when the DRB is configured with integrity protection.

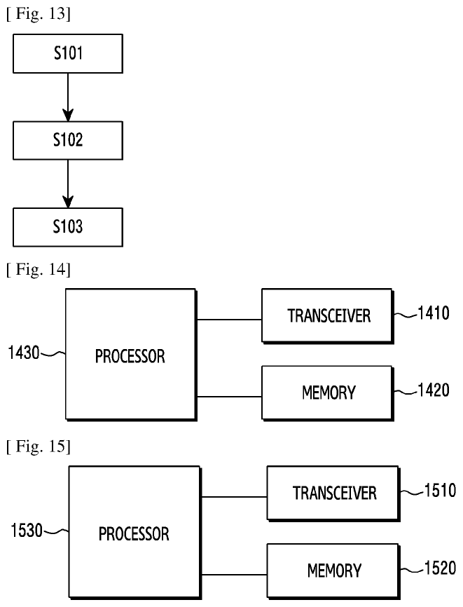

For the sake of completeness, FIG. 13 shows a flowchart illustrating an embodiment of the invention. It shows a method for performing a handover in a telecommunication system by a transmitting device.

Step S101 is receiving a reconfiguration message via a Signalling Radio Bearer, SRB, wherein the reconfiguration message includes a first indicator or a second indicator, wherein the first indicator triggers Packet Data Convergence Protocol, PDCP, re-establishment for the SRB and the second indicator triggers PDCP data recovery

S102 shows that PDCP re-establishment is triggered based on a first field for security key update being included in reconfiguration message.

S103 shows performing PDCP re-establishment or PDCP data recovery, respectively, for the SRB, based on the first indicator or the second indicator.

FIG. 14 illustrates a structure of a UE according to an embodiment of the disclosure.

As shown in FIG. 14, the UE according to an embodiment may include a transceiver 1410, a memory 1420, and a processor 1430. The transceiver 1410, the memory 1420, and the processor 1430 of the UE may operate according to a communication method of the UE described above. However, the components of the UE are not limited thereto. For example, the UE may include more or fewer components than those described above. In addition, the processor 1430, the transceiver 1410, and the memory 1420 may be implemented as a single chip. Also, the processor 1430 may include at least one processor. Furthermore, the UE of FIG. 14 corresponds to the FIGS. 1 to 13.

The transceiver 1410 collectively refers to a UE receiver and a UE transmitter, and may transmit/receive a signal to/from a base station or a network entity. The signal transmitted or received to or from the base station or a network entity may include control information and data. The transceiver 1410 may include a RF transmitter for up-converting and amplifying a frequency of a transmitted signal, and a RF receiver for amplifying low-noise and down-converting a frequency of a received signal. However, this is only an example of the transceiver 1410 and components of the transceiver 1410 are not limited to the RF transmitter and the RF receiver.

Also, the transceiver 1410 may receive and output, to the processor 1430, a signal through a wireless channel, and transmit a signal output from the processor 1430 through the wireless channel.

The memory 1420 may store a program and data required for operations of the UE. Also, the memory 1420 may store control information or data included in a signal obtained by the UE. The memory 1420 may be a storage medium, such as read-only memory (ROM), random access memory (RAM), a hard disk, a CD-ROM, and a DVD, or a combination of storage media.

The processor 1430 may control a series of processes such that the UE operates as described above. For example, the transceiver 1410 may receive a data signal including a control signal transmitted by the base station or the network entity, and the processor 1430 may determine a result of receiving the control signal and the data signal transmitted by the base station or the network entity.

FIG. 15 illustrates a structure of a base station according to an embodiment of the disclosure.

As shown in FIG. 15, the base station according to an embodiment may include a transceiver 1510, a memory 1520, and a processor 1530. The transceiver 1510, the memory 1520, and the processor 1530 of the base station may operate according to a communication method of the base station described above. However, the components of the base station are not limited thereto. For example, the base station may include more or fewer components than those described above. In addition, the processor 1530, the transceiver 1510, and the memory 1520 may be implemented as a single chip. Also, the processor 1530 may include at least one processor. Furthermore, the base station of FIG. 15 corresponds to the base station of the FIGS. 1 to 13.

The transceiver 1510 collectively refers to a base station receiver and a base station transmitter, and may transmit/receive a signal to/from a terminal (UE) or a network entity. The signal transmitted or received to or from the terminal or a network entity may include control information and data. The transceiver 1510 may include a RF transmitter for up-converting and amplifying a frequency of a transmitted signal, and a RF receiver for amplifying low-noise and down-converting a frequency of a received signal. However, this is only an example of the transceiver 1510 and components of the transceiver 1510 are not limited to the RF transmitter and the RF receiver.

Also, the transceiver 1510 may receive and output, to the processor 1530, a signal through a wireless channel, and transmit a signal output from the processor 1530 through the wireless channel.

The memory 1520 may store a program and data required for operations of the base station. Also, the memory 1520 may store control information or data included in a signal obtained by the base station. The memory 1520 may be a storage medium, such as read-only memory (ROM), random access memory (RAM), a hard disk, a CDROM, and a DVD, or a combination of storage media.

The processor 1530 may control a series of processes such that the base station operates as described above. For example, the transceiver 1510 may receive a data signal including a control signal transmitted by the terminal, and the processor 1530 may determine a result of receiving the control signal and the data signal transmitted by the terminal.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

In the above-described embodiments of the disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been shown and described with reference to various embodiments thereof, it will be understood by those skilled in the art that various changes in form and details may be made therein without departing from the spirit and scope of the disclosure as defined by the appended claims and their equivalents.

1. A method performed by a user equipment, UE in a wireless communication system, the method comprising:
receiving, from a base station, a reconfiguration message via a signalling radio bearer, SRB, wherein the reconfiguration message includes a first indicator or a second indicator; and
performing a packet data convergence protocol, PDCP re-establishment or a PDCP data recovery for the SRB, based on the first indicator or the second indicator,
wherein the first indicator triggers the PDCP re-establishment for the SRB and the second indicator triggers the PDCP data recovery, and
wherein the PDCP re-establishment is triggered based on a first field for security key update included in the reconfiguration message.

2. The method of claim 1, wherein the UE is configured with artificial intelligence/machine learning, AI/ML, functionality.

3. The method of claim 1, wherein the reconfiguration message is RRCReconfiguration including reconfigurationWithSync and is received via SRB1.

4. The method of claim 1, wherein the first value of the first indicator is reestablishPDCP and the second value of the first indicator is recoverPDCP, and
wherein the first field is masterKeyUpdate.

5. A method performed by a base station in a wireless communication system, the method comprising:
transmitting, to a user equipment, UE, a reconfiguration message via a signalling radio bearer, SRB, wherein the reconfiguration message includes a first indicator or a second indicator,
wherein a packet data convergence protocol, PDCP re-establishment or a PDCP data recovery for the SRB is based on the first indicator or the second indicator,
wherein the first indicator triggers the PDCP re-establishment for the SRB and the second indicator triggers the PDCP data recovery, and
wherein the PDCP re-establishment is triggered based on a first field for security key update included in the reconfiguration message.

6. The method of claim 5, wherein the UE is configured with artificial intelligence/machine learning, AI/ML, functionality.

7. The method of claim 5, wherein the reconfiguration message is RRCReconfiguration including reconfigurationWithSync and is received via SRB1.

8. The method of claim 5, wherein the first value of the first indicator is reestablishPDCP and the second value of the first indicator is recoverPDCP, and
wherein the first field is masterKeyUpdate.

9. A terminal in a wireless communication system, the terminal comprising:
a transceiver; and
at least one controller coupled with the transceiver and configured to:
receive, from a base station, a reconfiguration message via a signalling radio bearer, SRB, wherein the reconfiguration message includes a first indicator or a second indicator, and
perform a packet data convergence protocol, PDCP re-establishment or a PDCP data recovery for the SRB, based on the first indicator or the second indicator,
wherein the first indicator triggers the PDCP re-establishment for the SRB and the second indicator triggers the PDCP data recovery, and
wherein the PDCP re-establishment is triggered based on a first field for security key update included in the reconfiguration message.

10. The terminal of claim 9, wherein the UE is configured with artificial intelligence/machine learning, AI/ML, functionality.

11. The terminal of claim 9, wherein the reconfiguration message is RRCReconfiguration including reconfigurationWithSync and is received via SRB1.

12. The terminal of claim 9, wherein the first value of the first indicator is reestablishPDCP and the second value of the first indicator is recoverPDCP, and
wherein the first field is masterKeyUpdate.

13. A base station in a wireless communication system, the base station comprising:
a transceiver; and
at least one controller coupled with the transceiver and configured to:
transmit, to a user equipment, UE, a reconfiguration message via a signalling radio bearer, SRB, wherein the reconfiguration message includes a first indicator or a second indicator,
wherein a packet data convergence protocol, PDCP re-establishment or a PDCP data recovery for the SRB is based on the first indicator or the second indicator,
wherein the first indicator triggers the PDCP re-establishment for the SRB and the second indicator triggers the PDCP data recovery, and
wherein the PDCP re-establishment is triggered based on a first field for security key update included in the reconfiguration message.

14. The base station of claim 13, wherein the UE is configured with artificial intelligence/machine learning, AI/ML, functionality.

15. The base station of claim 13, wherein the reconfiguration message is RRCReconfiguration including reconfigurationWithSync and is received via SRB1.
